(19) United States
(12) Patent Application Publication
(10) Pub. No.: US 2023/0268982 A1
(43) Pub. Date: Aug. 24, 2023

(54) NETWORK CONTROLLED REPEATER

(71) Applicant: Intel Corporation, Santa Clara, CA (US)

(72) Inventors: Ziyi Li, Beijing (CN); Sudeep Palat, Cheltenham (GB); Youn Hyoung Heo, San Jose, CA (US)

(21) Appl. No.: 18/309,212

(22) Filed: Apr. 28, 2023

Related U.S. Application Data
(60) Provisional application No. 63/336,960, filed on Apr. 29, 2022.

(51) Int. Cl. H04B 7/155; H04W 76/10

(52) U.S. Cl. CPC H04B 7/15507; H04W 76/10

(57) ABSTRACT

The present disclosure generally relates to the field of wireless communications, cellular networks, network topologies, and communication system implementations, and in particular, to network controlled repeater (NCR) networking and associated implementations. Various solutions to support identification and initial access of an NCR, NCR protocol stacks, reduced capabilities/functionalities, and other aspects are described.

### CROSS REFERENCE TO RELATED APPLICATION

The present application claims priority to U.S. Provisional App. No. 63/336,960 filed Apr. 29, 2022, the contents of which is hereby incorporated by reference in its entirety.

### FIELD

The present disclosure generally relates to the field of wireless communications, cellular networks, network topologies, and communication system implementations, and in particular, to network controlled repeater networking and associated implementations.

### BACKGROUND

Coverage is a fundamental aspect of cellular network deployment, especially for fifth generation (5G)/new radio (NR) networks when millimeter wave (mmWave) is considered. However, deployment of regular full stack cells may not be the optimal and economical option among all choices. In the third generation partnership project (3GPP) release-16 (Rel-16) and release-17 (Rel-17) specifications, Integrated and Access Backhaul (IAB) and radio frequency (RF) repeaters were studied and supported in 5G/NR as potential coverage and capacity enhancement options. While legacy RF repeaters present a cost effective means of extending network coverage, legacy RF repeaters have limitations. Specifically, legacy RF repeaters simply perform an amplify-and-forward operation without being able to take into account various factors that could improve performance. Additionally, IAB may be over-complex if deployed for coverage holes.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 depicts an example procedure related to initial access, cell selection and power-on indication; FIGS. 3, 4, 6, 18a, 18b, 20a, 20b, 21a, 21b, and 21c depict example NCR-related message formats and data structures; FIGS. 2, 5, 8, 11, 12, 13, 15, 17, 19, and 22 depict example NCR-related procedures; FIGS. 7, 9, 10, 14, and 16 depict example protocol stacks; FIG. 23 depicts an example wireless network; FIG. 24 depicts example components of a wireless network; FIG. 25 depicts example components and hardware resources; and FIGS. 26 and 27 depict example procedures for practicing various embodiments discussed herein.

### DETAILED DESCRIPTION

### 1. Network Controlled Repeater Aspects

Network controlled repeaters (NCRs) provide enhancements over conventional RF repeaters, and may be specified in 3GPP Release 18. NCRs have the capability to receive and process side control information from the network. Side control information could allow an NCR to perform the amplify-and-forward operation in a more efficient manner in comparison to legacy RF repeaters. Potential benefits could include mitigation of unnecessary noise amplification, transmission and reception with better spatial directivity, and simplified network integration. Furthermore, NCRs should also have lower cost and lower complexity in comparison with IAB and normal user equipment (UE).

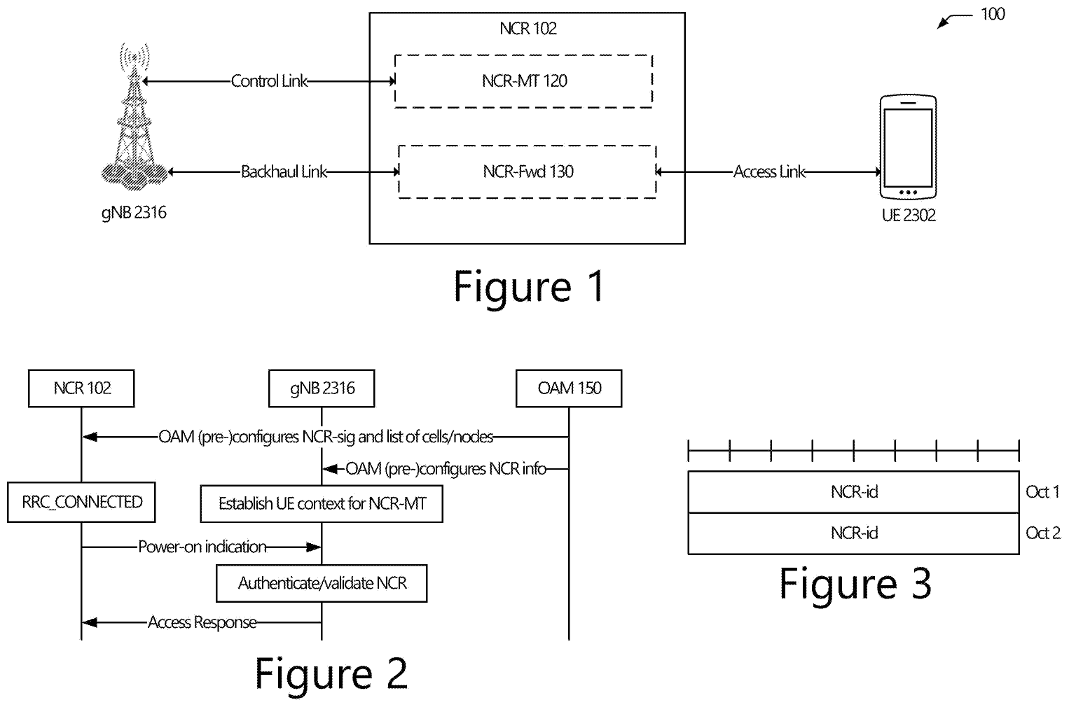

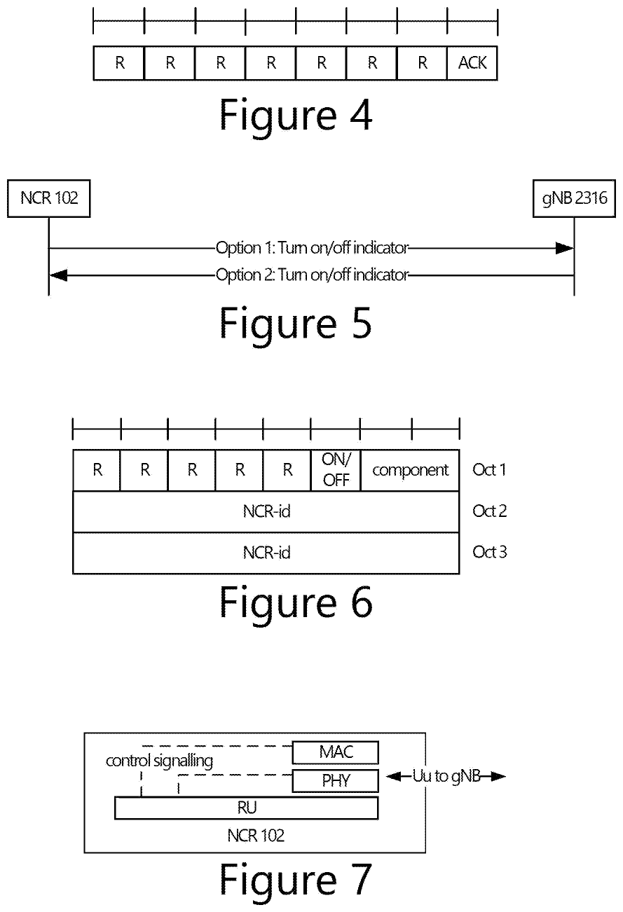

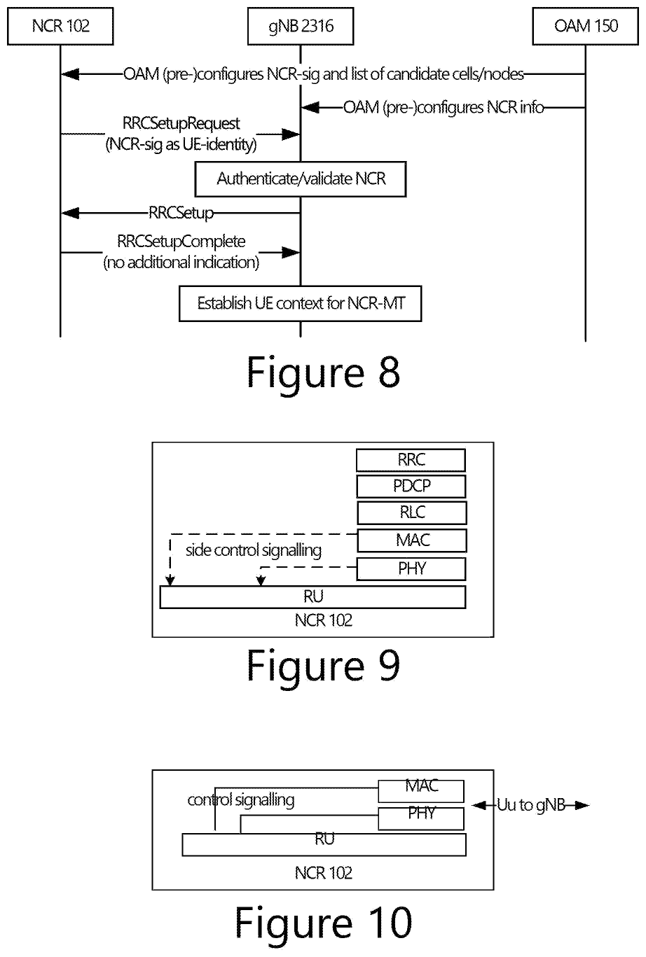

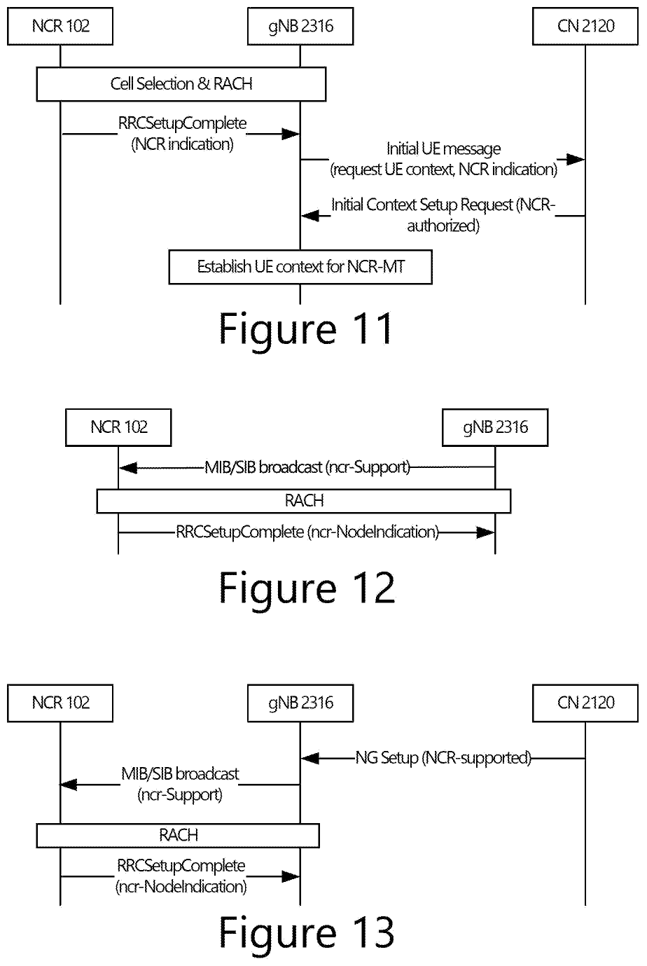

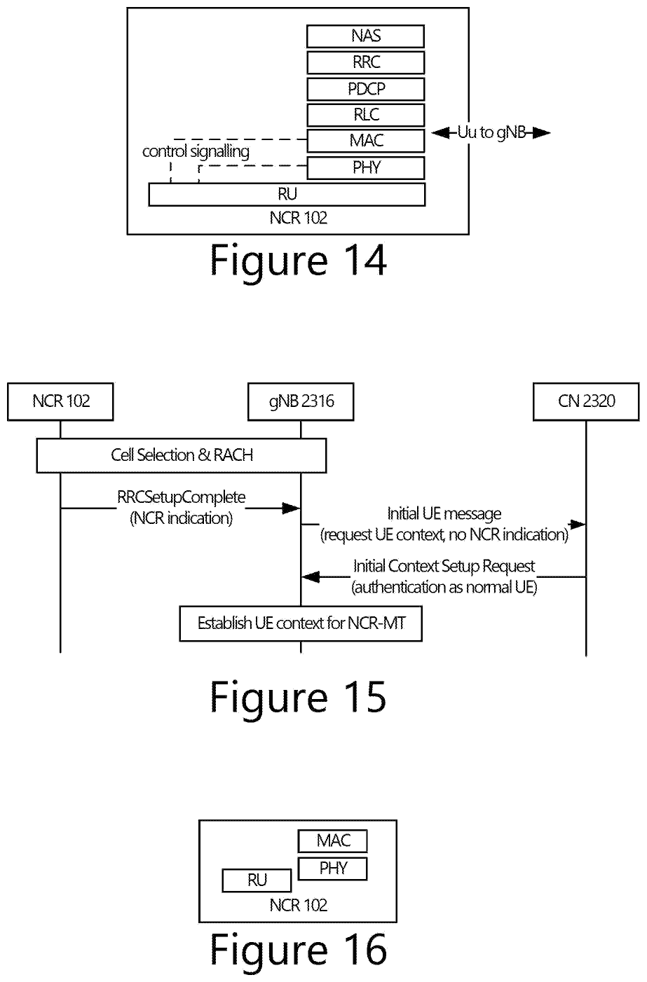

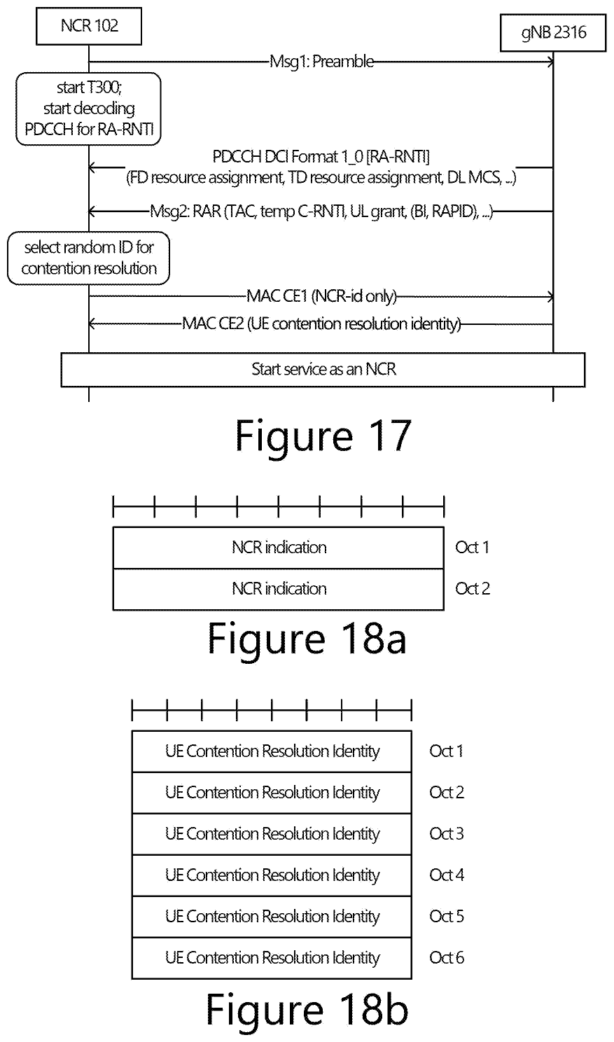

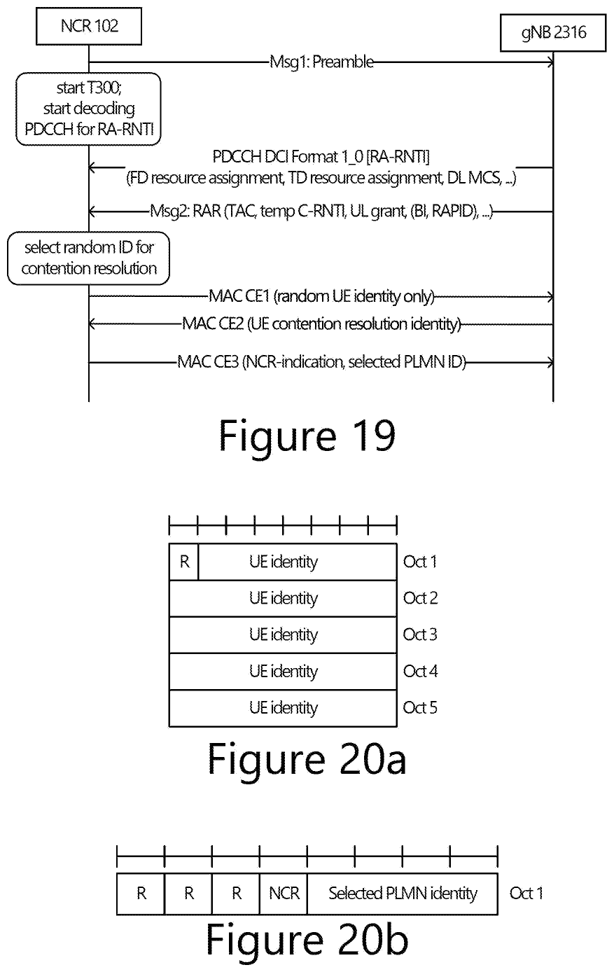

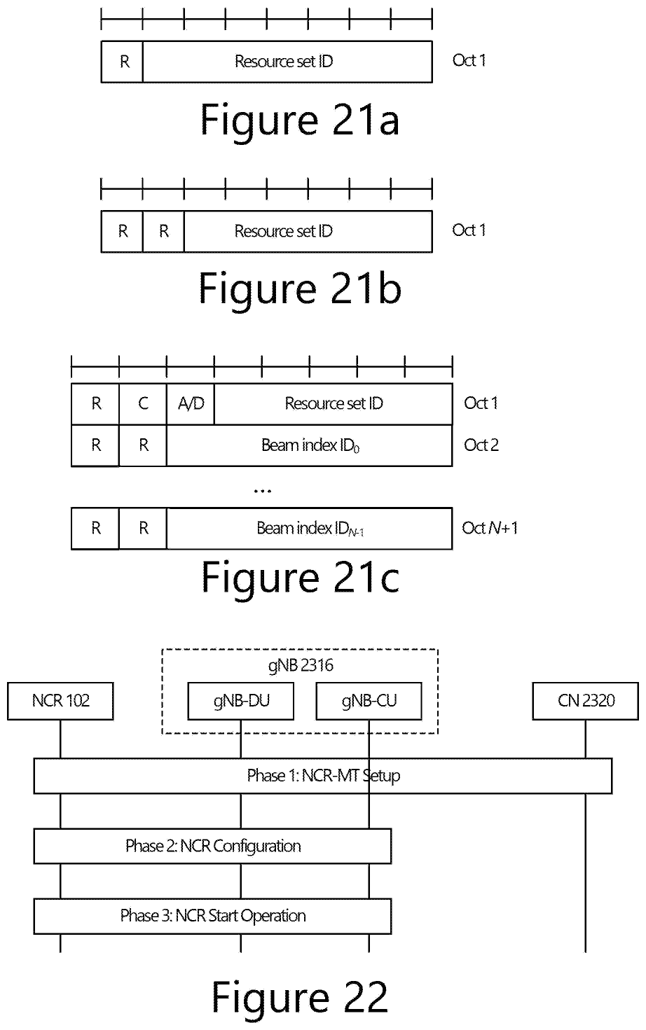

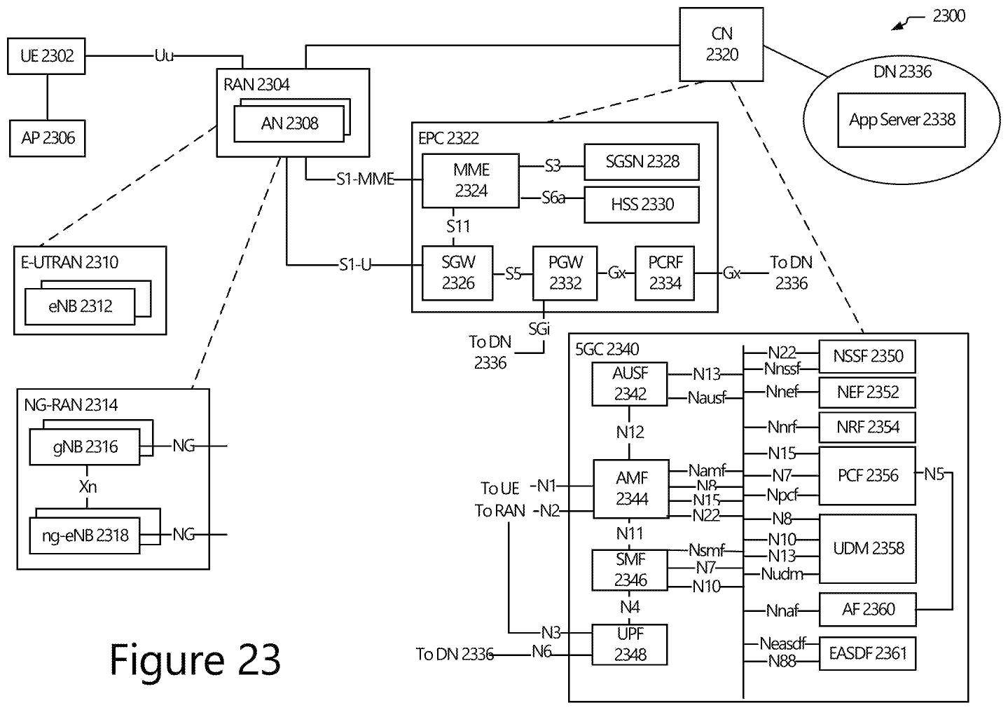

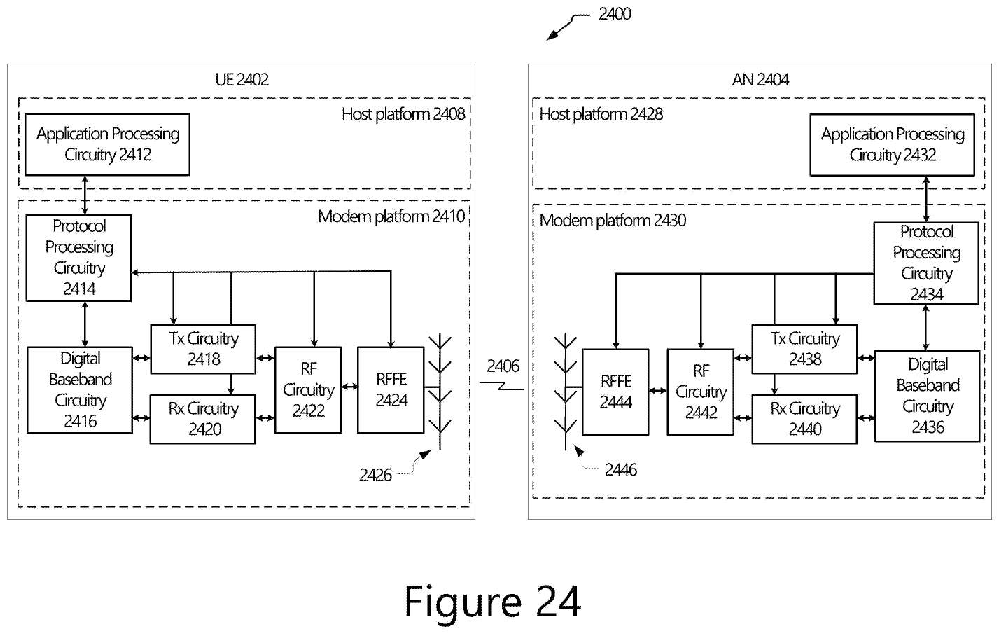

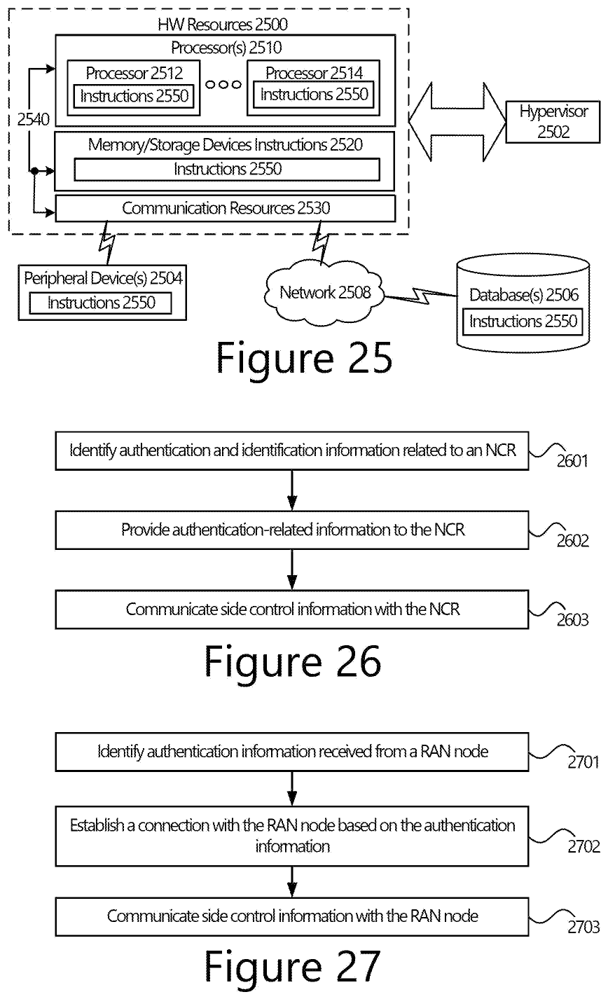

FIG. 1 shows an example NCR model 100, which includes the NCR mobile termination (NCR-MT) 120 and NCR forwarding function (NCR-Fwd) 130 in an NCR 102. The NCR-MT 120 is a function entity that communicate with a gNB 2316 via a control link (C-link) to enable exchange of control information (e.g., side control information at least for the control of NCR-Fwd 130). The C-link is based on NR Uu interface.

The NCR-Fwd 130 is a function entity that performs the amplify-and-forwarding operations/functions of UL/DL RF signal(s) between the gNB 2316 and the UE 2302 via a backhaul link and access link. The backhaul link is between the gNB 2316 and the NCR-Fwd 130, and the access link is between the UE 2302 and the NCR-Fwd 130. The backhaul and/or access links may be based on NR Uu interface, PC5 interface, sidelink interface, and/or any other suitable interface, such as any of those discussed herein. The behavior of the NCR-Fwd 130 is controlled according to the received side control information from the gNB 2316.

In some implementations, the NCR-MT 120 and the NCR-Fwd 130 operate in the same frequency band. Additionally or alternatively, at least one of the NCR-MT's 120 carrier(s) operates in the frequency band forwarded by the NCR-Fwd 130, and/or at least one of the NCR-MT's 120 carrier(s) operates in a different frequency band than the frequency band forwarded by the NCR-Fwd 130. Additionally or alternatively, the NCR-MT 120 and the NCR-Fwd 130 share the same cell (e.g., the NCR-MT 120 and the UE 2302 share the same cell provided by the gNB 2316). Additionally or alternatively, the NCR-MT 120 and the NCR-Fwd 130 camp on different cells (e.g., the NCR-MT 120 and the UE 2302 connect to different cells, where the different cells are provided by the same gNB 2316 or the different cells are provided by different gNBs 2316).

As a baseline, same large-scale properties of the channel (e.g., channel properties in Type-A and Type-D, if applicable) are expected to be experienced by C-link and backhaul link (at least when the NCR-MT 120 and the NCR-Fwd 130 are operating in same frequency band).

For the transmission/reception of C-link and backhaul link by NCR 102, the DL of C-link and the DL of backhaul link can be performed simultaneously or in time division multiplexing (TDM) manner, and the UL of C-link and UL of backhaul link can be performed in TDM manner. The multiplexing is under the control of the gNB 2316 with consideration for NCR capability and simultaneous transmission of the UL of C-link and UL of backhaul link is also subject to NCR capability.

The side control information includes, for example, beam information, timing information, information of UL-DL TDD configuration, ON-OFF information, and power control information.

Beam Information. For the backhaul link and C-link, both fixed beam and adaptive beam can be considered at NCR 102, where the fixed beam refers to the case that beam at NCR 102 for both C-link and backhaul-link cannot be changed. Beam correspondence is assumed to apply for DL/UL of the backhaul link at the NCR-Fwd 130, as well as the DL/UL of the C-link at NCR-MT 120.

As a baseline, the same TCI states as C-link are assumed for beams at NCR-Fwd 130 for backhaul link if the NCR-MT's 120 carrier(s) is operating within the frequency band forwarded by the NCR-Fwd 130. In case that the adaptive beams are adopted for C-link and backhaul link, the indication and determination of beams of backhaul link can be achieved by: the beam of backhaul link is indicated by a new signaling or the beam of backhaul link is determined by a pre-defined rule. When the beam of backhaul link is indicated by a new signaling, the new signaling is dynamic signaling and/or semi-static signaling (e.g., RRC signaling/MAC CE) indicating a beam(s) from the set of beams of the C-link. This does not imply that the beam of backhaul link is always indicated by the new signaling. When the beam of backhaul link is determined by a pre-defined rule (e.g., in slots/symbols with simultaneous DL receptions/UL transmissions in both C-link and backhaul link), the beam of backhaul link is the same as the beam of C-link. Otherwise, the beam of backhaul link follows one of the beams of the C link. Other predefined rules are not precluded.

At least for the access link, and at least for FR2, beam information is beneficial and recommended as the side control information for a network-controlled repeater to control the behavior of the NCR 102 for the access link. Regarding the access link beam indication, the beam of access link for NCR-Fwd 130 is indicated by a beam index where both dynamic indication and semi-static indication, including semi-persistent indication, are considered.

The time domain resource corresponding to an access link beam is explicitly determined based on the explicitly indicated time domain resources per beam indication. A single beam indication can indicate one or multiple beams. Different parameters may be indicated for semi-static or dynamic beam indication.

Beam correspondence is assumed for the DL/UL of the access link at NCR-Fwd 130, i.e., a DL beam and a UL beam on the access side which correspond to each other have the same beam index. The forwarding direction of an indicated beam in access link can be determined based on its corresponding time domain resource and the UL/DL TDD configuration. The forwarding behavior (or the forwarding direction) of an indicated beam in access link in flexible symbols is discussed infra.

Timing Information. For the timing of NCR 102, the following assumption is considered as baseline: the DL receive timing of the NCR-Fwd 130 is aligned with the DL receive timing of the NCR-MT 120; the UL transmit timing of the NCR-Fwd 130 is aligned with the UL transmit timing of the NCR-MT 120; the DL transmit timing of the NCR-Fwd 130 is delayed after the DL receive timing of the NCR-MT 120 (or the NCR-Fwd 130) by an internal delay; and the UL receive timing of the NCR-Fwd 130 is advanced before the UL transmit timing of the NCR-MT 120 (or the NCR-Fwd 130) by an internal delay. The legacy UE mechanism may be sufficient to achieve DL/UL timing for NCR-MT 120.

Information on UL-DL TDD configuration. For the TDD UL/DL configuration of network controller repeater, at least semi-static TDD UL/DL configuration is needed for network-controlled repeater for links including C-link, backhaul link and access link. On the flexible symbols based on the semi-static configuration (e.g., TDD-UL-DL-ConfigCommon, TDD-UL-DL-ConfigDedicated), the following behaviors of the NCR-Fwd 130 are considered: (i) the NCR-Fwd 130 is expected to be OFF or not forwarding over these symbols; (ii) the NCR-Fwd 130 will follow the TDD operation determined by NCR-MT 120 (e.g., determined by NCR-MT 120 based on the received SFI indication or scheduling from gNB), this means that no new side control signaling is needed; and/or (iii) the NCR-Fwd 130 will follow a new dynamic side control signaling of DL/UL forwarding over these symbols to NCR-Fwd 130. The same TDD UL/DL configuration is always assumed for backhaul link and access link. Additionally, the same TDD UL/DL configuration is assumed for C-link, backhaul link and access link if NCR-MT 120 and NCR-Fwd 130 operate in the same frequency band.

ON-OFF information. ON-OFF information is beneficial and recommended for network-controlled repeater to control the behavior of NCR-Fwd 130. The NCR-Fwd 130 is always expected to be “OFF” unless otherwise explicitly or implicitly indicated by the gNB. This applies regardless of the RRC state of NCR-MT 120. Indication (e.g., received when NCR-MT 120 in RRC-connected) or DRX state of NCR-MT 120 to control the ON-OFF behavior of NCR-Fwd 130 when the NCR-MT 120 is in RRC-idle/inactive is not precluded. The following options can be considered to indicate the ON-OFF information from gNB to NCR 102 for controlling the behavior of NCR-Fwd 130: (i) explicit indication with ON-OFF state (e.g., via dynamic or semi-static signaling) or ON-OFF pattern (e.g., periodic/semi-static ON-OFF pattern or new DRX-like pattern for ON-OFF); and/or (ii) implicit indication via the signaling for other side-control information (e.g., beam, DL/UL configuration, or PC information). It should be noticed that this example does not imply that PC information is necessary or not. Other solutions (e.g., potential combination of explicit and implication solution) can be further discussed in normative phase.

Power control information. The controlling of the amplifying gain of NCR-Fwd 130 is considered to enable the power control of NCR-Fwd 130 if PC is recommended as side control information for NCR in Rel-18.

To be able to send side control information to an NCR, the network (e.g., RAN 2304, AP 2306, ANs 2308, CN 2320, AN 2404, hardware resources 2500, and/or the like) should be able to identify this type of device. Moreover, to reduce cost and complexity at the NCR, the protocol stack can also be optimized/reduced.

The present disclosure provides different solutions to support identification and initial access of the NCR. In addition, protocol stack of NCR is described. Based on the described protocol stack, reduced capabilities/functionalities at NCR are also described. The embodiments discussed herein reduce the cost of NCR as well as provide functionality to amplify-and-forward RF signals covering coverage hole of one gNB. Additionally, the described solutions can also receive side control information from gNB to optimize performance of the amplified signals received from gNB in downlink (DL) and from UE in uplink (UL).

The NCR 102 is a repeater that includes, at high level of a radio unit (RU) (also referred to as a “remote unit”) and a control unit. The RU (also referred to herein as an “NCR-RU”) may be similar to that of a repeater defined by 3GPP RAN4 in Rel-17, which is used to amplify-and-forward the received signals from a RAN node (e.g., RAN 2304, AP 2306, ANs 2308, gNB 2316, AN 2404, hardware resources 2500, and/or the like) and/or a user equipment (UE) (e.g., UE 2302, UE 2402, hardware resources 2500, and/or the like) in DL and UL, respectively. Additionally or alternatively, the NCR-RU may be the same or similar as the NCR-Fwd 130.

The control unit (also referred to herein as an “NCR-CU”) is used to control the NCR-RU and provide it with the required configurations. This control function could be supported by a mobile termination (MT) (e.g., the NCR-MT 120). The MT is used to establish and maintain connection with the RAN node to receive configurations and the side control information. Additionally or alternatively, the MT could be a full or subset of the UE functions defined by 3GPP. The following embodiments are generally described with respect to (w.r.t) the NCR-MT 120 and initial access to gNB 2316. However, the embodiments discussed herein may be applicable to other implementations, configurations, and/or arrangements.

1.1. Authentication and Identification Via Oam

In this embodiment, the initial configurations of the NCR 102 are configured or pre-configured by an operations, administration, and maintenance (OAM) entity/element (e.g., OAM 150 in FIG. 2), which is/are controlled by an operator. The OAM 150 may be implemented using any suitable orchestration and/or management framework/mechanism, such as any of those discussed herein. The configuration includes all necessary information for establishing a connection for transfer of further configurations, including configuration for initial access, unique signature of the NCR 102 (referred to herein as an “NCR-sig”, “NCR-id”, and/or the like), candidate/assigned gNB(s) 2316 for the NCR 102 to access, protocol stack configurations (e.g., PHY, MAC, RLC, and/or PDCP configuration(s)) of the joined cell, and/or other suitable information/data. In some examples, the NCR-sig can be a RNTI, NCR-RNTI, and/or some other suitable identifier, signature, and/or network address, including any of those mentioned herein)

By using this approach, the authentication and identification of the NCR is provided by OAM through implementation. The NCR can initiate communication directly with the gNB 2316 with the (pre-)configured information received from the OAM 150. This could be to use a UE RRC_CONNECTED state defined in 3GPP or an new state that can be defined. This communication may involve only the lower layers of the protocol stack, such as MAC and PHY.

The OAM configuration could be provided by any means, for example, by direct OAM interface for the NCR 102 using over an IP link that is established by plugging-in the NCR 102 and/or based on an initial attachment the network. The gNB 2316 is also configured with the necessary parameters by the OAM 150, for example, to communicate with the NCR and provide additional dynamic configuration information. Once the communication link is established between the gNB 2316 and the NCR 102, this could be used for further configuration of the communication link (e.g., access link in FIG. 1) and to provide side control information for the NCR-RU/NCR-Fwd 130.

1.1.1. Initial Access, Cell Selection and Power-on Indication

FIG. 2 shows an example NCR-OAM procedure, which is performed among an NCR 102 (or an NCR-CU/NCR-MT 120 and/or NCR-RU/NCR-Fwd 130), gNB 2316, and OAM 150. Considering the NCR 102 receives only one candidate gNB 2316 from the OAM 150 based on (pre-)configuration, the NCR 102 naturally establishes its connection with the corresponding gNB 2316. The procedure of FIG. 2 may operate as follows.

Step 1: the OAM 150 configures, provisions, or otherwise provides the NCR 102 with an NCR-sig and a list of cells/RAN nodes (e.g., gNBs 2316, and/or the like) to serve the NCR 102. In some implementations, the NCR-sig may be computed, derived, selected, or otherwise determined by the OAM 150 using any suitable mechanism (e.g., cryptography, random number/string generator, and/or the like). In some implementations, the list of cells/RAN nodes can include any suitable identifier associated with each cell/RAN node in the list such as, for example, cell identifier (ID), PCI, NCGI, Absolute Radio-Frequency Channel Number (ARFCN), and/or any other identifier(s) and/or network address(es), such as any of those discussed herein. The list of cells/RAN nodes can also include other relevant information to allow the NCR 102 to connected to one or more of the listed cells/RAN nodes.

Step 2: the OAM 150 configures, provisions, or otherwise provides the gNB 2316 with NCR configuration/information. The NCR configuration/information can include, for example, NCR-sigs, UE contexts of a set of NCRs 102 that are permitted/authorized to connect with the gNB 2316. Any suitable configuration data structures/formats/messages can be used for the NCR configuration/information.

Step 3: the gNB 2316 establishes UE contexts for at least a subset of NCRs 102 from the set of authorized NCRs 102 based on the received configuration/information.

Step 4: the NCR 102 sends a power-on indication to the gNB 2316. The power-on indication includes the configured NCR-sig. In some examples, the power-on indication includes other suitable information (e.g., NCR capabilities and/or the like). An example of the power-on indicator is shown by FIG. 3. In some examples, the NCR 102 sends the power-on indication when it enters the RRC_CONNECTED mode/state, however, a different state could be defined for this purpose. Step 4 may take place before, during, or after step 3 in some implementations.

Step 5: the gNB 2316 authenticates, validates, and/or authorizes the NCR 102. In some examples, the gNB 2316 performs this operation by comparing the NCR-sig carried in the power-on indication with the (pre-)configured NCR-sigs of authorized NCRs 102. The gNB 2316 can employ additional or alternative authorization, authentication, and/or validation mechanisms.

Step 6: the gNB 2316 sends an access response (also referred to as an “access message” or the like) to the NCR 102. If the NCR-sig carried in the power-on indication matches one of configured NCR-sigs, the access response is or includes an acknowledgement (ACK) and/or provides connection confirmation information. If the NCR-sig carried in the power-on indication matches one of configured NCR-sigs, the access response is or includes a negative ACK (NACK) and/or indicates a connection failure, connection not authorized, and/or some other suitable cause code/value. An example of an access response message is shown by FIG. 4.

FIG. 3 shows an example message format/data structure for the NCR power-on indication. The power-on indication allows the gNB 2316 to know when the NCR 102 is ready to enable repeater functionality (e.g., NCR-Fwd 130) and receive gNB 2316 signaling so that gNB 2316 can start to provide side control information towards NCR 102. In the present disclosure, this is indicated as the NCR 102 being in the RRC_CONNECTED state, however, a new state can be defined for the NCR 102 for this purpose. To support that, the power-on indication is transmitted from the NCR 102 to the gNB 2316 when the NCR 102 is powered-on and goes into RRC_CONNECTED. In some implementations, the power-on indication is carried in a new or existing MAC CE, which can include a suitable MAC subheader or the like. In other implementations, the power-on indication is carried in PHY signaling. Before or after sending the power-on indication, a PRACH procedure may be supported if timing synchronization/power control is needed.

In this example, the power-on indication includes a 16 bit NCR-id field that carries the NCR-sig/id. In some examples, the NCR-sig may be an existing identifier/network address, or may be a new type of RNTI (e.g., network-controlled repeater RNTI, NCR-RNTI). Additionally or alternatively, the NCR-id field can carry an entire NCR-sig, a subset of the NCR-sig (e.g., a subset of (selected) bits from the NCR-sig), and/or used in PHY signaling (e.g., using it as scrambling parameters).

FIG. 4 shows an example access response (also referred to as an ACK indication or the like). In this example, the access response includes a set of reserved bits (R) and an ACK field. In some examples, the ACK field carries a value of “1” to indicate accepted/authorized/permitted connection, or carries a value of “0” to indicate that the connection was not accepted/authorized/permitted. A new or existing MAC CE can be used to carry the ACK indication to NCR 102, which can include a suitable MAC subheader or the like. In case the NCR 102 amplify-and-forwards information before receiving side control information configured from the gNB 2316 (which may lead to poor performance), the gNB 2316 can set a timing offset/delta information in the MAC CE (e.g., using one or more of the reserved bits) indicating when the gNB 2316 is to start sending side control information to the NCR 102. If the NCR 102 does not receive the ACK indication from the gNB 2316, the NCR 102 considers the establishment between the NCR 102 and the gNB 2316 to be not successful.

1.1.2. Turn on/Off Indication after Initial Access

FIG. 5 shows an example procedure for communicating a turn on/off indication after the initial access (e.g., after the procedure of FIG. 2), which may take place while the NCR 102 is in the RRC_CONNECTED mode/state. Option 1 involves the NCR 102 sending a turn on/off indication to the gNB 2316. If the NCR 102 wants to turn on/off by itself, the NCR 102 can send the turn on/off indication to the gNB 2316, indicating that the NCR 102 is going to turn on or turn off. Option 2 involves the gNB 2316 sending the turn on/off indication to the NCR 102. In option 2, the gNB 2316 can trigger and send the turn on/off indication to the NCR 102 indicating or instructing the NCR 102 to turn on/off the NCR-MT 120 and/or the NCR-Fwd 130. Considering that the NCR-MT 120 and NCR-Fwd 130 can operate independently (e.g., the NCR-Fwd 130 can still perform amplify-and-forward operations reusing previously configured side control information), the turn on/off indication in either option can include information indicating to turn on/off the NCR-MT 120 and the NCR-Fwd 130, independently or together. An example of the turn on/off indicator is shown by FIG. 6.

FIG. 6 shows an example power on/off indication, which may be used as the turn on/off the NCR-MT 120 and/or the NCR-Fwd 130 in the NCR 102. In this example, the turn on/off indication is a MAC CE (“turn on/off MAC CE”), which includes a set of reserved fields (e.g., 1 bit each), an ON/OFF field (e.g., 1 bit), a component field (e.g., 2 bits), and NCR-id field (e.g., 16 bits). The NCR-id field carries the NCR-sig/id in a same or similar manner as discussed previously w.r.t FIG. 3.

The ON/OFF field indicates whether the turn on/off MAC CE is a power-off indication or a power-on indication. As an example, the turn on/off MAC CE is a power-off indication when the ON/OFF field is set to 0 (e.g., the ON/OFF action is “turn off” or “deactivate”), and the MAC CE is a power-on indication when the ON/OFF field is set to 1 (e.g., the ON/OFF action is “turn on” or “activate”). In some implementations, the ON/OFF field may be replaced with, or otherwise referred to as, an activate/deactivate (A/D) field.

The component field indicates which NCR component (e.g., NCR-MT 120 and/or NCR-Fwd 130) is to be turned on/off as indicated by the ON/OFF field. In one example, one bit of the component field corresponds to one NCR component and the other bit corresponds to another NCR component. Table 1.1.2-1 shows an example of how the ON/OFF action indicated by the ON/OFF field is applied to NCR components when using a 2 bit component field.

TABLE 1.1.2-1
2-bit component field values

| Component | |
|---|---|
| field | |
| value | Action description |
| 00 | Reserved or informative only |
| 01 | Apply/perform action indicated by ON/OFF |
| | field to NCR-MT only |
| 10 | Apply/perform action indicated by ON/OFF |
| | field to NCR-Fwd only |
| 11 | Apply/perform action indicated by ON/OFF |
| | field to both NCR-MT and NCR-Fwd |

In some implementations, the component field has only 1 bit. Table 1.1.2-2 shows an example of how the ON/OFF action indicated by the ON/OFF field is applied to NCR components when using a 1 bit component field.

TABLE 1.1.2-2
1-bit component field values

| Component | |
|---|---|
| field | |
| value | Action description |
| 0 | Apply/perform action indicated by ON/OFF |
| | field to NCR-MT only |
| 1 | Apply/perform action from ON/OFF field |
| | to both NCR-MT and NCR-Fwd |

1.1.3. Protocol Stack Aspects

As discussed in section 1.1.1, the NCR configurations are (pre-)configured by the OAM 150. This can allow a simplified (or reduced) protocol stack, which only includes PHY and MAC layers to be considered for the NCR-MT 120. This allows the NCR 102 to have reduced power and resource consumption, as well as a reduced circuit footprint. FIG. 7 shows an example of such a protocol stack.

In the protocol stack of FIG. 7, the NCR-MT 120 includes/operates the PHY and MAC layers, and the NCR-Fwd 130 includes/operates the RU layer. The RU layer is or includes an amplify-and-forward radio unit of the NCR 102 (e.g., radio hardware and/or software elements). The PHY and MAC layers are responsible for receiving and processing side control information from the gNB 2316, and sending power-on/off indications to the gNB 2316. In some implementations, the NCR-Fwd 130 shares the RU layer with the NCR-MT 120. Alternatively, separate RU layers can be implemented for the NCR-MT 120 and NCR-Fwd 130.

1.1.4. Reduced Functionality for NCR

After connection establishment, the NCR-MT 120 is only responsible for limited features that support side control information receipt and processing. For example, features supported at the NCR-MT 120 include the following MAC functionality: HARQ, multiplexing (for MAC CE, including power-on indication MAC CE, side control information, turn-on/off indication, and/or the like). All other mandatory features in the MAC listed in 3GPP TS 38.822 v17.0.0 (2023-03-30) (“[TS38822]”) and 3GPP TS 38.306 v17.4.0 (2023-03-30) (“[TS38306]”) may or may not be optional for the NCR-MT 120.

1.2. Authentication Using OAM and Identification by GNB

This embodiment is similar to the embodiments discussed in section 1.1, configurations of the NCR 102 are pre-configured by the OAM 150, which are controlled by an operator or the like. In these embodiments, instead of providing only a single cell/RAN node (or a pre-selected list of cells/RAN nodes), the OAM 150 provides the NCR 102 with a list of candidate cells/RAN nodes (e.g., cells that can be covered by the same NCR 102), which allows the NCR 102 to select one of the candidate cells/RAN nodes for initial access and cell selection. By receiving the candidate cells/RAN nodes, the NCR 102 assumes it is authorized by the OAM 150 to establish connection with the listed candidate cells/RAN nodes.

Additionally, the gNB 2316 further provides identification to the NCR 102. For purposes of identification/authentication, the NCR-MT 120 can use a full, a subset, or a modified subset of UE functions for communication with the gNB 2316. For example, this could include using a subset of radio functions and/or protocols layers (e.g., RRC, PDCP, RLC, MAC, and/or PHY). Once the initial identification/authentication is completed, the NCR-MT 120 (or the subset of UE functionality) can provide further configuration of communication between the gNB 2316 and the NCR 102, and also provide the side control information for the NCR function, such as RU (NCR-Fwd 130).

1.2.1. Initial Access and Cell Selection

FIG. 8 shows an example NCR-OAM procedure with RAN node identification, which is performed among an NCR 102, the gNB 2316, and the OAM 150. The procedure of FIG. 8 may operate as follows:

Step 1: the OAM 150 configures, provisions, or otherwise provides the NCR 102 with an NCR-sig and a list of candidate cells/RAN nodes (e.g., candidate gNBs 2316, candidate cells provided by the same or different gNBs 2316, and/or the like) to serve the NCR 102. The NCR-sig may be the same or similar to those discussed previously, and the list of candidate cells/RAN nodes can include the same or different information as discussed previously w.r.t FIG. 2.

Step 2: the OAM 150 configures, provisions, or otherwise provides the gNB 2316 with NCR configuration/information, which may be the same or similar to the NCR configuration/information discussed previously w.r.t FIG. 1.

Step 3: the NCR 102 performs cell selection among the (pre-)configured candidate cells/RAN nodes. This may involve sending, for example, an RRCSetupRequest message to the selected gNB 2316. The RRCSetupRequest message includes the configured NCR-sig as UE-identity.

Step 4: the gNB 2316 authenticates, validates, and/or authorizes the NCR 102. In some examples, the gNB 2316 performs this operation by comparing the UE-identity (e.g., NCR-sig) carried in RRCSetupRequest message with the (pre-)configured NCR-sigs included in the NCR configuration/information.

Step 5: the gNB 2316 sends an RRCSetup message to the NCR 102 and provides identification information if the UE-identity (e.g., NCR-sig) matches one of the (pre-)configured NCR-sigs.

Step 6: the NCR 102 sends an RRCSetupComplete message to the gNB 2316 indicating the successful establishment of RRC setup.

Step 7: the gNB 2316 establishes UE context for/with the NCR-MT 120.

The RRCSetupRequest message is used to request the establishment of an RRC connection. To identify the NCR 102 at the gNB 2316, the NCR-sig assigned by the OAM 150 as the UE-identity is included in an RRCSetupRequest message so that the gNB 2316 knows it's an NCR 102 who is requesting RRCsetup. The NCR 102 may also include an establishment cause in the RRCSetupRequest message indicating the establishment is requested for repeater (or NCR) functionality. An example RRCSetupRequest message is shown as by Table 1.2-1 with corresponding field descriptions in Table 1.2-2. In this example, the “network-controlled-repeater-signature” parameter represents the NCR-sig discussed previously.

TABLE 1.2-1
RRCSetupRequest message

| | |
|---|---|
| -- ASN1START | |
| -- TAG-RRCSETUPREQUEST-START | |
| RRCSetupRequest ::= | SEQUENCE { |
| rrcSetupRequest | RRCSetupRequest-IEs |
| } | |
| RRCSetupRequest-IEs ::= | SEQUENCE { |
| ue-Identity | InitialUE-Identity, |
| establishmentCause | EstablishmentCause, |
| spare | BIT STRING (SIZE (1)) |

}

| | |
|---|---|
| InitialUE-Identity ::= | CHOICE { |
| ng-5G-S-TMSI-Part1 | BIT STRING (SIZE (39)), |
| randomValue | BIT STRING (SIZE (39)), |
| network-controlled-repeater-signature | BIT STRING (SIZE (39)), |

}

| | |
|---|---|
| EstablishmentCause ::= | ENUMERATED { |
| | emergency, highPriorityAccess, mt-Access, mo- |
| | Signalling, mo-Data, mo-VoiceCall, mo- |
| VideoCall, mo- | SMS, mps-PriorityAccess, mcs- |
| PriorityAccess, network- | controlled-repeater, spare5, |
| spare4, spare3, spare2, | spare1} |

-- TAG-RRCSETUPREQUEST-STOP
-- ASN1STOP

TABLE 1.2-2
RRCSetupRequest IE field descriptions

establishmentCause
Provides the establishment cause for the RRCSetupRequest
in accordance with the information
received from upper layers. gNB is not expected to
reject an RRCSetupRequest due to
unknown cause value being used by the UE.
ue-Identity
UE identity included to facilitate contention
resolution by lower layers.
ng-5G-S-TMSI-Part1
The rightmost 39 bits of 5G-S-TMSI
randomValue
Integer value in the range 0 to 2³⁹ − 1.

Additionally or alternatively, the NCR-sig could be an RNTI (e.g., NCR-RNTI or the like) or a specific bit string for the purpose of identification and authentication. This bit string can be pre-programmed in the NCR 102 and/or the gNB 2316 using the OAM 150 and/or other means, and the UE 2302 provides this bit string over a secure link to the gNB 2316. The gNB 2316 can then verify that the UE 2302 is indeed an NCR 102 that is allowed to be set up at (or attached to) the gNB 2316. The secure link can be integrity and/or ciphered by security mechanisms defined in 3GPP for access stratum (AS), non-access stratum (NAS), or extensions of AS/NAS. As the bit string is provided over a secure link, it should be difficult or impossible for other devices to eavesdrop and use it for replay attacks.

1.2.2. Protocol Stack and Reduced Functionality

As discussed in section 1.2.1, an RRC setup procedure can be used to provide identification and establish the initial access between the NCR 102 and the gNB 2316. Hence, RRC, PDCP, RLC, MAC, and PHY can be used for initial access, especially for SRB1. When the RRC setup for the NCR 102 is completed, there are two options of protocol stacks at the NCR 102. An example of the first option is shown by FIG. 9, and an example of the second option is shown by FIG. 10. In both options, the RU layer can be shared between the NCR-Fwd 130 and the NCR-MT 120, or separate RUs can be implemented for the NCR-MT 120 and NCR-Fwd 130.

1.2.2.1. Use Same Protocol Stack as Used for Initial Access

FIG. 9 shows an example protocol stack according to the first option, where semi-static side control information is provided via RRC signaling (e.g., TDD UL/DL configuration, and/or the like). However, considering that the NCR-MT 120 may not have its own traffic, the NCR-MT 120 does not need to establish DRB(s) after the RRC setup is complete. Moreover, considering that the size of RRC messages for side control information is quite small compared with normal UE configurations, a scaling factor may be considered for L2 buffer size and RRC buffer size.

The NCR-MT 120 stack could be a full UE stack or a subset of protocol layers/entities as mentioned previously. The NCR-MT 120, functioning as a UE 2302, can continue to maintain a connection with the gNB 2316. MAC CEs specifically defined for side control information can then be sent between the gNB 2316 and the NCR-MT 120 over the Uu interface. These MAC CEs will be intercepted and interpreted by the MAC layer of the NCR-MT 120 and used to provide side control information signaling for the RU layer (e.g., NCR-Fwd 130). PHY layer signaling can be used (in addition to or instead of MAC CEs) between the gNB 2316 and the NCR-MT 120 functioning similar to the UE to provide side control information.

As examples, the following functions are considered at the NCR-MT 120: L2 buffer size with scaling factor; General (e.g., 0-4 direct SN addition in the first RRC connection reconfiguration after RRC connection establishment, 0-7 PCell operation on FR2); PDCP (e.g., 1-0 (1/2/4/5/6) ciphering, integrity, reordering/in-order delivery, status reporting, duplicate discarding, 1-5 shortSN); RLC (e.g., 2-0 (1/3) TM and SDU discard, 2-1 AM with short SN); MAC (e.g., 3-0 (1/2/3/4/5/6/7/10/13) RA, TA maintenance, HARQ, multiplexing, PHR, 3-3 DRX); Measurement (e.g., 4-1 (1) intra-frequency and inter-frequency measurement and report); INACTIVE (e.g., 6-1 RRC INACTIVE); Mobility (e.g., 7-1 (1/2/6) if cell reselection is allowed for smart repeater when RLF happens); RRC (e.g., 9-1 supported with scaling factor, 9-2 RRC processing); SON/MDT (e.g., 20-15/20-16 reporting of connection establishment failure and RLF); and others (e.g., CLI for reducing inference purposes). All other features listed in [TS38822] and [TS38306] in RRC/PDCP/RLC/MAC may or may not be optional for the NCR-MT 120.

1.2.2.2. Use MAC/PHY Only at NCR-MT after Initial Access

FIG. 10 shows an example protocol stack according to the second option. In the second option, when the RRC setup is completed for the NCR 102, the NCR 102 can also deactivate it's RRC, PDCP, and/or RLC protocol layers if semi-static side control information via RRC signaling is not supported. As examples, the following features can be supported by the NCR-MT 120 MAC layer: MAC (e.g., 3-0 (1/2/3/4/5/6/7/10/13) TA maintenance, HARQ, multiplexing, PHR; 3-3 DRX).

1.3. Authentication and Identification by Core Network as a New Device Type

In this embodiment, the authentication and identification are provided by a core network (CN) 2310 (or one or more NFs in the CN 2320). Considering that the NCR 102 only amplify-and-forwards signals from the gNB 2316 and does not have any service request to the CN 2310, the CN 2310 does not need to provide any service to the NCR 102. Hence, in this embodiment, the NCR 102 may be known by the CN 2310 (or suitable NFs therein) as a new type of device. An example procedure for such embodiments is shown by FIG. 11, and may operate as follows:

Step 1: the NCR 102 performs cell selection and RACH following normal UE procedure(s) as defined in 3GPP TS 38.304 v17.4.0 (2023-04-03) (“[TS38304]”) and [TS38331].

Step 2: the NCR 102 sends an RRCSetupComplete message to the gNB 2316. The RRCSetupComplete message includes an NCR-indication parameter/IE and/or other relevant IEs/parameters.

Step 3: the gNB 2316 sends a NAS transport message (e.g., Initial UE MESSAGE) to the CN 2320 (or relevant NF(s) in the CN 2320, such as an AMF 2344) over the NG interface. Here, the Initial UE MESSAGE includes a request for UE context, an NCR-indication IE, and/or other relevant IEs/parameters.

Step 4: the CN 2320 (or relevant NF) provides authentication and identification to the NCR 102 as a new type of device (e.g., NCR-authorized or the like). In this example, the CN 2320 (or relevant NF) sends an Initial Context Setup Request message to NG-RAN 2314 (e.g., gNB 2316), which includes an NCR-authorized IE indicating that the NCR 102 is authorized by the CN 2320 (or relevant NF).

Step 5: the gNB 2316 establishes a UE context for NCR-MT 120 based on the configuration received from the CN 2320 (or relevant NF).

The RRCSetupComplete message (e.g., step 2 in FIG. 11) is used to confirm the successful completion of an RRC connection establishment. An example of RRCSetupComplete message is shown by Table 1.3-1 with corresponding field descriptions in Table 1.3-2.

TABLE 1.3-1
RRCSetupComplete message

-- ASN1START
-- TAG-RRCSETUPCOMPLETE-START

| | |
|---|---|
| RRCSetupComplete ::= | SEQUENCE { |
| rrc-TransactionIdentifier | RRC-TransactionIdentifier, |
| criticalExtensions | CHOICE { |
| rrcSetupComplete | RRCSetupComplete-IEs, |
| criticalExtensionsFuture | SEQUENCE { } |

}
}

| RRCSetupComplete-IEs ::= | SEQUENCE { |
|---|---|
| selectedPLMN-Identity | INTEGER (1..maxPLMN), |
| registeredAMF | RegisteredAMF |
| OPTIONAL, | |
| guami-Type | ENUMERATED {native, mapped} |
| OPTIONAL, | |
| s-NSSAI-List | SEQUENCE (SIZE (1..maxNrofS-NSSAI)) OF S-NSSAI |
| OPTIONAL, | |
| dedicatedNAS-Message | DedicatedNAS-Message, |
| ng-5G-S-TMSI-Value | CHOICE { |
| ng-5G-S-TMSI | NG-5G-S-TMSI, |
| ng-5G-S-TMSI-Part2 | BIT STRING (SIZE (9)) |
| } OPTIONAL, | |
| lateNonCriticalExtension | OCTET STRING |
| OPTIONAL, | |
| nonCriticalExtension | RRCSetupComplete-v1610-IEs |
| OPTIONAL | |
| } | |
| RRCSetupComplete-v1610-IEs ::= | SEQUENCE { |
| iab-NodeIndication-r16 | ENUMERATED {true} |
| OPTIONAL, | |
| idleMeasAvailable-r16 | ENUMERATED {true} |
| OPTIONAL, | |
| ue-MeasurementsAvailable-r16 | UE-MeasurementsAvailable-r16 |
| OPTIONAL, | |
| mobilityHistoryAvail-r16 | ENUMERATED {true} |
| OPTIONAL, | |
| mobilityState-r16 | ENUMERATED {normal, medium, high, spare} |
| OPTIONAL, | |
| nonCriticalExtension | RRCSetupComplete-v1700-IEs |
| OPTIONAL | |
| } | |
| RRCSetupComplete-v1700-IEs ::= | SEQUENCE { |
| onboardingRequest-r17 | ENUMERATED {true} |
| OPTIONAL, | |

| | |
|---|---|
| nonCriticalExtension | RRCSetupComplete-v1800-IEs |

OPTIONAL

}

| | |
|---|---|
| RRCSetupComplete-v1800-IEs ::= | SEQUENCE { |
| ncr-NodeIndication-r18 | ENUMERATED {true} |

OPTIONAL,

| | |
|---|---|
| nonCriticalExtension | SEQUENCE{ } |

OPTIONAL
}
RegisteredAMF ::= SEQUENCE {

| | | |
|---|---|---|
| plmn-Identity | PLMN-Identity | OPTIONAL, |

| | |
|---|---|
| amf-Identifier | AMF-Identifier |

}
-- TAG-RRCSETUPCOMPLETE-STOP
-- ASN1STOP

TABLE 1.3-2
RRCSetupComplete-IEs field descriptions

guami-Type
This field is used to indicate whether the GUAMI
included is native (derived from native 5G-
GUTI) or mapped (from EPS, derived from EPS
GUTI) as specified in 3GPP TS 24.501.
iab-NodeIndication
This field is used to indicate that the connection is
being established by an IAB-node as
specified in [TS38300].
idleMeasAvailable
Indication that the UE has idle/inactive
measurement report available.
mobilityState
This field indicates the UE mobility state (as defined
in [TS38304], clause 5.2.4.3) just prior to
UE going into RRC_CONNECTED state. The
UE indicates the value of medium and high
when being in Medium-mobility and High-mobility
states respectively. Otherwise the UE
indicates the value normal.
ncr-NodeIndication
This field is used to indicate that the connection is
being established by an NCR-node as
specified in [TS38300].
ng-5G-S-TMSI-Part2
The leftmost 9 bits of 5G-S-TMSI.
onboardingRequest
This field indicates that the connection is being
established for UE onboarding in the selected
onboarding SNPN (see e.g., [TS23501]).
registeredAMF
This field is used to transfer the GUAMI of the AMF
where the UE is registered, as provided
by upper layers (see e.g., 3GPP TS 23.003).
selectedPLMN-Identity
Index of the PLMN or SNPN selected by the
UE from the plmn-IdentityInfoList or npn-
IdentityInfoList fields included in SIB1.
ul-RRC-Segmentation
This field indicates the UE supports uplink RRC
segmentation of UECapabilityInformation.

The Initial UE MESSAGE (e.g., step 3 in FIG. 11) is sent by the NG-RAN node 2316 to transfer an initial layer 3 (L3) message to an AMF 2344 over the NG interface. An example Initial UE MESSAGE is shown by Table 1.3-3.

TABLE 1.3-3

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | ignore |
| RAN UE NGAP ID | M | | 9.3.3.2 | | YES | reject |

{additional parameters/IE discussed in 3GPP TS 38.413 v17.4.0 (2023 Apr. 3) (“[TS38413]”) §
9.2.5.1}

| | | | | | |
|---|---|---|---|---|---|
| RedCap Indication | O | 9.3.1.228 | | YES | ignore |
| NCR Node | O | ENUMERATED | Indication of an | YES | reject |
| Indication | | (true, . . . ) | NCR node | | |

The Initial Context Setup Request message (e.g., step 4 in FIG. 11) is sent by the AMF 2344 to request the setup of a UE context. An example of Initial Context Setup Request message from CN 2320 to gNB 2316 is shown as by Table 1.3-4. An example NCR authorized indication is shown by Table 1.3-5. This IE provides information about the authorization status of the network-controlled repeater (e.g., NCR 102).

TABLE 1.3-4

| IE/Group | | | IE type and | Semantics | | Assigned |
|---|---|---|---|---|---|---|
| Name | Presence | Range | reference | description | Criticality | Criticality |
| Message Type | M | | 9.3.1.1 | | YES | reject |
| AMF UE | M | | 9.3.3.1 | | YES | reject |
| NGAP ID | | | | | | |
| RAN UE | M | | 9.3.3.2 | | YES | reject |
| NGAP ID | | | | | | |

{additional parameters/IE discussed in [TS38413] § 9.2.2.1}

| | | | | |
|---|---|---|---|---|
| NCR | O | 9.3.1.xxx | YES | ignore |
| Authorized | | {see Table 1.3-5} | | |

TABLE 1.3-5

| IE/Group | | | IE type and | Semantics |
|---|---|---|---|---|
| Name | Presence | Range | reference | description |
| NCR | M | | ENUMERATED | Indicates the |
| Authorized | | | (authorized, not | NCR node |
| | | | authorized, . . . ) | authorization |
| | | | | status. |

1.3.1. Initial Access and Cell Selection

Since the gNB 2316 needs to support providing side control information to the NCR 102, the NCR 102 can only request RRC setup towards the cells that support NCR. During cell selection and initial access of NCR 102 (e.g., step 1 in the procedure of FIG. 11), there are two options for the gNB 2316 to indicate whether it can support NCR or not. FIG. 12 shows an example procedure for the first option, and FIG. 13 shows an example procedure for the second option.

1.3.1.1. Ncr Support Indication Initiated by Ran Node

In the first option (see e.g., FIG. 12), if the gNB 2316 supports NCR, it includes an NCR-support indication (“ncr-Support”) in its master information block (MIB) and/or system information block (SIB) and broadcasts the MIB/SIB. By receiving and identifying the ncr-Support in the MIB/SIB, the NCR 102 performs RACH and RRC connection setup procedures with the corresponding cell(s)/RAN nodes, resulting in the NCR 102 sending an RRCSetupComplete message, including an NCR node indication (“ncr-NodeIndication”), such as the RRCSetupComplete message shown by Table 1.3-1 supra.

In some examples, the ncr-Support is included in PLMN-IdentayInfoList of CellAccessRelatedInfo in SIB1. The PLMN-IdentayInfoList IE includes a list of PLMN identity information. An example of PLMN-IdentityInfoList is shown by Table 1.3-6 with corresponding field descriptions in Table 1.3-7 (see e.g., [TS38331]). In another example, the SIB1 in section 1.7.1 infra can be used for this purpose.

TABLE 1.3-6
PLMN-IdentityInfoList information element

-- ASN1START

-- TAG-PLMN-IDENTITYINFOLIST-START

| PLMN-IdentityInfoList ::= | SEQUENCE (SIZE (1..maxPLMN)) OF PLMN-IdentityInfo | |
|---|---|---|
| PLMN-IdentityInfo ::= | SEQUENCE { | |
| plmn-IdentityList | SEQUENCE (SIZE (1..maxPLMN)) OF PLMN-Identity, | |
| trackingAreaCode | TrackingAreaCode | OPTIONAL, -- |
| Need R | | |
| ranac | RAN-AreaCode | OPTIONAL, -- Need |
| R | | |
| cellIdentity | CellIdentity, | |

cellReservedForOperatorUse ENUMERATED {reserved, notReserved},

| ..., | |
|---|---|
| [[ | |
| iab-Support-r16 | ENUMERATED {true} |
| OPTIONAL -- Need S | |
| ]], | |
| [[ | |
| trackingAreaList-r17 | SEQUENCE (SIZE (1..maxTAC-r17)) OF TrackingAreaCode |
| OPTIONAL -- Need R | |
| ]], | |
| [[ | |
| ncr-Support-r18 | ENUMERATED {true} |

OPTIONAL -- Need S

]]
}

-- TAG-PLMN-IDENTITYINFOLIST-STOP

-- ASN1STOP

TABLE 1.3-7
PLMN-IdentityInfo field descriptions

cellReservedForOperatorUse
Indicates whether the cell is reserved for operator
use (per PLMN), as defined in [TS38304].
This field is ignored by IAB-MT.
gNB-ID-Length
Indicates the length of the gNB ID
out of the 36-bit long cellIdentity.
iab-Support
This field combines both the support of IAB and the
cell status for IAB. If the field is present,
the cell supports IAB and the cell is also considered as
a candidate for cell (re)selection for
IAB-node; if the field is absent, the cell does not support
IAB and/or the cell is barred for IAB-
node.
trackingAreaCode
Indicates Tracking Area Code to which the cell
indicated by cellIdentity field belongs. The
absence of the field indicates that the cell only supports
PSCell/SCell functionality (per PLMN)
or is an NTN cell.
trackingAreaList
List of Tracking Areas to which the cell indicated
by cellIdentity field belongs. If this field is
present, network does not configure trackingAreaCode.
Total number of different TACs across
different PLMN-IdentityInfos shall not exceed
maxTAC. This field is only present in an NTN
cell.
ncr-Support
This field combines the support of network-controlled
repeater. If the field is present, the cell
supports network-controlled repeater and the cell
is also considered as a candidate for cell
(re)selection for network-controlled repeater; if the
field is absent, the cell does not support
network-controlled repeater and/or the cell is
barred for network-controlled repeater.

1.3.1.2. Cn Authorizes Ran Node to Support Ncr

In the second option (see e.g., FIG. 13), the gNB 2316 first receives an NCR-support indication (“NCR-supported”) in an NG Setup message from the CN 2320 (or NF in the CN 2320) via the NG interface. The NCR-supported provides authorization for the gNB 2316 to support NCR. After receiving the NCR-supported from the CN 2320 (or NF in the CN 2320), the gNB 2316 forwards or otherwise provides an NCR-support indication (ncr-Support) in an MIB/SIB broadcast in the same or similar manner as discussed previously w.r.t FIG. 12.

In some examples, the NG Setup message is an NG Setup Request message, which is sent by the NG-RAN node 2316 to transfer application layer information for an NG-C interface instance (e.g., NG-RAN node 2316 AMF 2344). In other examples, the NG Setup message is an NG Setup Response message, which is sent by the AMF 2344 to the NG-RAN node 2316 (e.g., gNB 2316) to transfer application layer information for an NG-C interface instance. Examples of the NCR-supported included in an NG Setup Request message is shown by Table 1.3-8.

TABLE 1.3-8

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF Name | M | | 9.3.3.21 | | YES | reject |

{additional parameters/IE discussed in [TS38413] § 9.2.6.2}

| | | | | | |
|---|---|---|---|---|---|
| NCR Supported | O | ENUMERATED | Indication of | YES | ignore |
| | | (true, . . . ) | support for | | |
| | | | network- | | |
| | | | controlled | | |
| | | | repeater. | | |

1.3.2. Protocol Stack and Reduced Functionality for Ncr

To support communication with the CN 2320, NAS is required to be established on top of RRC. An example protocol stack for NCR 102 during initial access is shown FIG. 14. After RRCSetupComplete, two options are considered for the NCR-MT 120. In the first option, the same protocol stack that is used for initial access is continued to be used. For the first option, the functionality of the NCR-MT 120 is the same as option 1 discussed in section 1.2.2.1, supra. In the second option, only the MAC and PHY layers are used after initial access is performed. For the second option, the protocol stack and functionality of the NCR-MT 120 is the same as option 2 in section 1.2.2.2, supra.

1.4. Authentication and Identification by Core Network as a Normal Ue

Compared with the embodiments discussed previously in section 1.3, in these embodiments, to reduce impact to the CN 2320, the CN 2320 provides authentication to the NCR 102 as a normal UE 2302 without knowing it is an NCR 102. In other words, the NCR 102 is transparent to the CN 2320 in these embodiments. An example procedure for these embodiments is shown by FIG. 15, which may operate as follows.

Step 1: the NCR 102 performs cell selection and RACH following normal UE procedures, as defined in [TS38304] and [TS38331].

Step 2: the NCR 102 sends an RRCSetupComplete message to the gNB 2316. The RRCSetupComplete message includes an NCR-indication parameter/IE and/or other relevant IEs/parameters.

Step 3: the gNB 2316 sends an Initial UE MESSAGE to the CN 2320 (or relevant NF(s) in the CN 2320, such as an AMF 2344) over the NG interface to request UE context as is done for normal UEs 2302, without indicating NCR to the CN 2320 (e.g., the Initial UE MESSAGE does not include an NCR-indication).

Step 4: the CN 2320 (or relevant NF(s) in the CN 2320) provides authentication and identification to/towards the NCR 102 as a normal UE 2302. In this example, the CN 2320 (or relevant NF) sends an Initial Context Setup Request message to the NG-RAN 2314 (e.g., gNB 2316), which does not include the NCR-authorized IE discussed previously.

Step 5: the gNB 2316 establishes UE context for NCR-MT 120 based on the configuration received from the CN 2320.

In this embodiment, the RRCSetupComplete message sent to the gNB 2316 includes the NCR-indication as discussed previously in section 1.3. No other changes or new IEs are defined in the Initial UE MESSAGE and/or Initial Context Setup Request/Response message.

1.4.1. Initial Access and Cell Selection

To avoid impacts to the CN 2320, initial access and gNB 2316 indication to NCR 102 in this embodiment considers the same mechanisms as discussed in section 1.3.1.1.

1.4.2. Protocol Stack and Reduced Functionality for Ncr

In this embodiment, the protocol stack options and reduced functionality of NCR-MT 120 is the same as discussed in section 1.3.2.

1.5. Initial Access Via Mac Ce

In this embodiment, instead of performing RRC procedures for connection establishment, initial access via MAC CE (e.g., MSG3, MSG4, and/or the like) is used instead of using RRC messages. By using MAC CE(s) during the RACH procedure, the NCR-MT 120 can further simplify its protocol stack to only the MAC and PHY layers during initial access as discussed in sections 1.2, 1.3, and 1.4. Two options are considered for these embodiments.

1.5.1. Mac Ce as Msg3 with Ncr Identity

In a first option, a MAC CE as MSG3 replaces the RRCSetupRequest message, as is shown by the procedure of FIG. 17. In this option, RRCSetup and RRCSetupComplete messages are skipped. The procedure of FIG. 17 may operate as follows:

Step 1: the NCR 102 sends a Msg1 (Preamble) to the gNB 2316.

Step 2: the NCR 102 starts timer T300 and starts decoding the PDCCH for a random access RNTI (RA-RNTI).

Step 3: the gNB 2316 sends PDCCH downlink control information (DCI) Format 1_0 [RA-RNTI] to the NCR 102. The PDCCH DCI Format 1_0 includes configuration/information such as, for example, frequency domain (FD) resource assignment, time domain (TD) resource assignment, DL MCS for random access response (RAR), and/or other relevant parameters/data.

Step 4: the gNB 2316 sends a Msg2 (RAR) to the NCR 102. The Msg2 (RAR) can include information/data such as, for example, Timing Advance Command (TAC), temporary C-RNTI, UL grant, backoff indicator (BI), random access preamble identifier (RAPID) field, and/or other data/parameters (see e.g., [TS38321]).

Step 5: the NCR 102 (UE 2302) picks/selects a random ID for contention resolution.

Step 6: the NCR 102 sends a first MAC CE (MAC CE1) to the gNB 2316 including NCR identity (e.g., NCR-id/NCR-sig) only. Here, the NCR identity may be the same or similar as any of the other NCR-sigs/NCR-ids discussed herein, which may be configured by an OAM 150 or CN 2320 in a same or similar manner as discussed previously.

Step 7: the gNB 2316 sends a second MAC CE (MAC CE2) to the NCR 102. The MAC CE2 may be a UE contention resolution identity MAC CE including a UE contention resolution identity.

Step 8: the gNB 2316 and/or the NCR 102 start service as a network-controlled repeater (e.g., by performing amplify-and-forwarding services for the gNB 2316, one or more UEs 2302, and/or other network elements/nodes). After receiving UE contention resolution identity MAC CE, the NCR 102 and the and gNB 2316 complete the RACH procedure, and the NCR 102 is able to receive side control information from the gNB 2316.

FIG. 18a shows an example MAC CE as MSG3 (referred to herein as “MSG3”) that may be used in the procedure of FIG. 17 (e.g., at step 6). In this example, the MSG3 includes an NCR indicator field(s) (or NCR-sig field(s)) that carries the NCR's 102 NCR-sig/id, which may be configured by the OAM 150 and/or the CN 2320 (or NF(s) therein) as discussed previously. The NCR-sig/id carried by the NCR indicator field(s) may be the same or similar as discussed previously w.r.t FIGS. 3, 4, and 6.

The MSG3 is transmitted via the common control channel (CCCH) to the gNB 2316 (see e.g., [TS38321]). Based on receipt of the MSG3, the gNB 2316 sends a UE contention resolution identity MAC CE to the NCR 102 (e.g., step 7 in FIG. 17) indicating that the contention resolution is solved if the content is the same as MSG3 (e.g., configured NCR-id/sigs match the NCR-id/sig in the MSG3). An example of the UE contention resolution identity MAC CE is shown by FIG. 18b. The UE Contention Resolution Identity MAC CE is identified by MAC subheader with Logical Channel ID (LCID) as specified in Table 6.2.1-1 of [TS38321] (e.g., codepoint/index of “62”), and has a fixed 48-bit size. The UE Contention Resolution Identity MAC CE includes a UE Contention Resolution Identity field that contains the UL CCCH service data unit (SDU). If the UL CCCH SDU is longer than 48 bits, this field contains the first 48 bits of the UL CCCH SDU. Additionally, the MAC CEs in FIGS. 18a and 18b can also include a MAC subheader, such as those discussed in [TS38321].

Additionally or alternatively, a preamble (e.g., random access preamble or the like in the Msg1) can provide an identification as an NCR 102 to the gNB 2316. Additionally or alternatively, any the MAC CEs used in the procedure of FIG. 17 can include any of those discussed in section 1.8 infra.

1.5.2. Mac Ce as MSG3 with Random UE Identity

The second option includes the procedure shown by FIG. 19, which includes the same steps 1 to 5 as shown and described previously w.r.t FIG. 17. Steps 6 to 8 in FIG. 19 may be as follows.

Step 6: the NCR 102 sends a first MAC CE (MAC CE1) to the gNB 2316 including random UE identity (or random NCR identity) only. Here, the MAC CE1 may be the MSG3, which includes a random UE identity. The random UE identity may be the same or similar as any of those included in the RRCSetupRequest shown by Table 1.2-1, supra.

Step 7: the gNB 2316 sends a second MAC CE (MAC CE2) to the NCR 102 including UE contention resolution identity MAC CE (see e.g., FIG. 18b).

Step 8: the NCR 102 sends a third MAC CE (MAC CE3) to the gNB 2316 that includes a network-controlled repeater indicator. If contention resolution is solved, the NCR 102 sends a MAC CE as (or instead of) an RRCSetupComplete message (e.g., MAC CE3) indicating a successful RRC setup. The MAC CE as RRCSetupComplete may include an NCR indication, NCR-sig/NCR-id, selected PLMN identity, and/or the like.

FIG. 20a shows an example MSG3 that may be used for the procedure of FIG. 19. In this example, the MSG3 includes a reserved bit field (R) and one or more UE identity fields. The UE identity field(s) carry an NCR indication, an NCR-sig or NCR-id, a selected PLMN identity, and/or some other identifier/network address, such as any of those discussed herein.

FIG. 20b shows an example MAC CE as RRCSetupComplete that may be used for the procedure of FIG. 19. In this example, the MAC CE as RRCSetupComplete includes a set of reserved bit fields (R), a 1 bit NCR indicator field (e.g., labeled as “NCR” in FIG. 20b), and a selected PLMN identity field. In some examples, if the NCR indicator field has a value of 1, it represents it is an NCR (and/or that the selected PLMN identity in the selected PLMN identity field is an NCR identity/indicator), and if the NCR indicator field has a value of 0, it represents it is not an NCR (and/or that the selected PLMN identity in the selected PLMN identity field is not an NCR identity/indicator). The selected PLMN identity is an index of the PLMN selected by the UE 2306 from the plmn-IdentityInfoList or npn-IdentityInfoList fields included in SIB1 (see e.g., SIB1 in section 1.7.1 infra) or the index of candidate cell provided by the OAM 150 or CN 2320.

Additionally or alternatively, any the MAC CEs used in the procedures of FIGS. 17 and 19 can include any of those discussed in section 1.8 infra.

1.6. UE Capability Parameters

UE capability parameters have hierarchical structure. In the following tables of UE capability parameters, “Per” indicates the level the associated parameter is included. “UE” in the column indicates the associated parameter is signaled per UE, “Band” indicates it is signaled per band, “BC” indicates it is signaled per band combination, “FS” indicates it is signaled per feature set (per band per band combination), “FSPC” indicates it is signaled per feature set per component carrier (per CC per band per band combination), and “FD” in the column indicates to refer the associated field description. The UE may support different functionalities between FDD and TDD, and/or between FR1 and FR2. The UE shall indicate the UE capabilities as follows. In the table of UE capability parameter in subsequent clauses, “Yes” in the column by “FDD-TDD DIFF” and “FR1-FR2 DIFF” indicates the UE capability field can have a different value for between FDD and TDD or between FR1 and FR2 and “No” indicates if it cannot. “(Incl FR2-2 DIFF)” in the column by “FR1-FR2 DIFF” indicates the UE capability field can have a different value for between FR2-1 and FR2-2. Regarding to the per UE capabilities that are FDD/TDD differentiated (i.e. capabilities indicated as “Yes” in the column by “FDD-TDD DIFF”), the corresponding capabilities indicated by the FDD capability is applied to SUL if SUL band is supported by the UE. “FD” in the column indicates to refer the associated field description. “FR1 only” or “FR2 only” in the column indicates the associated feature is only supported in FR1 or FR2 and “TDD only” indicates the associated feature is only supported in TDD and not applicable to SUL carriers. “N/A” in the column indicates it is not applicable to the feature (e.g., the signaling supports the UE to have different values between FDD and TDD or between FR1 and FR2).

TABLE 1.6-1
General Parameters

| | | | FDD- | FR1- |
|---|---|---|---|---|
| | | | TDD | FR2 |
| Definitions for parameters | Per | M | DIFF | DIFF |
| accessStratumRelease | UE | Yes | No | No |
| Indicates the access stratum release the | | | | |
| UE supports as specified in [TS38331] | | | | |
| delay BudgetReporting | UE | No | No | No |
| Indicates whether the UE supports delay | | | | |
| budget reporting as specified | | | | |
| in [TS38331]. | | | | |
| dl-DedicatedMessageSegmentation-r16 | UE | No | No | No |
| Indicates whether the UE supports | | | | |
| reception of segmented DL RRC | | | | |
| messages. | | | | |
| drx-Preference-r16 | UE | No | No | No |
| Indicates whether the UE supports | | | | |
| providing its preference of a cell | | | | |
| group on DRX parameters for power | | | | |
| saving in RRC_CONNECTED, | | | | |
| as specified in [TS38331]. | | | | |
| gNB-SideRTT-BasedPDC-r17 | UE | No | No | No |
| Indicates whether the UE supports | | | | |
| gNB-side RTT-based PDC, as | | | | |
| specified in TS 38.300 [28]. A UE | | | | |
| supporting this feature shall also | | | | |
| support rtt-BasedPDC-CSI-RS-ForTracking- | | | | |
| r17 and/or rtt- | | | | |
| BasedPDC-PRS-r17. | | | | |
| inactiveState | UE | Yes | No | No |
| Indicates whether the UE supports | | | | |
| RRC_INACTIVE as specified in | | | | |
| [TS38331]. This capability is not | | | | |
| applicable to NCR-MT. | | | | |
| inactiveStateNTN-r17 | UE | CY | No | No |
| Indicates whether the UE supports | | | | |
| RRC_INACTIVE in NTN as | | | | |
| specified in [TS38331]. It is mandated if | | | | |
| the UE indicates the support | | | | |
| of nonTerrestrialNetwork-r17. | | | | |
| inactiveStatePO-Determination-r17 | UE | No | No | No |
| Indicates whether the UE supports to | | | | |
| use the same i_s to determine | | | | |
| PO in RRC_INACTIVE state as in | | | | |
| RRC_IDLE state. | | | | |
| inDeviceCoexInd-r16 | UE | No | No | No |
| Indicates whether the UE supports IDC | | | | |
| (In-Device Coexistence) | | | | |
| assistance information as specified in [TS38331]. | | | | |
| maxBW-Preference-r16, maxBW-Preference-r17 | UE | No | No | Yes |
| group on the maximum aggregated | | | | (Incl |
| bandwidth for power saving in | | | | |
| RRC_CONNECTED, as specified in [TS38331]. | | | | FR2-2 |
| Indicates whether the UE supports | | | | DIFF) |
| providing its preference of a cell | | | | |
| maxCC-Preference-r16 | UE | No | No | No |
| Indicates whether the UE supports | | | | |
| providing its preference of a cell | | | | |
| group on the maximum number of | | | | |
| secondary component carriers for | | | | |
| power saving in RRC_CONNECTED, as | | | | |
| specified in [TS38331]. | | | | |
| maxMIMO-LayerPreference-r16, | UE | No | No | Yes |
| maxMIMO-LayerPreference-r17 | | | | |
| Indicates whether the UE supports | | | | (Incl |
| providing its preference of a cell | | | | |
| group on the maximum number of MIMO | | | | FR2-2 |
| layers for power saving in | | | | |
| RRC_CONNECTED, as specified in [TS38331]. | | | | DIFF) |
| maxMRB-Add-r17 | UE | No | No | No |
| Indicates the additional maximum | | | | |
| number of MRBs that the UE | | | | |
| supports for MBS multicast reception as | | | | |
| specified in [TS38331] | | | | |
| mcgRLF-Recovery ViaSCG-r16 | UE | No | No | No |
| Indicates whether the UE supports recovery | | | | |
| from MCG RLF via split | | | | |
| SRB1 (if supported) and via SRB3 (if | | | | |
| supported) as specified in TS | | | | |
| 38.331[9]. | | | | |
| minSchedulingOffsetPreference-r16 | UE | No | No | No |
| Indicates whether the UE supports | | | | |
| providing its preference on the | | | | |
| minimum scheduling offset for cross- | | | | |
| slot scheduling of the cell group | | | | |
| for power saving in RRC_CONNECTED, | | | | |
| as specified in [TS38331]. | | | | |
| mpsPriorityIndication-r16 | UE | No | No | No |
| Indicates whether the UE supports | | | | |
| mpsPriorityIndication on RRC | | | | |
| release with redirect as defined in [TS38331]. | | | | |
| musim-GapPreference-r17 | UE | No | No | No |
| Indicates whether the UE supports | | | | |
| providing MUSIM assistance | | | | |
| information with MUSIM gap preference | | | | |
| and related MUSIM gap | | | | |
| configuration, as defined in [TS38331]. | | | | |
| UE supporting this feature | | | | |
| supports 3 periodic gaps and 1 aperiodic gap. | | | | |
| musimLeaveConnected-r17 | UE | No | No | No |
| Indicates whether the UE supports | | | | |
| providing MUSIM assistance | | | | |
| information with indication of leaving | | | | |
| RRC_CONNECTED state as | | | | |
| defined in [TS38331]. | | | | |
| nonTerrestrialNetwork-r17 | UE | No | No | No |
| Indicates whether the UE supports | | | | |
| NR NTN access. If the UE | | | | |
| indicates this capability the UE shall support | | | | |
| the following NTN | | | | |
| essential features, e.g., timer extension | | | | |
| in MAC/RLC/PDCP layers | | | | |
| and RACH adaptation to handle long | | | | |
| RTT, acquiring NTN specific | | | | |
| SIB and more than one TAC per PLMN | | | | |
| broadcast in one cell. | | | | |
| ntn-ScenarioSupport-r17 | UE | No | No | No |
| Indicates whether the UE supports the | | | | |
| NTN features in GSO scenario | | | | |
| or NGSO scenario. If a UE does not include | | | | |
| this field but includes | | | | |
| nonTerrestrialNetwork-r17, the UE | | | | |
| supports the NTN features for | | | | |
| both GSO and NGSO scenarios, and | | | | |
| also supports mobility between | | | | |
| GSO and NGSO scenarios. | | | | |
| onDemandSIB-Connected-r16 | UE | No | No | No |
| Indicates whether the UE supports the | | | | |
| on-demand request procedure | | | | |
| of SIB(s) or posSIB(s) while in | | | | |
| RRC_CONNECTED, as specified in | | | | |
| [TS38331]. | | | | |
| overheatingInd | UE | No | No | No |
| Indicates whether the UE supports | | | | |
| overheating assistance | | | | |
| information. | | | | |
| pei-SubgroupingSupportBandList-r17 | UE | No | No | No |
| Indicates whether the UE supports | | | | |
| receiving paging early indication | | | | |
| in DCI format 2_7 as specified in | | | | |
| TS38.304 [21] for a list of | | | | |
| frequency band. The UE shall support | | | | |
| UEID based subgrouping for a | | | | |
| frequency band if it indicates supporting | | | | |
| of paging early indication | | | | |
| reception for the frequency band. | | | | |
| The set of OFDM symbols within a | | | | |
| slot where UE can monitor the PEI PDCCH | | | | |
| in Type 2A CSS is the | | | | |
| same as the requirement for paging PDCCH | | | | |
| in Type 2 CSS for IDLE | | | | |
| and INACTIVE mode UEs. | | | | |
| partialFR2-FallbackRX-Req | UE | No | No | No |
| Indicates whether the UE meets only a | | | | |
| partial set of the UE minimum | | | | |
| receiver requirements for the eligible | | | | |
| FR2 fallback band | | | | |
| combinations as defined in Clause | | | | |
| 4.2 of TS 38.101-2 [3] and Clause | | | | |
| 4.2 of TS 38.101-3 [4]. If not indicated, the | | | | |
| UE shall meet all the UE | | | | |
| minimum receiver requirements for all the | | | | |
| FR2 fallback | | | | |
| combinations in TS 38.101-2 [3] and TS | | | | |
| 38.101-3 [4]. The UE shall | | | | |
| support configuration of any of the FR2 | | | | |
| fallback band combinations | | | | |
| regardless of the presence or the absence | | | | |
| of this field. | | | | |
| ra-SDT-r17 | UE | No | No | No |
| Indicates whether the UE supports transmission | | | | |
| of data and/or | | | | |
| signalling over allowed radio bearers | | | | |
| in RRC_INACTIVE state via | | | | |
| Random Access procedure (i.e., RA-SDT) | | | | |
| with 4-step RA type and if | | | | |
| UE supports twoStepRACH-r16, with | | | | |
| 2-step RA type, as specified in | | | | |
| [TS38331]. | | | | |
| ra-SDT-NTN-r17 | UE | No | No | No |
| Indicates whether the UE supports | | | | |
| transmission of data and/or | | | | |
| signalling over allowed radio bearers | | | | |
| in RRC_INACTIVE state in | | | | |
| NTN via Random Access procedure | | | | |
| (i.e., RA-SDT) with 4-step RA | | | | |
| type and if UE supports twoStepRACH-r16 | | | | |
| for NTN, with 2-step RA | | | | |
| type, as specified in [TS38331]. A UE | | | | |
| supporting this feature shall | | | | |
| also indicate the support of | | | | |
| nonTerrestrialNetwork-r17. | | | | |
| redirectAtResumeByNAS-r16 | UE | No | No | No |
| Indicates whether the UE supports | | | | |
| reception of redirectedCarrierInfo | | | | |
| in an RRCRelease message in response to | | | | |
| an RRCResume Request or | | | | |
| RRCResumeRequest1 which is triggered | | | | |
| by the NAS layer, as | | | | |
| specified in [TS38331]. | | | | |
| reducedCP-Latency | UE | No | No | No |
| Indicates whether the UE supports | | | | |
| reduced control plane latency as | | | | |
| defined in [TS38331] | | | | |
| referenceTimeProvision-r16 | UE | No | No | No |
| Indicates whether the UE supports | | | | |
| provision of referenceTimeInfo in | | | | |
| DLInformationTransfer message and in | | | | |
| SIB9 and reference time | | | | |
| information preference indication | | | | |
| via assistance information, as | | | | |
| specified in [TS38331]. | | | | |
| releasePreference-r16 | UE | No | No | No |
| Indicates whether the UE supports | | | | |
| providing its preference assistance | | | | |
| information to transition out of | | | | |
| RRC_CONNECTED for power | | | | |
| saving, as specified in [TS38331]. | | | | |
| resumeWithStoredMCG-SCells-r16 | UE | No | No | No |
| Indicates whether the UE supports not | | | | |
| deleting the stored MCG SCell | | | | |
| configuration when initiating the | | | | |
| resume procedure. | | | | |
| resumeWithStoredSCG-r16 | UE | No | No | No |
| Indicates whether the UE supports | | | | |
| not deleting the stored SCG | | | | |
| configuration when initiating resume. | | | | |
| The UE which indicates | | | | |
| support for resume WithStoredSCG-r16 | | | | |
| shall also indicate support for | | | | |
| resumeWithSCG-Config-r16. | | | | |
| resumeWithSCG-Config-r16 | UE | No | No | No |
| Indicates whether the UE supports | | | | |
| (re-)configuration of an SCG | | | | |
| during the resume procedure. | | | | |
| sliceInfoforCellReselection-r17 | UE | No | No | No |
| Indicates whether the UE supports | | | | |
| slice-based cell reselection | | | | |
| information in SIB and on RRC | | | | |
| release for slice-based cell | | | | |
| reselection in RRC_IDLE and RRC | | | | |
| INACTIVE as defined in 3GPP | | | | |
| TS 38.304. | | | | |
| splitSRB-WithOneUL-Path | UE | No | No | No |
| Indicates whether the UE supports | | | | |
| UL transmission via MCG path | | | | |
| and DL reception via either MCG path | | | | |
| or SCG path, as specified for | | | | |
| the split SRB in TS 37.340 [7]. The UE shall | | | | |
| not set the FDD/TDD | | | | |
| specific fields for this capability (i.e. it | | | | |
| shall not include this field in | | | | |
| UE-MRDC-CapabilityAddXDD-Mode) | | | | |
| splitDRB-withUL-Both-MCG-SCG | UE | Yes | No | No |
| Indicates whether the UE supports UL | | | | |
| transmission via both MCG | | | | |
| path and SCG path for the split DRB | | | | |
| as specified in 3GPP TS 37.340. | | | | |
| The UE shall not set the FDD/TDD | | | | |
| specific fields for this capability | | | | |
| (i.e. it shall not include this field in UE- | | | | |
| MRDC-CapabilityAddXDD-Mode). | | | | |
| srb3 | UE | Yes | No | No |
| Indicates whether the UE supports | | | | |
| direct SRB between the SN and | | | | |
| the UE as specified in TS 37.340 [7]. | | | | |
| The UE shall not set the | | | | |
| FDD/TDD specific fields for this | | | | |
| capability (i.e. it shall not include | | | | |
| this field in UE-MRDC-CapabilityAddXDD- | | | | |
| Mode). This field is not | | | | |
| applied to NE-DC. | | | | |
| srb-SDT-NTN-r17 | UE | No | No | No |
| Indicates whether the UE supports | | | | |
| the usage of signalling radio | | | | |
| bearer SRB2 over RA-SDT or CG-SDT | | | | |
| in NTN, as specified in | | | | |
| [TS38331]. | | | | |
| A UE supporting this feature shall | | | | |
| also indicate support of ra-SDT- | | | | |
| NTN-r17, or cg-SDT-r17 in NTN bands. | | | | |
| A UE supporting this feature | | | | |
| shall also indicate the support of | | | | |
| nonTerrestrialNetwork-r17. | | | | |
| srb-SDT-r17 | UE | No | No | No |
| Indicates whether the UE supports | | | | |
| the usage of signalling radio | | | | |
| bearer SRB2 over RA-SDT or CG-SDT, | | | | |
| as specified in [TS38331]. | | | | |
| A UE supporting this feature shall also indicate | | | | |
| support of ra-SDT-r17 or cg-SDT-r17. | | | | |
| ul-GapFR2-Pattern-r17 | UE | CY | No | FR2 |
| Indicates FR2 UL gap pattern(s) supported | | | | only |
| by the UE for NR SA, for | | | | |
| NR-DC without FR2-FR2 band combination, | | | | |
| for NE-DC, and for | | | | |
| (NG)EN-DC, if UE supports a band in FR2. | | | | |
| The leading/leftmost bit | | | | |
| (bit 0) corresponds to the FR2 UL gap | | | | |
| pattern 0, the next bit | | | | |
| corresponds to the FR2 UL gap pattern 1, | | | | |
| as specified in TS 38.133 | | | | |
| [5] and so on. The UE shall set at least one | | | | |
| of the bits to 1 for FR2 | | | | |
| UL gap pattern 1 and 3, if the UE indicates | | | | |
| support for ul-GapFR2- | | | | |
| r17 in an FR2 band. | | | | |
| ul-RRC-Segmentation-r16 | UE | No | No | No |
| Indicates whether the UE supports | | | | |
| uplink RRC segmentation of | | | | |
| UECapabilityInformation as | | | | |
| specified in [TS38331]. | | | | |

Table 1.6-2 captures feature groups, which may or may not be mandatory for an NCR-MT 120. CA, MR-DC, handover (e.g., CHO, DAPS, CPAC, and/or the like) related UE features and corresponding capabilities are not supported by an NCR-MT 120. All other feature groups or components of the feature groups as captured in 3GPP TR 38.822 as well as capabilities specified in this disclosure are optional for an NCR-MT 120, unless indicated otherwise. General parameters, SDAP parameters, PDCP parameters, and RLC parameters are shown by tables 1.6-3, 1.6-4, 1.6-5 and 1.6-65, respectively.

TABLE 1.6-2
Layer-2 and Layer-3 NCR-MT features

| | | Feature | | Additional |
|---|---|---|---|---|
| Features | Index | group | Components | information |
| 0. | 0-0 | NCR | 1) Side control | |
| General | | procedures | information | |
| | | | over MAC CE and | |
| | | | RRC, as specified in | |
| | | | [TS38321] and | |
| | | | [TS38331], | |
| | | | respectively. | |
| | | | 2) Switching OFF NCR- | |
| | | | Fwd during radio link | |
| | | | failure in [TS38331], | |
| | | | beam failure recovery in | |
| | | | [TS38321], and cell | |
| | | | reselection in [TS38304]. | |
| 1. PDCP | 1-0 | Basic | 1) (de)Ciphering on SRB | |
| | | PDCP | 2) Integrity protection | |
| | | procedures | on SRB | |
| | | | 4) Re-ordering and | |
| | | | in-order delivery | |
| | | | 6) Duplicate discarding | |
| | | | 7) 12bits SN | |
| 2. RLC | 2-0 | Basic RLC | 1) RLC TM | |
| | | procedures | 2) RLC AM with | |
| | | | 12bits SN | |
| | 2-4 | NR RLC | NR RLC SN size | |
| | | SN size | for SRB | |
| | | for SRB | | |
| 3. MAC | 3-0 | Basic | 1) RA procedure | |
| | | MAC | on PCell | |
| | | procedures | 2) NCR-MT initiated | |
| | | | RA procedure (including | |
| | | | for beam | |
| | | | recovery purpose) | |
| | | | 3) NW initiated RA | |
| | | | procedure (i.e. based on | |
| | | | PDCCH) | |
| | | | 4) Support of ssb- | |
| | | | Threshold and | |
| | | | association between | |
| | | | preamble/PRACH | |
| | | | occasion and SSB | |
| | | | 5) Preamble grouping | |
| | | | 6) UL single | |
| | | | TA maintenance | |
| | | | 7) HARQ operation | |
| | | | for DL and UL | |
| | | | 8) LCH prioritization | |
| | | | 9) Prioritized bit rate | |
| | | | 10) Multiplexing | |
| | | | 11) SR with single | |
| | | | SR configuration | |
| | | | 12) BSR | |
| | | | 13) PHR | |
| | | | 14) 8bits and 16bits | |
| | | | L field | |
| 9. RRC | 9-1 | RRC | Maximum overall RRC | 45 Kbytes |
| | | buffer size | configuration size | |
| | 9-2 | RRC | 1) RRC connection | 1) to 3) 10 ms |
| | | processing | establishment | 4) 10 ms |
| | | time | 3) RRC connection | 5): 10 ms + |
| | | | reconfiguration without | additional |
| | | | SCell addition/ | delay |
| | | | release and SCG | (cell search |
| | | | establishment/ | time and |
| | | | modification/release | synchronization) |
| | | | 4) RRC connection | defined in TS |
| | | | re-establishment. | 38.133 |
| | | | 5) RRC connection | 8) 5 ms |
| | | | reconfiguration with | 10) 80 ms |
| | | | sync procedure | |
| | | | 8) Initial security | |
| | | | activation | |
| | | | 10) UE capability | |
| | | | transfer | |

TABLE 1.6-3
General Parameters

| | | | FDD- | FR1- |
|---|---|---|---|---|
| | | | TDD | FR2 |
| Definitions for parameters | Per | M | DIFF | DIFF |
| inactiveStateNCR-r18 | NCR- | No | No | No |
| Indicates whether the NCR-MT | MT | | | |
| supports RRC_INACTIVE as | | | | |
| specified in [TS38331]. | | | | |
| supportedNumberOfDRBs-NCR-r18 | NCR- | No | No | No |
| Indicates the number of DRB that | MT | | | |
| NCR-MT supports. If absent, | | | | |
| NCR-MT does not support DRB. | | | | |
| If absent, NCR-MT also does not | | | | |
| support SDU discard in PDCP and RLC, | | | | |
| and counter check in RRC. | | | | |
| nonDRB-NCR-r18 | NCR- | No | No | No |
| Indicates whether the NCR-MT | MT | | | |
| supports SRB2 configuration without | | | | |
| a DRB, as specified in [TS38331]. | | | | |

TABLE 1.6-4
SDAP Parameters

| | | | FDD- | FR1- |
|---|---|---|---|---|
| | | | TDD | FR2 |
| Definitions for parameters | Per | M | DIFF | DIFF |
| sdap-QOS-NCR-r18 | NCR- | No | No | No |
| Indicates whether the NCR-MT | MT | | | |
| supports flow-based QoS and | | | | |
| multiple flows to 1 DRB mapping, | | | | |
| as specified in TS 37.324 [25]. | | | | |
| sdap-HeaderNCR-r18 | NCR- | No | No | No |
| Indicates whether the NCR-MT | MT | | | |
| supports UL SDAP header and | | | | |
| SDAP End-marker, as | | | | |
| specified in TS 37.324 [25]. | | | | |

TABLE 1.6-5
PDCP Parameters

| | | | FDD- | FR1- |
|---|---|---|---|---|
| | | | TDD | FR2 |
| Definitions for parameters | Per | M | DIFF | DIFF |
| longSN-NCR-r18 | NCR- | No | No | No |
| Indicates whether the NCR-MT | MT | | | |
| supports 18 bit length of PDCP | | | | |
| sequence number. | | | | |

TABLE 1.6-6
RLC Parameters

| | | | FDD- | FR1- |
|---|---|---|---|---|
| | | | TDD | FR2 |
| Definitions for parameters | Per | M | DIFF | DIFF |
| am-WithLongSN-NCR-r18 | NCR- | No | No | No |
| Indicates whether the NCR-MT | MT | | | |
| supports AM DRB with 18 bit length | | | | |
| of RLC sequence number. | | | | |

1.7. Additional RRC Aspects for NCR

1.7.1. System Information Block 1 (SIB1)

SIB1 contains information relevant when evaluating if a UE is allowed to access a cell and defines the scheduling of other system information. It also contains radio resource configuration information that is common for all UEs and barring information applied to the unified access control. Signalling radio bearer: N/A; RLC-SAP: TM; Logical channels: BCCH; and Direction: Network to UE. An example SIB1 message is shown by Table 1.7-1 with corresponding field descriptions in Table 1.7-2.

TABLE 1.7-1
SIB1 message

```
-- ASN1START
-- TAG-SIB1-START
SIB1 ::= SEQUENCE {
  cellSelectionInfo SEQUENCE {
  q-RxLevMin Q-RxLevMin,
  q-RxLevMinOffset INTEGER (1..8) OPTIONAL, -- Need S
  q-RxLevMinSUL Q-RxLevMin OPTIONAL, -- Need R
  q-QualMin Q-QualMin OPTIONAL, -- Need S
  q-QualMinOffset INTEGER (1..8) OPTIONAL -- Need S
  } OPTIONAL, -- Cond Standalone
  cellAccessRelatedInfo CellAccessRelatedInfo,
  connEstFailureControl ConnEstFailureControl OPTIONAL, -- Need R
  si-SchedulingInfo SI-SchedulingInfo OPTIONAL, -- Need R
  servingCellConfigCommon ServingCellConfigCommonSIB
  OPTIONAL, -- Need R
  ims-EmergencySupport ENUMERATED {true} OPTIONAL, --
  Need R
  eCallOverIMS-Support ENUMERATED {true} OPTIONAL, --
  Need R
  ue-TimersAndConstants UE-TimersAndConstants OPTIONAL, --
  Need R
  uac-BarringInfo SEQUENCE {
  uac-BarringForCommon UAC-BarringPerCatList OPTIONAL, --
  Need S
  uac-BarringPerPLMN-List UAC-BarringPerPLMN-List OPTIONAL,
  -- Need S
  uac-BarringInfoSetList UAC-BarringInfoSetList,
  uac-AccessCategory1-SelectionAssistanceInfo CHOICE {
    plmnCommon UAC-AccessCategory1-SelectionAssistanceInfo,
    individualPLMNList SEQUENCE (SIZE (2..maxPLMN)) OF
    UAC-AccessCategory1-
SelectionAssistanceInfo
  } OPTIONAL -- Need S
  } OPTIONAL, -- Need R
  useFullResumeID ENUMERATED {true} OPTIONAL, -- Need R
  lateNonCriticalExtension OCTET STRING OPTIONAL,
  nonCriticalExtension SIB1-v1610-IEs OPTIONAL
}
SIB1-v1610-IEs ::= SEQUENCE {
  idleModeMeasurementsEUTRA-r16 ENUMERATED{true}
  OPTIONAL, -- Need R
  idleModeMeasurementsNR-r16 ENUMERATED{true} OPTIONAL,
  -- Need R
  posSI-SchedulingInfo-r16 PosSI-SchedulingInfo-r16 OPTIONAL,
  -- Need R
  nonCriticalExtension SIB1-v1630-IEs OPTIONAL
}
SIB1-v1630-IEs ::= SEQUENCE {
  uac-BarringInfo-v1630 SEQUENCE {
  uac-AC1-SelectAssistInfo-r16 SEQUENCE (SIZE (2..maxPLMN)) OF
UAC-AC1-SelectAssistInfo-r16
  } OPTIONAL, -- Need R
  nonCriticalExtension SIB1-v1700-IEs OPTIONAL
}
SIB1-v1700-IEs ::= SEQUENCE {
  hsdn-Cell-r17 ENUMERATED {true} OPTIONAL, -- Need R
  uac-BarringInfo-v1700 SEQUENCE {
  uac-BarringInfoSetList-v1700 UAC-BarringInfoSetList-v1700
  } OPTIONAL, -- Cond MINT
  sdt-ConfigCommon-r17 SDT-ConfigCommonSIB-r17 OPTIONAL,
  -- Need R
  redCap-ConfigCommon-r17 RedCap-ConfigCommonSIB-r17
  OPTIONAL, -- Need R
  featurePriorities-r17 SEQUENCE {
  redCapPriority-r17 FeaturePriority-r17 OPTIONAL,
  -- Need R
  slicingPriority-r17 FeaturePriority-r17 OPTIONAL, -- Need R
  msg3-Repetitions-Priority-r17 FeaturePriority-r17
  OPTIONAL, -- Need R
  sdt-Priority-r17 FeaturePriority-r17 OPTIONAL -- Need R
  } OPTIONAL, -- Need R
  si-SchedulingInfo-v1700 SI-SchedulingInfo-v1700 OPTIONAL,
  -- Need R
  hyperSFN-r17 BIT STRING (SIZE (10)) OPTIONAL, -- Need R
  eDRX-AllowedIdle-r17 ENUMERATED {true} OPTIONAL,
  -- Need R
  eDRX-AllowedInactive-r17 ENUMERATED {true} OPTIONAL,
  -- Cond EDRX-RC
  intraFreqReselectionRedCap-r17 ENUMERATED {allowed,
  notAllowed} OPTIONAL, --
Need S
  cellBarredNTN-r17 ENUMERATED {barred, notBarred}
  OPTIONAL, -- Need S
  nonCriticalExtension SIB1-v1800-IEs OPTIONAL
}
SIB1-v1800-IEs ::= SEQUENCE {
  ncr-Support-r18 ENUMERATED {true} OPTIONAL, -- Need S
  nonCriticalExtension SEQUENCE { }
}
UAC-AccessCategory1-SelectionAssistanceInfo ::= ENUMERATED {a,
b, c}
UAC-AC1-SelectAssistInfo-r16 ::= ENUMERATED {a, b, c,
notConfigured}
SDT-ConfigCommonSIB-r17 ::= SEQUENCE {
  sdt-RSRP-Threshold-r17 RSRP-Range OPTIONAL, -- Need R
  sdt-LogicalChannelSR-DelayTimer-r17 ENUMERATED { sf20, sf40,
  sf64, sf128, sf512,
sf1024, sf2560, spare1} OPTIONAL, -- Need R
  sdt-DataVolumeThreshold-r17 ENUMERATED {byte32, byte100,
  byte200, byte400, byte600,
byte800, byte1000, byte2000, byte4000,
    byte8000, byte9000, byte10000, byte12000, byte24000, byte48000,
    byte96000},
t319a-r17 ENUMERATED { ms100, ms200, ms300, ms400, ms600,
ms1000, ms2000,
    ms3000, ms4000, spare7, spare6, spare5, spare4, spare3, spare2,
    spare1}
}
RedCap-ConfigCommonSIB-r17 ::= SEQUENCE {
  halfDuplexRedCapAllowed-r17 ENUMERATED {true} OPTIONAL,
  -- Need R
  cellBarredRedCap-r17 SEQUENCE {
  cellBarredRedCap1Rx-r17 ENUMERATED {barred, notBarred},
  cellBarredRedCap2Rx-r17 ENUMERATED {barred, notBarred}
  } OPTIONAL, -- Need R
  ...
}
FeaturePriority-r17 ::= INTEGER (0..7)
-- TAG-SIB1-STOP
-- ASN1STOP
```

TABLE 1.7-2
SIB1 field descriptions

cellBarredNTN
Value barred means that the cell is barred for connectivity
to NTN, as defined in [TS38304].
Value notBarred means that the cell is allowed for connectivity
to NTN. If not present, the UE
considers the cell is not allowed for connectivity to NTN,
as defined in [TS38304]. This field is
only applicable to NTN-capable UEs.
cellBarredRedCap1Rx
Value barred means that the cell is barred for a RedCap
UE with 1 Rx branch, as defined in
[TS38304]. This field is ignored by non-RedCap UEs.
cellBarredRedCap2Rx
Value barred means that the cell is barred for a RedCap
UE with 2 Rx branches, as defined in
[TS38304]. This field is ignored by non-RedCap UEs.
cellSelectionInfo
Parameters for cell selection related to the serving cell.
eCallOverIMS-Support
Indicates whether the cell supports eCall over IMS
services as defined in TS 23.501 [32]. If
absent, eCall over IMS is not supported by the network in the cell.
eDRX-AllowedIdle
The presence of this field indicates that extended DRX
for CN paging is allowed in the cell for
UEs in RRC_IDLE or RRC_INACTIVE. The UE shall
stop using extended DRX for CN
paging in RRC_IDLE or RRC_INACTIVE if
eDRX-AllowedIdle is not present.
eDRX-AllowedInactive
The presence of this field indicates that extended DRX
for RAN paging is allowed in the cell
for UEs in RRC_INACTIVE. The UE shall stop using
extended DRX for RAN paging in
RRC_INACTIVE if eDRX-AllowedInactive is not present.
featurePriorities
Indicates priorities for features, such as RedCap, Slicing,
SDT and MSG3-Repetitions for
Coverage Enhancements. These priorities are used to determine which
FeatureCombinationPreambles the UE shall use when
a feature maps to more than one
FeatureCombinationPreambles, as specified in TS 38.321 [3].
A lower value means a higher
priority. The network does not signal the same priority for
more than one feature. The network
signals a priority for all feature that map to at least
one FeatureCombinationPreambles.
halfDuplexRedCap-Allowed
The presence of this field indicates that the cell supports
half-duplex FDD RedCap UEs.
hsdn-Cell
This field indicates this is a HSDN cell as specified in [TS38304].
hyperSFN
Indicates hyper SFN which increments by one when the
SFN wraps around.
idleModeMeasurementsEUTRA
This field indicates that a UE that is configured for EUTRA
idle/inactive measurements shall
perform the measurements while camping in this cell and
report availability of these
measurements when establishing or resuming a connection
in this cell. If absent, a UE is not
required to perform EUTRA idle/inactive measurements.
idleModeMeasurementsNR
This field indicates that a UE that is configured for
NR idle/inactive measurements shall
perform the measurements while camping in this cell
and report availability of these
measurements when establishing or resuming a connection
in this cell. If absent, a UE is not
required to perform NR idle/inactive measurements.
ims-EmergencySupport
Indicates whether the cell supports IMS emergency
bearer services for UEs in limited service
mode. If absent, IMS emergency call is not supported
by the network in the cell for UEs in
limited service mode.
intraFreqReselectionRedCap
Controls cell selection/reselection to intra-frequency
cells for RedCap UEs when this cell is
barred, or treated as barred by the RedCap UE,
as specified in [TS38304]. If not present, a
RedCap UE treats the cell as barred, i.e., the UE
considers that the cell does not support
RedCap.
ncr-Support
This field combines both the support of NCR and the
cell status for NCR. If the field is present,
the cell supports NCR and the cell is also considered
as a candidate for cell (re)selection for
NCR-node; if the field is absent, the cell does not
support NCR and/or the cell is barred for
NCR-node.
q-QualMin
Parameter “Q_{qualmin}” in [TS38304], applicable for
serving cell. If the field is absent, the UE
applies the (default) value of negative infinity for Q_{qualmin}.
q-QualMinOffset
Parameter “Q_{qualminoffset}” in [TS38304]. Actual value
Q_{qualminoffset} = field value [dB]. If the field is
absent, the UE applies the (default) value of 0 dB for
Q_{qualminoffset}. Affects the minimum required
quality level in the cell.
q-RxLevMin
Parameter “Qᵣₓₗₑᵥₘᵢₙ” in [TS38304], applicable for serving cell.
q-RxLevMinOffset
Parameter “Q_{rxlevminoffset}” in [TS38304]. Actual
value Q_{rxlevminoffset} = field value * 2 [dB]. If
absent, the UE applies the (default) value of 0 dB for
Q_{rxlevminoffset}. Affects the minimum
required Rx level in the cell.
q-RxLevMinSUL
Parameter “Qᵣₓₗₑᵥₘᵢₙ” in [TS38304], applicable for serving cell.
sdt-RSRP-Threshold
RSRP threshold used to determine whether SDT procedure
can be initiated, as specified in TS
38.321 [3].
sdt-DataVolumeThreshold
Data volume threshold used to determine whether SDT
can be initiated, as specified in TS
38.321 [3]. Value byte32 corresponds to 32 bytes,
value byte100 corresponds to 100 bytes, and
so on.
sdt-LogicalChannelSR-DelayTimer
The value of logicalChannelSR-DelayTimer applied
during SDT for logical channels
configured with SDT, as specified in TS 38.321 [3].
Value in number of subframes. Value sf20
corresponds to 20 subframes, sf40 corresponds to 40
subframes, and so on. If this field is not
configured, then logicalChannelSR-DelayTimer
is not applied for SDT logical channels.
servingCellConfigCommon
Configuration of the serving cell.
t319a
Initial value of the timer T319a used for detection of SDT
failure. Value ms100 corresponds to
100 milliseconds, value ms200 corresponds to 200 milliseconds and so on.
uac-AccessCategory1-SelectionAssistanceInfo
Information used to determine whether Access Category 1
applies to the UE, as defined in
3GPP TS 22.261. If plmnCommon is chosen, the UAC-AccessCategory1-
SelectionAssistanceInfo is applicable to all the PLMNs and SNPNs
in plmn-IdentityInfoList and
npn-IdentityInfoList. If individualPLMNList is chosen, the 1^{st}
entry in the list corresponds to the
first network within all of the PLMNs and SNPNs across
the plmn-IdentityList and the npn-
IdentityInfoList, the 2^{nd} entry in the list corresponds to the
second network within all of the
PLMNs and SNPNs across the plmn-IdentityList and the
npn-IdentityInfoList and so on. If uac-
AC1-SelectAssistInfo-r16 is present, the UE shall
ignore the uac-AccessCategory1-
SelectionAssistanceInfo.
uac-AC1-SelectAssistInfo
Information used to determine whether Access Category
1 applies to the UE, as defined in
3GPP TS 22.261. The 1^{st} entry in the list corresponds
to the first network within all of the
PLMNs and SNPNs across the plmn-IdentityList and
npn-IdentityInfoList, the 2^{nd} entry in the
list corresponds to the second network within all of the
PLMNs and SNPNs across the plmn-
IdentityList and the npn-IdentityInfoList and so on.
Value notConfigured indicates that Access
Category1 is not configured for the corresponding PLMN/SNPN.
uac-BarringForCommon
Common access control parameters for each access
category. Common values are used for all
PLMNs/SNPNs, unless overwritten by the
PLMN/SNPN specific configuration provided in
uac-BarringPerPLMN-List. The parameters are
specified by providing an index to the set of
configurations (uac-BarringInfoSetList). UE
behaviour upon absence of this field is specified in
clause 5.3.14.2.
ue-TimersAndConstants
Timer and constant values to be used by the UE.
The cell operating as PCell always provides
this field.
useFullResumeID
Indicates which resume identifier and Resume request
message should be used. UE uses fullI-
RNTI and RRCResumeRequest1 if the field is present,
or shortI-RNTI and RRCResumeRequest
if the field is absent.

| Conditional | |
|---|---|
| Presence | Explanation |
| EDRX-RC | The field is optionally present, Need |
| | R, in a cell that enables eDRX- |
| | AllowedIdle, otherwise it is absent. |
| MINT | The field is optionally present, Need R, |
| | in a cell that provides a configuration for |
| | disaster roaming, otherwise it is absent, Need R |
| Standalone | The field is mandatory present in a |
| | cell that supports standalone |
| | operation, otherwise it is absent. |

1.7.2. Reception of the Rrcsetup by the Ue

In addition to the operations/functions described by [TS38331] § 5.3.3.4, the UE 2302 performs the following actions upon reception of the RRCSetup: The UE 2302 sets the content of RRCSetupComplete message as follows: if connecting as an NCR-node: the UE 2302 includes the ncr-NodeIndication. The UE 2302 includes all other parameters according to [TS38331] § 5.3.3.4.

1.8. Additional MAC and MAC Control Element Aspects for NCR

1.8.1. Backhaul Link Beam Indication for NCR

NCR Downlink Backhaul Link Beam Indication MAC CE (see e.g., FIG. 21a) and NCR Uplink Backhaul Link Beam Indication MAC CE (see e.g., FIG. 21b) are used by a gNB 2316 to indicate to an NCR node 102 the beam to be used for the DL and UL backhaul transmission, respectively, between the gNB 2316 and the NCR node 102.

Upon reception of an NCR Downlink Backhaul Link Beam Indication MAC CE (see e.g., FIG. 21a), the NCR node 102 indicates to NCR-Fwd 130 to apply the configuration contained in NCR Downlink Backhaul Link Beam Indication MAC CE as received by the NCR-MT 120.

Upon reception of an NCR Uplink Backhaul Link Beam Indication MAC CE (see e.g., FIG. 21b), the NCR node 102 indicates to NCR-Fwd 130 to apply the configuration contained in the NCR Uplink Backhaul Link Beam Indication MAC CE as received by the NCR-MT 120.

1.8.2. Access Link Beam Indication for NCR

NCR Access Link Beam Indication MAC CE (see e.g., FIG. 21c) is used by a gNB 2316 to indicate to an NCR node 102 the forwarding resources to be used for the semi-persistent access link transmission between the NCR node 102 and the UE(s) 2302 served by this device.

Upon reception of an NCR Access Link Beam Indication MAC CE (see e.g., FIG. 21c), the NCR node 102 applies the configuration signalled in the MAC CE as received by NCR-MT 120 to the forwarding resource lists indicated via RRC, and use it to operate the NCR-Fwd 130.

1.8.3. NCR Downlink Backhaul Link Beam Indication MAC CE

FIG. 21a depicts an example NCR Downlink Backhaul Beam Indication MAC CE, which is identified by MAC subheader with eLCID as specified in Table 6.2.1-1b in [TS38321] (e.g., a codepoint of 225 and an index of 289). The NCR Downlink Backhaul Beam Indication MAC CE has a fixed size and includes a single octet. The NCR Downlink Backhaul Beam Indication MAC CE includes a reserved bit (R) that is set to 0. The NCR Downlink Backhaul Beam Indication MAC CE includes a resource set ID field, which is used to indicate the downlink beam to be used for backhaul link transmission. It contains TCI-StateId (comprising all 7 bits), as specified in [TS38331], of a TCI State. The length of the field is 7 bits;

1.8.4. NCR Uplink Backhaul Link Beam Indication MAC CE

FIG. 21b depicts an example NCR Uplink Backhaul Beam Indication MAC CE, which is identified by MAC subheader with eLCID as specified in Table 6.2.1-1b in [TS38321] (e.g., a codepoint of 226 and an index of 290). The NCR Uplink Backhaul Beam Indication MAC CE has a fixed size and includes a single octet. The NCR Uplink Backhaul Beam Indication MAC CE includes a set of reserved bits (R) that are set to 0. The NCR Uplink Backhaul Beam Indication MAC CE includes a resource set ID field, which is used to indicate the uplink beam to be used for backhaul link transmission. If the ul-TCI-StateList is configured as specified in [TS38331], this field contains TCI-UL-State-Id (comprising all 6 bits) of an UL TCI State, which is used as the uplink beam indication for backhaul link transmission, otherwise, this field contains an SRI (contained in the 4 rightmost bits) which is used as the uplink beam indication for backhaul link transmission, with the 2 remaining bits set to zero.

1.8.5. NCR Access Link Beam Indication MAC CE

FIG. 21c depicts an example NCR Access Link Beam Indication MAC CE, which is identified by MAC subheader with eLCID as specified in Table 6.2.1-1b in [TS38321] (e.g., a codepoint of 224 and an index of 288). The NCR Access Link Beam Indication MAC CE has a variable size and includes some or all of the following fields. The NCR Access Link Beam Indication MAC CE includes a set of reserved bits (R) that are set to 0.

The NCR Access Link Beam Indication MAC CE includes a resource set ID field, which is used to indicate one of forwarding semi-persistent resource lists signalled in [fieldNameTBD] as specified in [TS38331]. The resource set ID field contains a list ID (or list of resource set IDs) comprising all 5 bits.

The NCR Access Link Beam Indication MAC CE includes an activate.deactivate (A/D) field. If the value of the A/D field is set to 1, the forwarding resource list indicated in resource set (list) ID field is being activated. If the value of the A/D field is set to 0, the forwarding resource list indicated in the resource set (list) ID field is being deactivated.

The NCR Access Link Beam Indication MAC CE includes a C field, which indicates whether the octets containing beam index ID field(s) are present. If the value of the C field is set to 1, the beam index ID, field(s) is/are present. If the value of this field is set to 0, the beam index ID, field(s) is/are absent. In some examples, the C field can be set to 1 only if the NCR Access Link Beam Indication MAC CE is used for activation (e.g., when the A/D field is set to 1). If the NCR Access Link Beam Indication MAC CE is used for deactivation, this field is set to 0.

The NCR Access Link Beam Indication MAC CE includes a set of beam index ID, fields, where i is a value from 0 to N−1 (where N is a number). Each beam index ID, field indicates the updated beam index for forwarding resources within the list indicated by the resource set (list) ID field. Beam index ID₀ indicates the beam index for the first forwarding resource within the list; beam index Di indicates the beam index for the second forwarding resource within the list, and so on to beam index ID_{N-1} for the Nth forwarding resource within the list. The length of the beam index IDᵢ field is 6 bits.

1.9. Overall Procedures for Network Controlled Repeater

1.9.1. NCR Integration Procedure

FIG. 22 depicts an example procedure for NCR integration between the NCR 102, the gNB 2316, and the CN 2320, and the gNB 2316 includes a gNB distributed unit (gNB-DU) and a gNB central unit (gNB-CU). The procedure of FIG. 22 includes three phases.

Phase 1 involves NCR-MT 120 setup. In this phase, the NCR-MT 120 (re-)selects a cell that broadcasts the NCR support indicator in SIM (see e.g., SIM in section 1.7.1 supra). It then connects to the network as a UE 2302 by performing the RRC connection setup procedure with the gNB-CU, and authentication with the CN 2320 (e.g., 5GC 2340). The NCR-MT 120 includes the NCR indication in the RRCSetupComplete message as discussed previously. The gNB 2316 selects an appropriate AMF 2344 for the NCR 102. Upon receiving the NCR authorization information from the CN 2320 (e.g., 5GC 2340), the gNB-CU provides the authorization information to the gNB-DU. The UE initial access procedure(s) as discussed in clauses 8.1 and 8.9 of [TS38401] is/are used for the setup of the NCR-MT 120.

Phase 2 involves NCR configuration. Here, the gNB-CU may configure the NCR 102 via RRC. Phase 3 involves NCR Start Operation. After the NCR 102 is configured, the NCR 102 may start serving the UE(s) 2302.

1.9.2. UE Context Setup

The purpose of the UE Context Setup procedure is to establish the UE Context including, among others, SRB, DRB, BH RLC channel, Uu Relay RLC channel, PC5 Relay RLC channel, and SL DRB configuration. The procedure uses UE-associated signaling.

The gNB-CU initiates the procedure by sending UE CONTEXT SETUP REQUEST message to the gNB-DU. If the gNB-DU succeeds to establish the UE context, it replies to the gNB-CU with UE CONTEXT SETUP RESPONSE. If no UE-associated logical F1-connection exists, the UE-associated logical F1-connection is established as part of the procedure.

In addition to all of the operations and/or functionality described in [TS38473] § 8.3.1, if the Network Controlled Repeater Authorized IE is contained in the UE CONTEXT SETUP REQUEST message and it is set to “authorized”, the gNB-DU node shall, if supported, consider that the UE is authorized as Network Controlled Repeater.

1.9.3. Ue Context Modification (Gnb-Cu Initiated)

The purpose of the UE Context Modification procedure is to modify the established UE Context (e.g., establishing, modifying and releasing radio resources or sidelink resources). This procedure is also used to command the gNB-DU to stop data transmission for the UE for mobility (see e.g., [TS38401]). The procedure uses UE-associated signalling.

In addition to all of the operations and/or functionality described in [TS38473] § 8.3.4, if the Network Controlled Repeater Authorized IE is contained in the UE CONTEXT MODIFICATION REQUEST message, the gNB-DU shall, if supported, update its authorization information for the UE accordingly. If the Network Controlled Repeater Authorized IE is set to “not authorized”, the gNB-DU shall, if supported, initiate actions to ensure that the UE is no longer accessing as a Network Controlled Repeater.

1.9.4. Ue Context Setup Request

The UE CONTEXT SETUP REQUEST message is sent by the gNB-CU to request the setup of a UE context. Direction: gNB-CU gNB-DU.

| | | | | | | |
|---|---|---|---|---|---|---|
| | | | IE type | | | |
| | | | and | Semantics | | Assigned |
| IE/Group Name | Presence | Range | reference | description | Criticality | Criticality |

| | | | | |
|---|---|---|---|---|
| Message Type | M | 9.3.1.1 | YES | reject |
| gNB-CU UE F1AP | M | 9.3.1.4 | YES | reject |
| ID | | | | |
| gNB-DU UE F1AP | O | 9.3.1.5 | YES | ignore |
| ID | | | | |

. . . {see [TS38473] § 9.2.2.1} . . .

| | | | | | | |
|---|---|---|---|---|---|---|
| UE Multicast MRB | | 0 . . . 1 | | | YES | reject |
| to Be Setup List | | | | | | |
| >UE Multicast MRB | | 1 . . . <maxnoofMRBsforUE> | | | EACH | reject |
| to Be Setup Item IEs | | | | | | |
| >>MRB ID | M | | 9.3.1.224 | MRB ID for the | — | |
| | | | | UE. | | |
| >>MBS PTP | O | | 9.3.2.10 | | — | |
| Retransmission | | | | | | |
| Tunnel Required | | | | | | |
| >>MBS PTP | O | | MRB | | — | |
| Forwarding Tunnel | | | Progress | | | |
| Required | | | Information | | | |
| Information | | | 9.3.2.12 | | | |
| >>Source MRB ID | O | | 9.3.1.224 | In case of inter- | — | ignore |
| | | | MRB ID | DU handover, | | |
| | | | | indicates the | | |
| | | | | MRB ID | | |
| | | | | provided to the | | |
| | | | | UE in the | | |
| | | | | source cell. | | |
| ServingCellMO List | | 0 . . . 1 | | For NCD-SSBs | YES | ignore |
| >ServingCellMO | | 1 . . . <maxnoofServingCellMOs> | | | EACH | ignore |
| Item IEs | | | | | | |
| >>servingCellMO | M | | INTEGER | | — | |
| | | | (1 . . . 64) | | | |
| >>SSB frequency | M | | INTEGER | ARFCN | — | |
| | | | (0 . . . 3279165) | | | |
| Network Controlled | O | | 9.3.1.xxx | | YES | ignore |
| Repeater | | | | | | |
| Authorized | | | | | | |

1.9.5. Ue Context Modification Request

The UE CONTEXT MODIFICATION REQUEST message is sent by the gNB-CU to provide UE Context information changes to the gNB-DU. Direction: gNB-CU→gNB-DU

| | | | IE type | | | |
|---|---|---|---|---|---|---|
| | | | and | Semantics | | Assigned |
| IE/Group Name | Presence | Range | reference | description | Criticality | Criticality |
| Message Type | M | | 9.3.1.1 | | YES | reject |
| gNB-CU UE F1AP | M | | 9.3.1.4 | | YES | reject |
| ID | | | | | | |
| gNB-DU UE F1AP | M | | 9.3.1.5 | | YES | reject |
| ID | | | | | | |

. . . {see [TS38473] § 9.2.2.7} . . .

| | | | | | | |
|---|---|---|---|---|---|---|
| Uplink | O | | 9.3.1.284 | | YES | ignore |
| TxDirectCurrentMore | | | | | | |
| CarrierList | | | | | | |
| Information | | | | | | |
| CPAC MCG | | 0 . . . 1 | | This IE is used | YES | ignore |
| Information | | | | at the MN for | | |
| | | | | MCG | | |
| | | | | configuration | | |
| | | | | as specified in | | |
| | | | | TS 37.340 [7] | | |
| | | | | for CPAC. | | |
| >CPAC Trigger | M | | ENUMERATED | | | |
| | | | (CPAC- | | | |
| | | | preparation, | | | |
| | | | CPAC- | | | |
| | | | executed, . . . ) | | | |
| >PSCell ID | M | | NR CGI | The PSCell | | |
| | | | 9.3.1.12 | corresponding | | |
| | | | | to the included | | |
| | | | | CG-Config IE | | |
| | | | | at CPAC- | | |
| | | | | preparation or | | |
| | | | | the selected | | |
| | | | | PSCell by the | | |
| | | | | UE at CPAC- | | |
| | | | | executed. | | |
| Network Controlled | O | | 9.3.1.xxx | | YES | ignore |
| Repeater Authorized | | | | | | |

1.9.6. Network Controlled Repeater Authorized

The Network Controlled Repeater Authorized IE provides the authorization status of the Network Controlled Repeater. This IE may be used in the UE CONTEXT SETUP REQUEST and/or the UE CONTEXT MODIFICATION REQUEST messages discussed previously.

| IE/Group | | | IE type and | Semantics |
|---|---|---|---|---|
| Name | Presence | Range | reference | description |
| Network | M | | ENUMERATED | |
| Controlled | | | (authorized, | |
| Repeater | | | not authorized, . . . ) | |
| Authorized | | | | |

1.9.7. Message and Information Element Abstract Syntax

The following tables provide structure and content of example F1AP messages described in the previous sections. The example F1AP messages can contain any IEs specified in the object set definitions for that message without the order or number of occurrence being restricted by ASN.1. A sending entity constructs an F1AP message according to the PDU definitions module and with the following additional rules: IEs are ordered (in an IE container) in the order they appear in object set definitions; and object set definitions specify how many times IEs may appear. An IE shall appear exactly once if the presence field in an object has value “mandatory”. An IE may appear at most once if the presence field in an object has value “optional” or “conditional”. If in a tabular format there is multiplicity specified for an IE (i.e., an IE list) then in the corresponding ASN.1 definition the list definition is separated into two parts. The first part defines an IE container list where the list elements reside. The second part defines list elements. The IE container list appears as an IE of its own. For this version of the standard an IE container list may contain only one kind of list elements.

TABLE 1.9.7-2
Information Element Definitions

//...
-- N
NA-Resource-Configuration-List ::= SEQUENCE (SIZE(1.. maxnoofHSNASlots)) OF NA-
Resource-Configuration-Item
NA-Resource-Configuration-Item ::= SEQUENCE {

| | |
|---|---|
| nADownlink | NADownlink OPTIONAL, |
| nAUplink | NAUplink OPTIONAL, |
| nAFlexible | NAFlexible OPTIONAL, |
| iE-Extensions | ProtocolExtensionContainer { { NA-Resource-Configuration- |

Item-ExtIEs} } OPTIONAL
}

| | |
|---|---|
| NA-Resource-Configuration-Item-ExtIEs | F1AP-PROTOCOL-EXTENSION ::= { |

...
}
NADownlink ::= ENUMERATED { true, false, ...}
NAFlexible ::= ENUMERATED {true, false, ...}
NAUplink ::= ENUMERATED { true, false, ...}
NetworkControlledRepeaterAuthorized ::= ENUMERATED { authorized, not-
authorized, ...}
Neighbour-Node-Cells-List ::= SEQUENCE (SIZE(1..maxnoofNeighbourNodeCellsIAB)) OF
Neighbour-Node-Cells-List-Item
Neighbour-Node-Cells-List-Item ::= SEQUENCE{

| | |
|---|---|
| nRCGI | NRCGI, |
| gNB-CU-UE-F1AP-ID GNB-CU-UE-F1AP-ID | OPTIONAL, |
| gNB-DU-UE-F1AP-ID GNB-DU-UE-F1AP-ID | OPTIONAL, |
| peer-Parent-Node-Indicator | ENUMERATED {true, ...} OPTIONAL, |
| iAB-DU-Cell-Resource-Configuration-Mode-Info | IAB-DU-Cell-Resource-Configuration- |

Mode-Info OPTIONAL,

| | |
|---|---|
| iAB-STC-Info | IAB-STC-Info OPTIONAL, |
| rACH-Config-Common | RACH-Config-Common |

OPTIONAL,

| | |
|---|---|
| rACH-Config-Common-IAB | RACH-Config-Common-IAB |

OPTIONAL,

| | |
|---|---|
| cSI-RS-Configuration | OCTET STRING OPTIONAL, |
| sR-Configuration | OCTET STRING OPTIONAL, |
| pDCCH-ConfigSIB1 | OCTET STRING OPTIONAL, |
| sCS-Common | OCTET STRING OPTIONAL, |
| iE-Extensions | ProtocolExtensionContainer {{Neighbour- |

| | |
|---|---|
| Node-Cells-List-Item-ExtIEs}} | OPTIONAL |

}

| | |
|---|---|
| Neighbour-Node-Cells-List-Item-ExtIEs | F1AP-PROTOCOL-EXTENSION ::= { |

...
}

TABLE 1.9.7-3
Constant Definitions

| | |
|---|---|
| //... | |
| id-MulticastF1UContextReferenceCU | ProtocolIE-ID ::= 681 |
| id-PosSItypeList | ProtocolIE-ID ::= 682 |
| id-DAPS-HO-Status | ProtocolIE-ID ::= 683 |
| id-UplinkTxDirectCurrentTwoCarrierListInfo | ProtocolIE-ID ::= 684 |
| id-UE-MulticastMRBs-ToBeSetup-atModify-List | ProtocolIE-ID ::= 685 |
| id-UE-MulticastMRBs-ToBeSetup-atModify-Item | ProtocolIE-ID ::= 686 |
| id-MC-PagingCell-List | ProtocolIE-ID ::= 687 |
| id-MC-PagingCell-Item | ProtocolIE-ID ::= 688 |
| id-SRSPosRRCInactiveQueryIndication | ProtocolIE-ID ::= 689 |
| id-NetworkControlledRepeaterAuthorized | ProtocolIE-ID ::= xxx |
| END | |
| -- ASN1STOP | |

### 2. Network, System, and Device Configurations and Arrangements

FIG. 23 depicts an example network architecture 2300. The network 2300 may operate in a manner consistent with 3GPP technical specifications for LTE or 5G/NR systems. However, the example embodiments are not limited in this regard and the described examples may apply to other networks that benefit from the principles described herein, such as future 3GPP systems, or the like.

The network 2300 includes a UE 2302, which is any mobile or non-mobile computing device designed to communicate with a RAN 2304 via an over-the-air connection. The UE 2302 is communicatively coupled with the RAN 2304 by a Uu interface, which may be applicable to both LTE and NR systems. Examples of the UE 2302 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, in-vehicle infotainment system, in-car entertainment system, instrument cluster, head-up display (HUD) device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M), device-to-device (D2D), machine-type communication (MTC) device, Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein. The UE 2302 may be the same or similar to any of the other UEs discussed herein such as, for example, UE 2402, hardware resources 2500, and/or any other UE discussed herein.

The network 2300 may include a set of UEs 2302 coupled directly with one another via a device-to-device (D2D), proximity services (ProSe), PC5, and/or sidelink (SL) interface, and/or any other suitable interface such as any of those discussed herein. These UEs 2302 may be M2M, D2D, MTC, and/or IoT devices, and/or V2X systems that communicate using physical sidelink channels such as, but not limited to, PSBCH, PSDCH, PSSCH, PSCCH, PSFCH, and the like. The UE 2302 may perform blind decoding attempts of SL channels/links according to the various examples herein.

In some examples, the UE 2302 may additionally communicate with an AP 2306 via an over-the-air (OTA) connection. The AP 2306 manages a WLAN connection, which may serve to offload some/all network traffic from the RAN 2304. The connection between the UE 2302 and the AP 2306 may be consistent with any IEEE 802.11 protocol. Additionally, the UE 2302, RAN 2304, and AP 2306 may utilize cellular-WLAN aggregation/integration (e.g., LWA/LWIP). Cellular-WLAN aggregation may involve the UE 2302 being configured by the RAN 2304 to utilize both cellular radio resources and WLAN resources.

The RAN 2304 includes one or more access network nodes (ANs) 2308. The ANs 2308 terminate air-interface(s) for the UE 2302 by providing access stratum protocols including RRC, PDCP, RLC, MAC, and PHY/L1 protocols. In this manner, the AN 2308 enables data/voice connectivity between CN 2320 and the UE 2302. The ANs 2308 may be a macrocell base station or a low power base station for providing femtocells, picocells or other like cells having smaller coverage areas, smaller user capacity, or higher bandwidth compared to macrocells; or some combination thereof. In these implementations, an 2308 be referred to as a BS, gNB, RAN node, eNB, ng-eNB, NodeB, RSU, TRP (or TRxP), and the like.

One example implementation is a “CU/DU split” architecture where the ANs 2308 are embodied as a gNB-Central Unit (CU) that is communicatively coupled with one or more gNB-Distributed Units (DUs), where each DU may be communicatively coupled with one or more Radio Units (RUs) (also referred to as RRHs, RRUs, or the like). In some implementations, the one or more RUs may be individual RSUs. In some implementations, the CU/DU split may include an ng-eNB-CU and one or more ng-eNB-DUs instead of, or in addition to, the gNB-CU and gNB-DUs, respectively. The ANs 2308 employed as the CU may be implemented in a discrete device or as one or more software entities running on server computers as part of, for example, a virtual network including a virtual Base Band Unit (BBU) or BBU pool, cloud RAN (CRAN), Radio Equipment Controller (REC), Radio Cloud Center (RCC), centralized RAN (C-RAN), virtualized RAN (vRAN), and/or the like (although these terms may refer to different implementation concepts). Any other type of architectures, arrangements, and/or configurations can be used.

The set of ANs 2308 are coupled with one another via respective X2 interfaces if the RAN 2304 is an LTE RAN or Evolved Universal Terrestrial Radio Access Network (E-UTRAN) 2310, or respective Xn interfaces if the RAN 2304 is a NG-RAN 2314. The X2/Xn interfaces, which may be separated into control/user plane interfaces in some examples, may allow the ANs to communicate information related to handovers, data/context transfers, mobility, load management, interference coordination, and the like.

The ANs of the RAN 2304 may each manage one or more cells, cell groups, component carriers, and the like to provide the UE 2302 with an air interface for network access. The UE 2302 may be simultaneously connected with a set of cells provided by the same or different ANs 2308 of the RAN 2304. For example, the UE 2302 and RAN 2304 may use carrier aggregation to allow the UE 2302 to connect with a set of component carriers, each corresponding to a Pcell or Scell. In dual connectivity scenarios, a first AN 2308 may be a master node that provides an MCG and a second AN 2308 may be secondary node that provides an SCG. The first/second ANs 2308 may be any combination of eNB, gNB, ng-eNB, and the like.

The RAN 2304 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

Additionally or alternatively, individual UEs 2302 provide radio information to one or more ANs 2308 and/or one or more edge compute nodes (e.g., edge servers/hosts, and the like). The radio information may be in the form of one or more measurement reports, and/or may include, for example, signal strength measurements, signal quality measurements, and/or the like. Each measurement report is tagged with a timestamp and the location of the measurement (e.g., the UEs 2302 current location). As examples, the measurements collected by the UEs 2302 and/or included in the measurement reports may include one or more of the following: bandwidth (BW), network or cell load, latency, jitter, round trip time (RTT), number of interrupts, out-of-order delivery of data packets, transmission power, bit error rate, bit error ratio (BER), Block Error Rate (BLER), packet error ratio (PER), packet loss rate, packet reception rate (PRR), data rate, peak data rate, end-to-end (e2e) delay, signal-to-noise ratio (SNR), signal-to-noise and interference ratio (SINR), signal-plus-noise-plus-distortion to noise-plus-distortion (SINAD) ratio, carrier-to-interference plus noise ratio (CINR), Additive White Gaussian Noise (AWGN), energy per bit to noise power density ratio (a/NO), energy per chip to interference power density ratio (Ec/I0), energy per chip to noise power density ratio (Ec/NO), peak-to-average power ratio (PAPR), reference signal received power (RSRP), reference signal received quality (RSRQ), received signal strength indicator (RSSI), received channel power indicator (RCPI), received signal to noise indicator (RSNI), Received Signal Code Power (RSCP), average noise plus interference (ANPI), GNSS timing of cell frames for UE positioning for E-UTRAN or 5G/NR (e.g., a timing between an AP 2306 or RAN node 2308 reference time and a GNSS-specific reference time for a given GNSS), GNSS code measurements (e.g., the GNSS code phase (integer and fractional parts) of the spreading code of the ith GNSS satellite signal), GNSS carrier phase measurements (e.g., the number of carrier-phase cycles (integer and fractional parts) of the ith GNSS satellite signal, measured since locking onto the signal; also called Accumulated Delta Range (ADR)), channel interference measurements, thermal noise power measurements, received interference power measurements, power histogram measurements, channel load measurements, STA statistics, and/or other like measurements. The RSRP, RSSI, and/or RSRQ measurements may include RSRP, RSSI, and/or RSRQ measurements of cell-specific reference signals, channel state information reference signals (CSI-RS), and/or synchronization signals (SS) or SS blocks for 3GPP networks (e.g., LTE or 5G/NR), and RSRP, RSSI, RSRQ, RCPI, RSNI, and/or ANPI measurements of various beacon, Fast Initial Link Setup (FILS) discovery frames, or probe response frames for WLAN/WiFi (e.g., [IEEE80211]) networks. Other measurements may be additionally or alternatively used, such as those discussed in 3GPP TS 36.214 v17.0.0 (2022-03-31) (“[TS36214]”), 3GPP TS 38.215 v17.3.0 (2023-03-30) (“[TS38215]”), 3GPP TS 38.314 v17.2.0 (2023-01-13) (“[TS38314]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), and/or the like. Additionally or alternatively, any of the aforementioned measurements (or combination of measurements) may be collected by one or more ANs 2308 and provided to the edge compute node(s).

Additionally or alternatively, the measurements can include one or more of the following measurements: measurements related to Data Radio Bearer (DRB) (e.g., number of DRBs attempted to setup, number of DRBs successfully setup, number of released active DRBs, in-session activity time for DRB, number of DRBs attempted to be resumed, number of DRBs successfully resumed, and the like); measurements related to RRC (e.g., mean number of RRC connections, maximum number of RRC connections, mean number of stored inactive RRC connections, maximum number of stored inactive RRC connections, number of attempted, successful, and/or failed RRC connection establishments, and the like); measurements related to UE Context (UECNTX); measurements related to Radio Resource Utilization (RRU) (e.g., DL total PRB usage, UL total PRB usage, distribution of DL total PRB usage, distribution of UL total PRB usage, DL PRB used for data traffic, UL PRB used for data traffic, DL total available PRBs, UL total available PRBs, and the like); measurements related to Registration Management (RM); measurements related to Session Management (SM) (e.g., number of PDU sessions requested to setup; number of PDU sessions successfully setup; number of PDU sessions failed to setup, and the like); measurements related to GTP Management (GTP); measurements related to IP Management (IP); measurements related to Policy Association (PA); measurements related to Mobility Management (MM) (e.g., for inter-RAT, intra-RAT, and/or Intra/Inter-frequency handovers and/or conditional handovers: number of requested, successful, and/or failed handover preparations; number of requested, successful, and/or failed handover resource allocations; number of requested, successful, and/or failed handover executions; mean and/or maximum time of requested handover executions; number of successful and/or failed handover executions per beam pair, and the like); measurements related to Virtualized Resource(s) (VR); measurements related to Carrier (CARR); measurements related to QoS Flows (QF) (e.g., number of released active QoS flows, number of QoS flows attempted to release, in-session activity time for QoS flow, in-session activity time for a UE 2302, number of QoS flows attempted to setup, number of QoS flows successfully established, number of QoS flows failed to setup, number of initial QoS flows attempted to setup, number of initial QoS flows successfully established, number of initial QoS flows failed to setup, number of QoS flows attempted to modify, number of QoS flows successfully modified, number of QoS flows failed to modify, and the like); measurements related to Application Triggering (AT); measurements related to Short Message Service (SMS); measurements related to Power, Energy and Environment (PEE); measurements related to NF service (NFS); measurements related to Packet Flow Description (PFD); measurements related to Random Access Channel (RACH); measurements related to Measurement Report (MR); measurements related to Layer 1 Measurement (L1M); measurements related to Network Slice Selection (NSS); measurements related to Paging (PAG); measurements related to Non-IP Data Delivery (NIDD); measurements related to external parameter provisioning (EPP); measurements related to traffic influence (TI); measurements related to Connection Establishment (CE); measurements related to Service Parameter Provisioning (SPP); measurements related to Background Data Transfer Policy (BDTP); measurements related to Data Management (DM); and/or any other performance measurements such as those discussed in 3GPP TS 28.552 v18.2.0 (2023-03-30) (“[TS28552]”), 3GPP TS 32.425 v17.1.0 (2021-06-24) (“[TS32425]”), and/or the like.

The radio information may be reported in response to a trigger event and/or on a periodic basis. Additionally or alternatively, individual UEs 2302 report radio information either at a low periodicity or a high periodicity depending on a data transfer that is to take place, and/or other information about the data transfer. Additionally or alternatively, the edge compute node(s) may request the measurements from the ANs 2308 at low or high periodicity, or the ANs 2308 may provide the measurements to the edge compute node(s) at low or high periodicity. Additionally or alternatively, the edge compute node(s) may obtain other relevant data from other edge compute node(s), core network functions (NFs), application functions (AFs), and/or other UEs 2302 such as Key Performance Indicators (KPIs), with the measurement reports or separately from the measurement reports.

Additionally or alternatively, in cases where is discrepancy in the observation data from one or more UEs, one or more RAN nodes, and/or core network NFs (e.g., missing reports, erroneous data, and the like) simple imputations may be performed to supplement the obtained observation data such as, for example, substituting values from previous reports and/or historical data, apply an extrapolation filter, and/or the like. Additionally or alternatively, acceptable bounds for the observation data may be predetermined or configured. For example, CQI and MCS measurements may be configured to only be within ranges defined by suitable 3GPP standards. In cases where a reported data value does not make sense (e.g., the value exceeds an acceptable range/bounds, or the like), such values may be dropped for the current learning/training episode or epoch. For example, on packet delivery delay bounds may be defined or configured, and packets determined to have been received after the packet delivery delay bound may be dropped.

The UE 2302 can also perform determine reference signal (RS) measurement and reporting procedures to provide the network with information about the quality of one or more wireless channels and/or the communication media in general, and this information can be used to optimize various aspects of the communication system. As examples, the measurement and reporting procedures performed by the UE 2302 can include those discussed in 3GPP TS 38.211 v17.4.0 (2023 Jan. 4) (“[TS38211]”), 3GPP TS 38.212 v17.5.0 (2023-03-30) (“[TS38212]”), 3GPP TS 38.213 v17.5.0 (2023 Mar. 30) (“[TS38213]”), 3GPP TS 38.214 v17.5.0 (2023 Mar. 30) (“[TS38214]”), [TS38215], 3GPP TS 38.101-1 v18.1.0 (2023 Apr. 7) (“[TS38101-1]”), 3GPP TS 38.104 v18.1.0 (2023 Apr. 7) (“[TS38104]”), 3GPP TS 38.133 v18.1.0 (2023 Apr. 7) (“[TS38133]”), [TS38331], and/or other the like. The physical signals and/or reference signals can include demodulation reference signals (DM-RS), phase-tracking reference signals (PT-RS), positioning reference signal (PRS), channel-state information reference signal (CSI-RS), synchronization signal block (SSB), primary synchronization signal (PSS), secondary synchronization signal (SSS), and sounding reference signal (SRS).

In any of the examples discussed herein, any suitable data collection and/or measurement mechanism(s) may be used to collect the observation data. For example, data marking (e.g., sequence numbering, and the like), packet tracing, signal measurement, data sampling, and/or timestamping techniques may be used to determine any of the aforementioned metrics/observations. The collection of data may be based on occurrence of events that trigger collection of the data. Additionally or alternatively, data collection may take place at the initiation or termination of an event. The data collection can be continuous, discontinuous, and/or have start and stop times. The data collection techniques/mechanisms may be specific to a HW configuration/implementation or non-HW-specific, or may be based on various software parameters (e.g., OS type and version, and the like). Various configurations may be used to define any of the aforementioned data collection parameters. Such configurations may be defined by suitable specifications/standards, such as 3GPP (e.g., [SA6Edge]), ETSI (e.g., [MEC]), O-RAN (e.g., [O-RAN]), Intel® Smart Edge Open (formerly OpenNESS) (e.g., [ISEO]), IETF (e.g., MAMS [RFC8743]), IEEE/WiFi (e.g., [IEEE80211], and the like), and/or any other like standards such as those discussed herein.

In examples where the RAN 2304 is an E-UTRAN 2310 with one or more eNBs 2312, the E-UTRAN 2310 provides an LTE air interface (Uu) with the parameters and characteristics at least as discussed in 3GPP TS 36.300 v17.2.0 (2022-09-30) (“[TS36300]”). In examples where the RAN 2304 is an next generation (NG)-RAN 2314 with a set of gNBs 2316. Each gNB 2316 connects with 5G-enabled UEs 2302 using a 5G-NR air interface (which may also be referred to as a Uu interface) with parameters and characteristics as discussed in [TS38300], among many other 3GPP standards, such as any of those discussed herein. Where the NG-RAN 2314 includes a set of ng-eNBs 2318, the one or more ng-eNBs 2318 connect with a UE 2302 via the 5G Uu and/or LTE Uu interface. The gNBs 2316 and the ng-eNBs 2318 connect with the 5GC 2340 through respective NG interfaces, which include an N2 interface, an N3 interface, and/or other interfaces. The gNB 2316 and the ng-eNB 2318 are connected with each other over an Xn interface. Additionally, individual gNBs 2316 are connected to one another via respective Xn interfaces, and individual ng-eNBs 2318 are connected to one another via respective Xn interfaces. In some examples, the NG interface may be split into two parts, an NG user plane (NG-U) interface, which carries traffic data between the nodes of the NG-RAN 2314 and a UPF 2348 (e.g., N3 interface), and an NG control plane (NG-C) interface, which is a signaling interface between the nodes of the NG-RAN 2314 and an AMF 2344 (e.g., N2 interface).

The NG-RAN 2314 may provide a 5G-NR air interface (which may also be referred to as a Uu interface) with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a DL resource grid that includes PSS/SSS/PBCH.

The 5G-NR air interface may utilize BWPs for various purposes. For example, BWP can be used for dynamic adaptation of the SCS. For example, the UE 2302 can be configured with multiple BWPs where each BWP configuration has a different SCS. When a BWP change is indicated to the UE 2302, the SCS of the transmission is changed as well. Another use case example of BWP is related to power saving. In particular, multiple BWPs can be configured for the UE 2302 with different amount of frequency resources (e.g., PRBs) to support data transmission under different traffic loading scenarios. A BWP containing a smaller number of PRBs can be used for data transmission with small traffic load while allowing power saving at the UE 2302 and in some cases at the gNB 2316. A BWP containing a larger number of PRBs can be used for scenarios with higher traffic load.

In some implementations, individual gNBs 2316 can include a gNB-CU and a set of gNB-DUs. Additionally or alternatively, gNBs 2316 can include one or more RUs. In these implementations, the gNB-CU may be connected to each gNB-DU via respective F1 interfaces. In case of network sharing with multiple cell ID broadcast(s), each cell identity associated with a subset of PLMNs corresponds to a gNB-DU and the gNB-CU it is connected to, share the same physical layer cell resources. For resiliency, a gNB-DU may be connected to multiple gNB-CUs by appropriate implementation. Additionally, a gNB-CU can be separated into gNB-CU control plane (gNB-CU-CP) and gNB-CU user plane (gNB-CU-UP) functions. The gNB-CU-CP is connected to a gNB-DU through an F1 control plane interface (F1-C), the gNB-CU-UP is connected to the gNB-DU through an F1 user plane interface (F1-U), and the gNB-CU-UP is connected to the gNB-CU-CP through an E1 interface. In some implementations, one gNB-DU is connected to only one gNB-CU-CP, and one gNB-CU-UP is connected to only one gNB-CU-CP. For resiliency, a gNB-DU and/or a gNB-CU-UP may be connected to multiple gNB-CU-CPs by appropriate implementation. One gNB-DU can be connected to multiple gNB-CU-UPs under the control of the same gNB-CU-CP, and one gNB-CU-UP can be connected to multiple DUs under the control of the same gNB-CU-CP. Data forwarding between gNB-CU-UPs during intra-gNB-CU-CP handover within a gNB may be supported by Xn-U.

Similarly, individual ng-eNBs 2318 can include an ng-eNB-CU and a set of ng-eNB-DUs. In these implementations, the ng-eNB-CU and each ng-eNB-DU are connected to one another via respective W1 interface. An ng-eNB can include an ng-eNB-CU-CP, one or more ng-eNB-CU-UP(s), and one or more ng-eNB-DU(s). An ng-eNB-CU-CP and an ng-eNB-CU-UP is connected via the E1 interface. An ng-eNB-DU is connected to an ng-eNB-CU-CP via the W1-C interface, and to an ng-eNB-CU-UP via the W1-U interface. The general principle described herein w.r.t gNB aspects also applies to ng-eNB aspects and corresponding E1 and W1 interfaces, if not explicitly specified otherwise.

The node hosting user plane part of the PDCP protocol layer (e.g., gNB-CU, gNB-CU-UP, and for EN-DC, MeNB or SgNB depending on the bearer split) performs user inactivity monitoring and further informs its inactivity or (re)activation to the node having control plane connection towards the core network (e.g., over E1, X2, or the like). The node hosting the RLC protocol layer (e.g., gNB-DU) may perform user inactivity monitoring and further inform its inactivity or (re)activation to the node hosting the control plane (e.g., gNB-CU or gNB-CU-CP).

In these implementations, the NG-RAN 2314, is layered into a Radio Network Layer (RNL) and a Transport Network Layer (TNL). The NG-RAN 2314 architecture (e.g., the NG-RAN logical nodes and interfaces between them) is part of the RNL. For each NG-RAN interface (e.g., NG, Xn, F1, and the like) the related TNL protocol and the functionality are specified. The TNL provides services for user plane transport and/or signaling transport. In NG-Flex configurations, each NG-RAN node is connected to all AMFs 2344 of AMF sets within an AMF region supporting at least one slice also supported by the NG-RAN node. The AMF Set and the AMF Region are defined in [TS23501].

The RAN 2304 is communicatively coupled to CN 2320 that includes network elements and/or network functions (NFs) to provide various functions to support data and telecommunications services to customers/subscribers (e.g., UE 2302). The components of the CN 2320 may be implemented in one physical node or separate physical nodes. In some examples, NFV may be utilized to virtualize any or all of the functions provided by the network elements of the CN 2320 onto physical compute/storage resources in servers, switches, and the like. A logical instantiation of the CN 2320 may be referred to as a network slice, and a logical instantiation of a portion of the CN 2320 may be referred to as a network sub-slice.

The CN 2320 may be an LTE CN 2322 (also referred to as an Evolved Packet Core (EPC) 2322). The EPC 2322 may include MME 2324, SGW 2326, SGSN 2328, HSS 2330, PGW 2332, and PCRF 2334 coupled with one another over interfaces (or “reference points”) as shown. The NFs in the EPC 2322 are briefly introduced as follows. The MME 2324 implements mobility management functions to track a current location of the UE 2302 to facilitate paging, bearer activation/deactivation, handovers, gateway selection, authentication, and the like. The SGW 2326 terminates an S1 interface toward the RAN 2310 and routes data packets between the RAN 2310 and the EPC 2322. The SGW 2326 may be a local mobility anchor point for inter-RAN node handovers and also may provide an anchor for inter-3GPP mobility. Other responsibilities may include lawful intercept, charging, and some policy enforcement. The SGSN 2328 tracks a location of the UE 2302 and performs security functions and access control. The SGSN 2328 also performs inter-EPC node signaling for mobility between different RAT networks; PDN and S-GW selection as specified by MME 2324; MME 2324 selection for handovers; and the like. The S3 reference point between the MME 2324 and the SGSN 2328 enable user and bearer information exchange for inter-3GPP access network mobility in idle/active states. The HSS 2330 includes a database for network users, including subscription-related information to support the network entities' handling of communication sessions. The HSS 2330 can provide support for routing/roaming, authentication, authorization, naming/addressing resolution, location dependencies, and the like. An S6a reference point between the HSS 2330 and the MME 2324 may enable transfer of subscription and authentication data for authenticating/authorizing user access to the EPC 2320. The PGW 2332 may terminate an SGi interface toward a data network (DN) 2336 that may include an application (app)/content server 2338. The PGW 2332 routes data packets between the EPC 2322 and the data network 2336. The PGW 2332 is communicatively coupled with the SGW 2326 by an S5 reference point to facilitate user plane tunneling and tunnel management. The PGW 2332 may further include a node for policy enforcement and charging data collection (e.g., PCEF). Additionally, the SGi reference point may communicatively couple the PGW 2332 with the same or different data network 2336. The PGW 2332 may be communicatively coupled with a PCRF 2334 via a Gx reference point. The PCRF 2334 is the policy and charging control element of the EPC 2322. The PCRF 2334 is communicatively coupled to the app/content server 2338 to determine appropriate QoS and charging parameters for service flows. The PCRF 2332 also provisions associated rules into a PCEF (via Gx reference point) with appropriate TFT and QCI.

The CN 2320 may be a 5GC 2340 including an Authentication Server Function (AUSF) 2342, Access and Mobility Management Function (AMF) 2344, Session Management Function (SMF) 2346, User Plane Function (UPF) 2348, Network Slice Selection Function (NSSF) 2350, Network Exposure Function (NEF) 2352, Network Repository Function (NRF) 2354, Policy Control Function (PCF) 2356, Unified Data Management (UDM) 2358, Unified Data Repository (UDR) 2359, and Application Function (AF) 2360 coupled with one another over various interfaces as shown. The NFs in the 5GC 2340 are briefly introduced as follows.

The AUSF 2342 stores data for authentication of UE 2302 and handle authentication-related functionality. The AUSF 2342 may facilitate a common authentication framework for various access types.

The AMF 2344 allows other functions of the 5GC 2340 to communicate with the UE 2302 and the RAN 2304 and to subscribe to notifications about mobility events w.r.t the UE 2302. The AMF 2344 is also responsible for registration management (e.g., for registering UE 2302), connection management, reachability management, mobility management, lawful interception of AMF-related events, and access authentication and authorization. The AMF 2344 provides transport for SM messages between the UE 2302 and the SMF 2346, and acts as a transparent proxy for routing SM messages. AMF 2344 also provides transport for SMS messages between UE 2302 and an SMSF. AMF 2344 interacts with the AUSF 2342 and the UE 2302 to perform various security anchor and context management functions. Furthermore, AMF 2344 is a termination point of a RAN-CP interface, which includes the N2 reference point between the RAN 2304 and the AMF 2344. The AMF 2344 is also a termination point of NAS (N1) signaling, and performs NAS ciphering and integrity protection.

AMF 2344 also supports NAS signaling with the UE 2302 over an N3IWF interface. The N3IWF provides access to untrusted entities. N3IWF may be a termination point for the N2 interface between the (R)AN 2304 and the AMF 2344 for the control plane, and may be a termination point for the N3 reference point between the (R)AN 2314 and the 2348 for the user plane. As such, the AMF 2344 handles N2 signaling from the SMF 2346 and the AMF 2344 for PDU sessions and QoS, encapsulate/de-encapsulate packets for IPSec and N3 tunneling, marks N3 user-plane packets in the UL, and enforces QoS corresponding to N3 packet marking taking into account QoS requirements associated with such marking received over N2. N3IWF may also relay UL and DL control-plane NAS signaling between the UE 2302 and AMF 2344 via an N1 reference point between the UE 2302 and the AMF 2344, and relay UL and DL user-plane packets between the UE 2302 and UPF 2348. The N3IWF also provides mechanisms for IPsec tunnel establishment with the UE 2302. The AMF 2344 may exhibit an Namf service-based interface, and may be a termination point for an N14 reference point between two AMFs 2344 and an N17 reference point between the AMF 2344 and a 5G-EIR (not shown by FIG. 23).

The SMF 2346 is responsible for SM (e.g., session establishment, tunnel management between UPF 2348 and AN 2308); UE IP address allocation and management (including optional authorization); selection and control of UP function; configuring traffic steering at UPF 2348 to route traffic to proper destination; termination of interfaces toward policy control functions; controlling part of policy enforcement, charging, and QoS; lawful intercept (for SM events and interface to LI system); termination of SM parts of NAS messages; DL data notification; initiating AN specific SM information, sent via AMF 2344 over N2 to AN 2308; and determining SSC mode of a session. SM refers to management of a PDU session, and a PDU session or “session” refers to a PDU connectivity service that provides or enables the exchange of PDUs between the UE 2302 and the DN 2336. The SMF 2346 may also include the following functionalities to support edge computing enhancements (see e.g., [TS23548]): selection of EASDF 2361 and provision of its address to the UE as the DNS server for the PDU session; usage of EASDF 2361 services as defined in [TS23548]; and for supporting the application layer architecture defined in [TS23558], provision and updates of ECS address configuration information to the UE. Discovery and selection procedures for EASDFs 2361 is discussed in [TS23501] § 6.3.23.

The UPF 2348 acts as an anchor point for intra-RAT and inter-RAT mobility, an external PDU session point of interconnect to data network 2336, and a branching point to support multi-homed PDU session. The UPF 2348 also performs packet routing and forwarding, packet inspection, enforces user plane part of policy rules, lawfully intercept packets (UP collection), performs traffic usage reporting, perform QoS handling for a user plane (e.g., packet filtering, gating, UL/DL rate enforcement), performs UL traffic verification (e.g., SDF-to-QoS flow mapping), transport level packet marking in the UL and DL, and performs DL packet buffering and DL data notification triggering. UPF 2348 may include an UL classifier to support routing traffic flows to a data network.

The NSSF 2350 selects a set of network slice instances serving the UE 2302. The NSSF 2350 also determines allowed NSSAI and the mapping to the subscribed S-NSSAIs, if needed. The NSSF 2350 also determines an AMF set to be used to serve the UE 2302, or a list of candidate AMFs 2344 based on a suitable configuration and possibly by querying the NRF 2354. The selection of a set of network slice instances for the UE 2302 may be triggered by the AMF 2344 with which the UE 2302 is registered by interacting with the NSSF 2350; this may lead to a change of AMF 2344. The NSSF 2350 interacts with the AMF 2344 via an N22 reference point; and may communicate with another NSSF in a visited network via an N31 reference point (not shown).

The NEF 2352 securely exposes services and capabilities provided by 3GPP NFs for third party, internal exposure/re-exposure, AFs 2360, edge computing or fog computing systems (e.g., edge compute node, and the like. In such examples, the NEF 2352 may authenticate, authorize, or throttle the AFs. NEF 2352 may also translate information exchanged with the AF 2360 and information exchanged with internal network functions. For example, the NEF 2352 may translate between an AF-Service-Identifier and an internal 5GC information. NEF 2352 may also receive information from other NFs based on exposed capabilities of other NFs. This information may be stored at the NEF 2352 as structured data, or at a data storage NF using standardized interfaces. The stored information can then be re-exposed by the NEF 2352 to other NFs and AFs, or used for other purposes such as analytics.

The NRF 2354 supports service discovery functions, receives NF discovery requests from NF instances, and provides information of the discovered NF instances to the requesting NF instances. NRF 2354 also maintains information of available NF instances and their supported services. The NRF 2354 also supports service discovery functions, wherein the NRF 2354 receives NF Discovery Request from NF instance or an SCP (not shown), and provides information of the discovered NF instances to the NF instance or SCP.

The PCF 2356 provides policy rules to control plane functions to enforce them, and may also support unified policy framework to govern network behavior. The PCF 2356 may also implement a front end to access subscription information relevant for policy decisions in a UDR 2359 of the UDM 2358. In addition to communicating with functions over reference points as shown, the PCF 2356 exhibit an Npcf service-based interface.

The UDM 2358 handles subscription-related information to support the network entities' handling of communication sessions, and stores subscription data of UE 2302. For example, subscription data may be communicated via an N8 reference point between the UDM 2358 and the AMF 2344. The UDM 2358 may include two parts, an application front end and a UDR. The UDR may store subscription data and policy data for the UDM 2358 and the PCF 2356, and/or structured data for exposure and application data (including PFDs for application detection, application request information for multiple UEs 2302) for the NEF 2352. The Nudr service-based interface may be exhibited by the UDR to allow the UDM 2358, PCF 2356, and NEF 2352 to access a particular set of the stored data, as well as to read, update (e.g., add, modify), delete, and subscribe to notification of relevant data changes in the UDR. The UDM 2358 may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 2358 may exhibit the Nudm service-based interface.

Edge Application Server Discovery Function (EASDF) 2361 exhibits an Neasdf service-based interface, and is connected to the SMF 2346 via an N88 interface. One or multiple EASDF instances may be deployed within a PLMN, and interactions between 5GC NF(s) and the EASDF 2361 take place within a PLMN. The EASDF 2361 includes one or more of the following functionalities: registering to NRF 2354 for EASDF 2361 discovery and selection; handling the DNS messages according to the instruction from the SMF 2346; and/or terminating DNS security, if used. Handling the DNS messages according to the instruction from the SMF 2346 includes one or more of the following functionalities: receiving DNS message handling rules and/or BaselineDNSPattern from the SMF 2346; exchanging DNS messages from/with the UE 2302; forwarding DNS messages to C-DNS or L-DNS for DNS query; adding EDNS client subnet (ECS) option into DNS query for an FQDN; reporting to the SMF 2346 the information related to the received DNS messages; and/or buffering/discarding DNS messages from the UE 2302 or DNS Server. The EASDF has direct user plane connectivity (e.g., without any NAT) with the PSA UPF over N6 for the transmission of DNS signalling exchanged with the UE. The deployment of a NAT between EASDF 2361 and PSA UPF 2348 may or may not be supported. Additional aspects of the EASDF 2361 are discussed in [TS23548].

AF 2360 provides application influence on traffic routing, provide access to NEF 2352, and interact with the policy framework for policy control. The AF 2360 may influence UPF 2348 (re)selection and traffic routing. Based on operator deployment, when AF 2360 is considered to be a trusted entity, the network operator may permit AF 2360 to interact directly with relevant NFs. In some implementations, the AF 2360 is used for edge computing implementations.

The 5GC 2340 may enable edge computing by selecting operator/3rd party services to be geographically close to a point that the UE 2302 is attached to the network. This may reduce latency and load on the network. In edge computing implementations, the 5GC 2340 may select a UPF 2348 close to the UE 2302 and execute traffic steering from the UPF 2348 to DN 2336 via the N6 interface. This may be based on the UE subscription data, UE location, and information provided by the AF 2360, which allows the AF 2360 to influence UPF (re)selection and traffic routing.

The data network (DN) 2336 may represent various network operator services, Internet access, or third party services that may be provided by one or more servers including, for example, application (app)/content server 2338. The DN 2336 may be an operator external public, a private PDN, or an intra-operator packet data network, for example, for provision of IMS services. In this example, the app server 2338 can be coupled to an IMS via an S-CSCF or the I-CSCF. In some implementations, the DN 2336 may represent one or more local area DNs (LADNs), which are DNs 2336 (or DN names (DNNs)) that is/are accessible by a UE 2302 in one or more specific areas. Outside of these specific areas, the UE 2302 is not able to access the LADN/DN 2336.

Additionally or alternatively, the DN 2336 may be an edge DN 2336, which is a (local) DN that supports the architecture for enabling edge applications. In these examples, the app server 2338 may represent the physical hardware systems/devices providing app server functionality and/or the application software resident in the cloud or at an edge compute node that performs server function(s). In some examples, the app/content server 2338 provides an edge hosting environment that provides support required for Edge Application Server's execution.

In some examples, the 5GS can use one or more edge compute nodes to provide an interface and offload processing of wireless communication traffic. In these examples, the edge compute nodes may be included in, or co-located with one or more RANs 2310, 2314. For example, the edge compute nodes can provide a connection between the RAN 2314 and UPF 2348 in the 5GC 2340. The edge compute nodes can use one or more NFV instances instantiated on virtualization infrastructure within the edge compute nodes to process wireless connections to and from the RAN 2314 and UPF 2348.

In some implementations, the edge compute nodes provide a distributed computing environment for application and service hosting, and also provide storage and processing resources so that data and/or content can be processed in close proximity to subscribers (e.g., users of UEs 2302) for faster response times. The edge compute nodes also support multitenancy run-time and hosting environment(s) for applications, including virtual appliance applications that may be delivered as packaged virtual machine (VM) images, middleware application and infrastructure services, content delivery services including content caching, mobile big data analytics, and computational offloading, among others. Computational offloading involves offloading computational tasks, workloads, applications, and/or services to the edge compute nodes from the UEs 2302, CN 2320, DN 2336, and/or server(s) 2338, or vice versa. For example, a device application or client application operating in a UE 2302 may offload application tasks or workloads to one or more edge compute nodes. In another example, an edge compute node may offload application tasks or workloads to a set of UEs 2302 (e.g., for distributed machine learning computation and/or the like).

The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) necessary to run edge computing applications within an operator network or a subset of an operator network. The edge servers are physical computer systems that may include an edge platform and/or virtualization infrastructure, and provide compute, storage, and network resources to edge computing applications. Each of the edge servers are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 2302. The VI of the edge compute nodes provide virtualized environments and virtualized resources for the edge hosts, and the edge computing applications may run as VMs and/or application containers on top of the VI.

In one example implementation, the ECT is and/or operates according to the MEC framework, as discussed in ETSI GR MEC 001 v3.1.1 (2022 January), ETSI GS MEC 003 v3.1.1 (2022 March), ETSI GS MEC 009 v3.1.1 (2021 June), ETSI GS MEC 010-1 v1.1.1 (2017 October), ETSI GS MEC 010-2 v2.2.1 (2022 February), ETSI GS MEC 011 v2.2.1 (2020 December), ETSI GS MEC 012 V2.2.1 (2022 February), ETSI GS MEC 013 V2.2.1 (2022 January), ETSI GS MEC 014 v2.1.1 (2021 March), ETSI GS MEC 015 v2.1.1 (2020 June), ETSI GS MEC 016 v2.2.1 (2020 April), ETSI GS MEC 021 v2.2.1 (2022 February), ETSI GR MEC 024 v2.1.1 (2019 November), ETSI GS MEC 028 V2.2.1 (2021 July), ETSI GS MEC 029 v2.2.1 (2022 January), ETSI MEC GS 030 v2.1.1 (2020 April), and ETSI GR MEC 031 v2.1.1 (2020 October) (collectively referred to herein as “[MEC]”), the contents of each of which are hereby incorporated by reference in their entireties. This example implementation (and/or in any other example implementation discussed herein) may also include NFV and/or other like virtualization technologies such as those discussed in ETSI GR NFV 001 V1.3.1 (2021 March), ETSI GS NFV 002 V1.2.1 (2014 December), ETSI GR NFV 003 V1.6.1 (2021 March), ETSI GS NFV 006 V2.1.1 (2021 January), ETSI GS NFV-INF 001 V1.1.1 (2015 January), ETSI GS NFV-INF 003 V1.1.1 (2014 December), ETSI GS NFV-INF 004 V1.1.1 (2015 January), ETSI GS NFV-MAN 001 v1.1.1 (2014 December), and/or Israel et al., OSM Release FIVE Technical Overview, ETSI OPEN SOURCE MANO, OSM White Paper, 1st ed. (January 2019), https://osm.etsi.org/images/OSM-Whitepaper-TechContent-ReleaseFIVE-FINAL.pdf (collectively referred to as “[ETSINFV]”), the contents of each of which are hereby incorporated by reference in their entireties. Other virtualization technologies and/or service orchestration and automation platforms may be used such as, for example, those discussed in E2E Network Slicing Architecture, GSMA, Official Doc. NG.127, v1.0 (3 Jun. 2021), https://www.gsma.com/newsroom/wp-content/uploads/NG.127-v1.0-2.pdf, Open Network Automation Platform (ONAP) documentation, Release Istanbul, v9.0.1 (17 Feb. 2022), https://docs.onap.org/en/latest/index.html (“[ONAP]”), 3GPP Service Based Management Architecture (SBMA) as discussed in 3GPP TS 28.533 v17.1.0 (2021 Dec. 23) (“[TS28533]”), the contents of each of which are hereby incorporated by reference in their entireties.

In another example implementation, the ECT is and/or operates according to the O-RAN framework. Typically, front-end and back-end device vendors and carriers have worked closely to ensure compatibility. The flip-side of such a working model is that it becomes quite difficult to plug-and-play with other devices and this can hamper innovation. To combat this, and to promote openness and inter-operability at every level, several key players interested in the wireless domain (e.g., carriers, device manufacturers, academic institutions, and/or the like) formed the Open RAN alliance (“O-RAN”) in 2018. The O-RAN network architecture is a building block for designing virtualized RAN on programmable hardware with radio access control powered by AI/ML. Various aspects of the O-RAN architecture are described in O-RAN Working Group 1 (Use Cases and Overall Architecture): O-RAN Architecture Description, O-RAN ALLIANCE WG1, O-RAN Architecture Description v08.00, Release R003 (March 2023); O-RAN Operations and Maintenance Architecture Specification v04.00, 0-RAN ALLIANCE WG1 (February 2021); O-RAN Working Group 2 AI/ML workflow description and requirements v01.03 O-RAN ALLIANCE WG2 (October 2021); O-RAN Working Group 2 (Non RT RIC and AI interface WG): RI interface: General Aspects and Principles 4.0, v04.00, Release R003 (March 2023); O-RAN Working Group 2 (Non-RT RIC and A1 interface WG) Non-RT RIC Architecture v02.01 (October 2022); O-RAN Working Group 3 (Near-Real-time RAN Intelligent Controller and E2 Interface Working Group): Near-RT RIC Architecture, v04.00, Release R003 (March 2023); O-RAN Working Group 4 (Open Fronthaul Interfaces WG) Control, User and Synchronization Plane Specification, v11.00, Release R003 (March 2023); O-RAN Fronthaul Working Group 4 Cooperative Transport Interface Transport Control Plane Specification, v03.00 (October 2022); O-RAN Fronthaul Working Group 4 Cooperative Transport Interface Transport Management Plane Specification, v11.00, Release R003 (March 2023); O-RAN Open X-haul Transport Working Group Management interfaces for Transport Network Elements, v05.00, Release R003 (March 2023); O-RAN Open Transport Working Group 9 Xhaul Packet Switched Architectures and Solutions, v03.00, Release R003 (March 2023); O-RAN Open X-haul Transport Working Group Synchronization Architecture and Solution Specification, v03.00 (October 2022); O-RAN Open Xhaul Transport WG9 WDM-based Fronthaul Transport, v03.00, Release R003 (March 2023); O-RAN Operations and Maintenance Architecture, v08.00, Release R003 (March 2023); O-RAN Operations and Maintenance Interface Specification, v09.00, Release R003 (March 2023) (collectively referred to as “[O-RAN]”), the contents of each of which are hereby incorporated by reference in their entireties.

In another example implementation, the ECT is and/or operates according to the 3rd Generation Partnership Project (3GPP) System Aspects Working Group 6 (SA6) Architecture for enabling Edge Applications (referred to as “3GPP edge computing”) as discussed in 3GPP TS 23.558 v18.1.0 (2022-12-23) (“[TS23558]”), 3GPP TS 23.501 v18.0.0 (2022-12-21) (“[TS23501]”), 3GPP TS 23.502 v18.1.1 (2023-04-05) (“[TS23502]”), 3GPP TS 23.548 v18.1.0 (2023-04-06) (“[TS23548]”), 3GPP TS 28.538 v18.2.0 (2023-03-30) (“[TS28538]”), 3GPP TR 23.700-98 v18.0.0 (2022-12-23) (“[TR23700-98]”), 3GPP TS 23.222 v18.0.0 (2022-12-23) (“[TS23222]”), 3GPP TS 33.122 v18.0.0 (2022-12-16) (“[TS33122]”), 3GPP TS 29.222 v17.1.0 (2021-06-25) (“[TS29222]”), 3GPP TS 29.522 v18.0.0 (2022-12-16) (“[TS29522]”), 3GPP TS 29.122 v18.0.0 (2022-12-16) (“[TS29122]”), 3GPP TS 23.682 v17.3.0 (2022-06-15) (“[TS23682]”), 3GPP TS 23.434 v18.3.0 (2022-12-23) (“[TS23434]”), and 3GPP TS 23.401 v18.0.0 (2022-12-21) (collectively referred to as “[SA6Edge]”), the contents of each of which are hereby incorporated by reference in their entireties.

In another example implementation, the ECT is and/or operates according to the Intel® Smart Edge Open framework (formerly known as OpenNESS) as discussed in Intel® Smart Edge Open Developer Guide, version 21.09 (30 Sep. 2021), available at: https://smart-edge-open.github.io/ (“[ISEO]”), the contents of which is hereby incorporated by reference in its entirety.

In another example implementation, the ECT operates according to the Multi-Access Management Services (MAMS) framework as discussed in Kanugovi et al., Multi Access Management Services (MAMS), INTERNET ENGINEERING TASK FORCE (IETF), Request for Comments (RFC) 8743 (March 2020) (“[RFC8743]”), Ford et al., TCP Extensions for Multipath Operation with Multiple Addresses, IETF RFC 8684, (March 2020), De Coninck et al., Multipath Extensions for QUIC (MP-QUIC), IETF DRAFT-DECONINCK-QUIC-MULTIPATH-07, IETA, QUIC Working Group (3 May 2021), Zhu et al., User-Plane Protocols for Multiple Access Management Service, IETF DRAFT-ZHU-INTAREA-MAMS-USER-PROTOCOL-09, IETA, INTAREA (4 Mar. 2020), and Zhu et al., Generic Multi-Access (GMA) Convergence Encapsulation Protocols, IETF RFC 9188 (February 2022) (collectively referred to as “[MAMS]”), the contents of each of which are hereby incorporated by reference in their entireties.

It should be understood that the aforementioned edge computing frameworks/ECTs and services deployment examples are only illustrative examples of ECTs, and that the present disclosure may be applicable to many other or additional edge computing/networking technologies in various combinations and layouts of devices located at the edge of a network including the various edge computing networks/systems described herein. Further, the techniques disclosed herein may relate to other IoT edge network systems and configurations, and other intermediate processing entities and architectures may also be applicable to the present disclosure. Examples of such edge computing/networking technologies include [MEC]; [O-RAN]; [ISEO]; [SA6Edge]; Content Delivery Networks (CDNs) (also referred to as “Content Distribution Networks” or the like); Mobility Service Provider (MSP) edge computing and/or Mobility as a Service (MaaS) provider systems (e.g., used in AECC architectures); Nebula edge-cloud systems; Fog computing systems; Cloudlet edge-cloud systems; Mobile Cloud Computing (MCC) systems; Central Office Re-architected as a Datacenter (CORD), mobile CORD (M-CORD) and/or Converged Multi-Access and Core (COMAC) systems; and/or the like. Further, the techniques disclosed herein may relate to other IoT edge network systems and configurations, and other intermediate processing entities and architectures may also be used for purposes of the present disclosure.

The interfaces of the 5GC 2340 include reference points and service-based interfaces. The reference points include: N1 (between the UE 2302 and the AMF 2344), N2 (between RAN 2314 and AMF 2344), N3 (between RAN 2314 and UPF 2348), N4 (between the SMF 2346 and UPF 2348), N5 (between PCF 2356 and AF 2360), N6 (between UPF 2348 and DN 2336), N7 (between SMF 2346 and PCF 2356), N8 (between UDM 2358 and AMF 2344), N9 (between two UPFs 2348), N10 (between the UDM 2358 and the SMF 2346), N11 (between the AMF 2344 and the SMF 2346), N12 (between AUSF 2342 and AMF 2344), N13 (between AUSF 2342 and UDM 2358), N14 (between two AMFs 2344; not shown), N15 (between PCF 2356 and AMF 2344 in case of a non-roaming scenario, or between the PCF 2356 in a visited network and AMF 2344 in case of a roaming scenario), N16 (between two SMFs 2346; not shown), and N22 (between AMF 2344 and NSSF 2350). Other reference point representations not shown in FIG. 23 can also be used. The service-based representation of FIG. 23 represents NFs within the control plane that enable other authorized NFs to access their services. The service-based interfaces (SBIs) include: Namf (SBI exhibited by AMF 2344), Nsmf (SBI exhibited by SMF 2346), Nnef (SBI exhibited by NEF 2352), Npcf (SBI exhibited by PCF 2356), Nudm (SBI exhibited by the UDM 2358), Naf (SBI exhibited by AF 2360), Nnrf (SBI exhibited by NRF 2354), Nnssf (SBI exhibited by NSSF 2350), Nausf (SBI exhibited by AUSF 2342). Other service-based interfaces (e.g., Nudr, N5g-eir, and Nudsf) not shown in FIG. 23 can also be used. In some examples, the NEF 2352 can provide an interface to edge compute nodes 2336x, which can be used to process wireless connections with the RAN 2314.

Although not shown by FIG. 23, the system 2300 may also include NFs that are not shown such as, for example, Unstructured Data Storage Function (UDSF), Network Slice Admission Control Function (NSACF), Network Slice-specific and SNPN Authentication and Authorization Function (NSSAAF), UE radio Capability Management Function (UCMF), 5G-Equipment Identity Register (5G-EIR), Network Data Analytics Function (NWDAF), CHarging Function (CHF), Time Sensitive Networking AF (TSN AF), Time Sensitive Communication and Time Synchronization Function (TSCTSF), Data Collection Coordination Function (DCCF), Analytics Data Repository Function (ADRF), Messaging Framework Adaptor Function (MFAF), Non-Seamless WLAN Offload Function (NSWOF), Service Communication Proxy (SCP), Security Edge Protection Proxy (SEPP), Non-3GPP InterWorking Function (N3IWF), Trusted Non-3GPP Gateway Function (TNGF), Wireline Access Gateway Function (W-AGF), and/or Trusted WLAN Interworking Function (TWIF) as discussed in [TS23501].

FIG. 24 schematically illustrates a wireless network 2400. The wireless network 2400 includes a UE 2402 in wireless communication with an AN 2404. The UE 2402 may be the same or similar to, and substantially interchangeable with any of the of the UEs discussed herein such as, for example, UE 2302, hardware resources 2500, and/or any other UE discussed herein. The AN 2404 may be the same or similar to, and substantially interchangeable with any of the of the ANs (network access nodes (NANs)) discussed herein such as, for example, AP 2306, ANs 2308, RAN 2304, hardware resources 2500, and/or any other AN/NAN discussed herein.

The UE 2402 may be communicatively coupled with the AN 2404 via connection 2406. The connection YY06 is illustrated as an air interface to enable communicative coupling, and can be consistent with cellular communications protocols such as an LTE protocol or a 5G NR protocol operating at mmWave or sub-6 GHz frequencies.

The UE 2402 includes a host platform 2408 coupled with a modem platform 2410. The host platform 2408 includes application processing circuitry 2412, which may be coupled with protocol processing circuitry 2414 of the modem platform 2410. The application processing circuitry 2412 may run various applications for the UE 2402 that source/sink application data. The application processing circuitry 2412 may further implement one or more layer operations to transmit/receive application data to/from a data network. These layer operations includes transport (for example UDP) and Internet (e.g., IP) operations

The protocol processing circuitry 2414 may implement one or more of layer operations to facilitate transmission or reception of data over the connection 2406. The layer operations implemented by the protocol processing circuitry 2414 includes, for example, MAC, RLC, PDCP, RRC and NAS operations.

The modem platform 2410 may further include digital baseband circuitry 2416 that may implement one or more layer operations that are “below” layer operations performed by the protocol processing circuitry 2414 in a network protocol stack. These operations includes, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and other related functions.

The modem platform 2410 may further include transmit circuitry 2418, receive circuitry 2420, RF circuitry 2422, and RF front end (RFFE) 2424, which includes or connect to one or more antenna panels 2426. Briefly, the transmit circuitry 2418 includes a digital-to-analog converter, mixer, intermediate frequency (IF) components, etc.; the receive circuitry 2420 includes an analog-to-digital converter, mixer, IF components, etc.; the RF circuitry 2422 includes a low-noise amplifier, a power amplifier, power tracking components, etc.; RFFE 2424 includes filters (e.g., surface/bulk acoustic wave filters), switches, antenna tuners, beamforming components (e.g., phase-array antenna components), etc. The selection and arrangement of the components of the transmit circuitry 2418, receive circuitry 2420, RF circuitry 2422, RFFE 2424, and antenna panels 2426 (referred generically as “transmit/receive components” or “Tx/Rx components”) may be specific to details of a specific implementation such as, for example, whether communication is TDM or FDM, in mmWave or sub-6 gHz frequencies, etc. In some examples, the transmit/receive components may be arranged in multiple parallel transmit/receive chains, may be disposed in the same or different chips/modules, etc.

In some examples, the protocol processing circuitry 2414 includes one or more instances of control circuitry (not shown) to provide control functions for the transmit/receive components.

A UE reception may be established by and via the antenna panels 2426, RFFE 2424, RF circuitry 2422, receive circuitry 2420, digital baseband circuitry 2416, and protocol processing circuitry 2414. In some examples, the antenna panels 2426 may receive a transmission from the AN 2404 by receive-beamforming signals received by a set of antennas/antenna elements of the one or more antenna panels 2426.

A UE transmission may be established by and via the protocol processing circuitry 2414, digital baseband circuitry 2416, transmit circuitry 2418, RF circuitry 2422, RFFE 2424, and antenna panels 2426. In some examples, the transmit components of the UE 2404 may apply a spatial filter to the data to be transmitted to form a transmit beam emitted by the antenna elements of the antenna panels 2426.

Similar to the UE 2402, the AN 2404 includes a host platform 2428 coupled with a modem platform 2430. The host platform 2428 includes application processing circuitry 2432 coupled with protocol processing circuitry 2434 of the modem platform 2430. The modem platform may further include digital baseband circuitry 2436, transmit circuitry 2438, receive circuitry 2440, RF circuitry 2442, RFFE circuitry 2444, and antenna panels 2446. The components of the AN 2404 may be similar to and substantially interchangeable with like-named components of the UE 2402. In addition to performing data transmission/reception as described above, the components of the AN 2408 may perform various logical functions that include, for example, RNC functions such as radio bearer management, UL and DL dynamic radio resource management, and data packet scheduling.

Examples of the antenna elements of the antenna panels 2426 and/or the antenna elements of the antenna panels 2446 include planar inverted-F antennas (PIFAs), monopole antennas, dipole antennas, loop antennas, patch antennas, Yagi antennas, parabolic dish antennas, omni-directional antennas, and/or the like.

FIG. 25 illustrates components capable of reading instructions from a machine-readable or computer-readable medium (e.g., a non-transitory machine-readable storage medium) and perform any one or more of the methodologies discussed herein. Specifically, FIG. 25 shows a diagrammatic representation of hardware resources 2500 including one or more processors (or processor cores) 2510, one or more memory/storage devices 2520, and one or more communication resources 2530, each of which may be communicatively coupled via a bus 2540 or other interface circuitry. For examples where node virtualization (e.g., NFV) is utilized, a hypervisor 2502 may be executed to provide an execution environment for one or more network slices/sub-slices to utilize the hardware resources 2500.

The processors 2510 may include, for example, a processor 2512 and a processor 2514. The processors 2510 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 2520 may include main memory, disk storage, or any suitable combination thereof. The memory/storage devices 2520 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 2530 may include interconnection or network interface controllers, components, or other suitable devices to communicate with one or more peripheral devices 2504 or one or more databases 2506 or other network elements via a network 2508. For example, the communication resources 2530 may include wired communication components (e.g., for coupling via USB, Ethernet, etc.), cellular communication components, NFC components, Bluetooth® (or Bluetooth® Low Energy) components, Wi-Fi® components, and other communication components.

Instructions 2550 may comprise software, a program, an application, an applet, an app, or other executable code for causing at least any of the processors 2510 to perform any one or more of the methodologies discussed herein. The instructions 2550 may reside, completely or partially, within at least one of the processors 2510 (e.g., within the processor's cache memory), the memory/storage devices 2520, or any suitable combination thereof. Furthermore, any portion of the instructions 2550 may be transferred to the hardware resources 2500 from any combination of the peripheral devices 2504 or the databases 2506. Accordingly, the memory of processors 2510, the memory/storage devices 2520, the peripheral devices 2504, and the databases 2506 are examples of computer-readable and machine-readable media.

### 3. Examples

FIG. 26 depicts an example process for practicing various embodiments discussed herein. The process of FIG. 26 may be performed by a radio access network (RAN) node such as an AN 2308, gNB 2316, and/or the like. The process of FIG. 26 includes identifying authentication and identification information related to a network controlled repeater (NCR) (operation 2601); providing authentication-related information to the NCR (operation 2602); and communicating side control information with the NCR (operation 2603).

FIG. 27 depicts another example process for practicing various embodiments discussed herein. The process of FIG. 27 may be performed by a network controlled repeater (NCR) in a cellular network, such as NCR 102. The process of FIG. 27 includes identifying authentication information received from a RAN node (operation 2701); establishing a connection with the RAN node based on the authentication information (operation 2702); and communicating side control information with the RAN node (operation 2703). In some examples, the side control information is used to configure and/or adjust parameters of a radio unit in the NCR 102 and/or NCR-Fwd 130.

For one or more embodiments, at least one of the components set forth in one or more of the preceding figures may be configured to perform one or more operations, techniques, processes, and/or methods as set forth in the following examples.

Example 1 includes a method to be performed by a radio access network (RAN) node B device for facilitating network-controlled repeater and providing side control information for network-controlled repeater, the system is configured to receive authentication and identification of network-controlled repeater from OAM or CN or gNB itself and provide authentication to network-controlled repeater; the network-controlled repeater establishes a connection with gNB for receiving and transmitting side control information.

Example 2 includes the method of example 1 and/or some other example(s) herein, wherein the authentication and identification of network-controlled repeater is provided by OAM, and OAM provides all configurations of network-controlled repeater before it is powered-on.

Example 3 includes the method of example 2 and/or some other example(s) herein, wherein the configuration includes a unique signature of network-controlled repeater, assigned gNB for network-controlled repeater to access, or other configurations for initial access, physical layer, mac layer and/or RLC layer, PDCP layer configurations.

Example 4 includes the method of examples 1-3 and/or some other example(s) herein, wherein OAM provides gNB with a list of unique signatures of network-controlled repeaters which are allowed to access to the cell, including UE contexts of the corresponding network-controlled repeater.

Example 5 includes the method of examples 1-4 and/or some other example(s) herein, wherein the network-controlled repeater sends a power-on indication to gNB via MAC CE to request initial access, which includes the unique signature of network-controlled repeater.

Example 6 includes the method of examples 1-5 and/or some other example(s) herein, wherein the gNB compares the received signature in power-on indication with signature list of Example 4, sends an access confirmation or acknowledgement indication to the network-controlled repeater and starts providing side control information.

Example 7 includes the method of examples 1-6 and/or some other example(s) herein, wherein the gNB further indicates the timing offset to network-controlled repeater when side control information starts to be provided.

Example 8 includes the method of examples 1-7 and/or some other example(s) herein, wherein only start amplify-and-forward received signals after receiving side control information from gNB of Example 1.

Example 9 includes the method of examples 1-8 and/or some other example(s) herein, wherein the method includes exchanging turn on and turn off indication after initial access between network-controlled repeater and gNB.

Example 10 includes the method of example 9 and/or some other example(s) herein, wherein the turn-on and turn-off indication comprises ON/OFF indication, component to be turned-on/off (i.e. mobile termination and/or radio unit of network-controlled repeater), and unique signature of network-controlled repeater.

Example 11 includes the method of examples 9-10 and/or some other example(s) herein, wherein the turn-on and turn-off indication can also be scrambled by network-controlled repeater unique signature.

Example 12 includes the method of examples 9-11 and/or some other example(s) herein, wherein the turn-on and turn-off indication is triggered by gNB and sends to network-controlled repeater.

Example 13 includes the method of examples 9-12 and/or some other example(s) herein, wherein the turn-on and turn-off indication is initiated by network-controlled repeater and sends to gNB.

Example 14 includes the method of examples 1-13 and/or some other example(s) herein, wherein the network-controlled repeater comprises MAC and PHY layer in mobile termination and radio unit for amplify-and-forward signals; and the MAC and PHY are part of the UE functionality used for establishing the connection, or identification/authentication with the gNB and is used to provide the side control information.

Example 15 includes the method of example 14 and/or some other example(s) herein, wherein the mobile termination of network-controlled repeater comprises HARQ, multiplexing for MAC CE functionality in MAC layer; and other mandatory features in MAC layer is optional for mobile termination of network-controlled repeater.

Example 16 includes the method of examples 1-15 and/or some other example(s) herein, wherein the authentication of network-controlled repeater is provided by OAM, and gNB provides identification and confirmation to the network-controlled repeater. OAM provides all configurations of network-controlled repeater before it is powered-on.

Example 17 includes the method of example 16 and/or some other example(s) herein, wherein the configuration includes a unique signature of network-controlled repeater, a list of candidate gNBs for network-controlled repeater to access, and other configurations for initial access, PHY layer, MAC layer and/or RLC layer, PDCP layer configurations.

Example 18 includes the method of examples 1-17 and/or some other example(s) herein, wherein the network-controlled repeater sends an RRC message such as RRCSetupRequest to request initial access, or a subsequent secure message which includes the unique signature of network-controlled repeater as UE-identity.

Example 19 includes the method of example 18 and/or some other example(s) herein, wherein the message includes a new establishment cause, indicating the establishment of connection is for network-controlled repeater.

Example 20 includes the method of examples 16-19 and/or some other example(s) herein, wherein the network-controlled repeater comprises RRC, PDCP, RLC, MAC and PHY layer in mobile termination and radio unit for amplify-and-forward signals, and the MAC and PHY is used to provide the side control information could be part of the UE functionality used for establishing the connection, or identification/authentication with the gNB,

Example 21 includes the method of example 20 and/or some other example(s) herein, wherein the mobile termination of network-controlled repeater is not required to establish DRB.

Example 22 includes the method of examples 1-21 and/or some other example(s) herein, wherein the mobile termination of network-controlled repeater is configured with a scaling factor for L2 buffer size and RRC buffer size.

Example 23 includes the method of example 20 and/or some other example(s) herein, wherein the network-controlled repeater deactivates RRC, PDCP, RLC layers after initial access.

Example 24 includes the method of examples 1-23 and/or some other example(s) herein, wherein the authentication and identification of network-controlled repeater is provided by core network as a new type of device (e.g., network-controlled repeater); the gNB provides network-controlled repeater indication to core network over NG interface (e.g., Initial UE message) and core network provides authorization for network-controlled repeater over NG interface (e.g., initial context setup request).

Example 25 includes the method of examples 1-24 and/or some other example(s) herein, wherein the gNB broadcasts a network-controlled repeater support indication in SIB1.

Example 26 includes the method of example 24 and/or some other example(s) herein, wherein the core network provides a network-controlled repeater support indication to gNB authorizing it can provide connection towards network-controlled repeater via NG interface (e.g., NG Setup Request message).

Example 27 includes the method of examples 1-26 and/or some other example(s) herein, wherein the network-controlled repeater includes a network-controlled repeater indication in RRCSetupComplete message, indicating it is a network-controlled repeater node.

Example 28 includes the method of example 24 and/or some other example(s) herein, wherein the network-controlled repeater comprises NAS, RRC, PDCP, RLC, MAC and PHY layer in mobile termination and radio unit for amplify-and-forward signals.

Example 29 includes the method of example 28 and/or some other example(s) herein, wherein the network-controlled repeater deactivates NAS, RRC, PDCP, RLC layers after initial access.

Example 30 includes the method of examples 1-29 and/or some other example(s) herein, wherein the authentication and identification of network-controlled repeater is provided by core network as a normal UE; the gNB receives a network-controlled repeater indication from the network repeater in RRCSetupComplete message and requests UE context setup from core network as a normal UE.

Example 31 includes the method of examples 1-29 and/or some other example(s) herein, wherein the network-controlled repeater performs initial access via MAC layer, wherein MSG3 and MSG4 uses MAC CE for contention resolution.

Example 32 includes the method of example 31 and/or some other example(s) herein, wherein the MAC CE as MSG3 comprises the unique signature of network-controlled repeater.

Example 33 includes the method of examples 31-32 and/or some other example(s) herein, wherein the network-controlled repeater skips sending RRCSetupRequest and RRCSetupComplete during RACH procedure.

Example 34 includes the method of examples 31-33 and/or some other example(s) herein, wherein the MAC CE as MSG3 comprises a random UE identity and sends to the gNB as RRCSetupRequest message.

Example 35 includes the method of examples 31-34 and/or some other example(s) herein, wherein the network-controlled repeater sends the network-controlled repeater indication and selected PLMN identity via MAC CE to gNB as RRCSetupComplete message.

Example 36 includes a method to be performed by a radio access network (RAN) node, wherein the method comprises: identifying authentication and identification information related to a network-controlled repeater (NCR); providing authentication-related information to the NCR; and communicating side control information with the NCR.

Example 37 includes the method of example 36 and/or some other example(s) herein, wherein the authentication and identification information is received from an operations, administration, and maintenance (OAM) module, a core network (CN) element, and/or preconfigured at the RAN node.

Example 38 includes the method of examples 36-37 and/or some other example(s) herein, wherein communicating the side control information includes transmitting side control information to the NCR and/or identifying side control information received from the NCR.

Example 39 includes a method to be performed by a network controlled repeater (NCR) in a new radio (NR) cellular network, one or more elements of a NCR, and/or an electronic device that includes a NCR, wherein the method comprises: identifying authentication information received from a radio access network (RAN) node; establishing, based on the authentication information, a connection with the RAN node; and communicating side control information with the RAN node.

Example 40 includes the method of example 39 and/or some other example(s) herein, wherein communicating the side control information include transmitting side control information to the RAN node and/or identifying side control information received from the RAN node.

Example Z01 may include an apparatus comprising means to perform one or more elements of a method described in or related to any of examples 1-40, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-40, or any other method or process described herein.

Example Z03 may include an apparatus comprising logic, modules, or circuitry to perform one or more elements of a method described in or related to any of examples 1-40, or any other method or process described herein.

Example Z04 may include a method, technique, or process as described in or related to any of examples 1-40, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-40, or portions thereof.

Example Z06 may include a signal as described in or related to any of examples 1-40, or portions or parts thereof.

Example Z07 may include a datagram, packet, frame, segment, protocol data unit (PDU), or message as described in or related to any of examples 1-40, or portions or parts thereof, or otherwise described in the present disclosure.

Example Z08 may include a signal encoded with data as described in or related to any of examples 1-40, or portions or parts thereof, or otherwise described in the present disclosure.

Example Z09 may include a signal encoded with a datagram, packet, frame, segment, protocol data unit (PDU), or message as described in or related to any of examples 1-40, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-40, or portions thereof.

Example Z11 may include a computer program comprising instructions, wherein execution of the program by a processing element is to cause the processing element to carry out the method, techniques, or process as described in or related to any of examples 1-40, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### 4. Terminology

For the purposes of the present document, the following terms and definitions are applicable to the examples and embodiments discussed herein. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. Furthermore, the terms “comprising,” “including,” “having,” and the like, as used with respect to the present disclosure, are synonymous.

The terms “master” and “slave” at least in some examples refers to a model of asymmetric communication or control where one device, process, element, or entity (the “master”) controls one or more other device, process, element, or entity (the “slaves”). The terms “master” and “slave” are used in this disclosure only for their technical meaning. The term “master” or “grandmaster” may be substituted with any of the following terms “main”, “source”, “primary”, “initiator”, “requestor”, “transmitter”, “host”, “maestro”, “controller”, “provider”, “producer”, “client”, “source”, “mix”, “parent”, “chief”, “manager”, “reference” (e.g., as in “reference clock” or the like), and/or the like. Additionally, the term “slave” may be substituted with any of the following terms “receiver”, “secondary”, “subordinate”, “replica”, target”, “responder”, “device”, “performer”, “agent”, “standby”, “consumer”, “peripheral”, “follower”, “server”, “child”, “helper”, “worker”, “node”, and/or the like.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “establish” or “establishment” at least in some examples refers to (partial or in full) acts, tasks, operations, and the like, related to bringing or the readying the bringing of something into existence either actively or passively (e.g., exposing a device identity or entity identity). Additionally or alternatively, the term “establish” or “establishment” at least in some examples refers to (partial or in full) acts, tasks, operations, and the like, related to initiating, starting, or warming communication or initiating, starting, or warming a relationship between two entities or elements (e.g., establish a session, establish a session, and the like). Additionally or alternatively, the term “establish” or “establishment” at least in some examples refers to initiating something to a state of working readiness. The term “established” at least in some examples refers to a state of being operational or ready for use (e.g., full establishment). Furthermore, any definition for the term “establish” or “establishment” defined in any specification or standard can be used for purposes of the present disclosure and such definitions are not disavowed by any of the aforementioned definitions.

The term “obtain” at least in some examples refers to (partial or in full) acts, tasks, operations, and the like, of intercepting, movement, copying, retrieval, or acquisition (e.g., from a memory, an interface, or a buffer), on the original packet stream or on a copy (e.g., a new instance) of the packet stream. Other aspects of obtaining or receiving may involving instantiating, enabling, or controlling the ability to obtain or receive a stream of packets (or the following parameters and templates or template values).

The term “receipt” at least in some examples refers to any action (or set of actions) involved with receiving or obtaining an object, data, data unit, and the like, and/or the fact of the object, data, data unit, and the like being received. The term “receipt” at least in some examples refers to an object, data, data unit, and the like, being pushed to a device, system, element, and the like (e.g., often referred to as a push model), pulled by a device, system, element, and the like (e.g., often referred to as a pull model), and/or the like.

The term “element” at least in some examples refers to a unit that is indivisible at a given level of abstraction and has a clearly defined boundary, wherein an element may be any type of entity including, for example, one or more devices, systems, controllers, network elements, modules, engines, components, and so forth, or combinations thereof. The term “entity” at least in some examples refers to a distinct element of a component, architecture, platform, device, and/or system. Additionally or alternatively, the term “entity” at least in some examples refers to information transferred as a payload.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing. The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points. Additionally or alternatively, the term “metric” at least in some examples refers to a standard definition of a quantity, produced in an assessment of performance and/or reliability of the network, which has an intended utility and is carefully specified to convey the exact meaning of a measured value.

The term “signal” at least in some examples refers to an observable change in a quality and/or quantity. Additionally or alternatively, the term “signal” at least in some examples refers to a function that conveys information about of an object, event, or phenomenon. Additionally or alternatively, the term “signal” at least in some examples refers to any time varying voltage, current, or electromagnetic wave that may or may not carry information. The term “digital signal” at least in some examples refers to a signal that is constructed from a discrete set of waveforms of a physical quantity so as to represent a sequence of discrete values.

The terms “ego” (as in, e.g., “ego device”) and “subject” (as in, e.g., “data subject”) at least in some examples refers to an entity, element, device, system, and the like, that is under consideration or being considered. The terms “neighbor” and “proximate” (as in, e.g., “proximate device”) at least in some examples refers to an entity, element, device, system, and the like, other than an ego device or subject device.

The term “identifier” at least in some examples refers to a value, or a set of values, that uniquely identify an identity in a certain scope. Additionally or alternatively, the term “identifier” at least in some examples refers to a sequence of characters that identifies or otherwise indicates the identity of a unique object, element, or entity, or a unique class of objects, elements, or entities. Additionally or alternatively, the term “identifier” at least in some examples refers to a sequence of characters used to identify or refer to an application, program, session, object, element, entity, variable, set of data, and/or the like. The “sequence of characters” mentioned previously at least in some examples refers to one or more names, labels, words, numbers, letters, symbols, and/or any combination thereof. Additionally or alternatively, the term “identifier” at least in some examples refers to a name, address, label, distinguishing index, and/or attribute. Additionally or alternatively, the term “identifier” at least in some examples refers to an instance of identification. The term “persistent identifier” at least in some examples refers to an identifier that is reused by a device or by another device associated with the same person or group of persons for an indefinite period. The term “identification” at least in some examples refers to a process of recognizing an identity as distinct from other identities in a particular scope or context, which may involve processing identifiers to reference an identity in an identity database. The term “application identifier”, “application ID”, or “app ID” at least in some examples refers to an identifier that can be mapped to a specific application, application instance, or application instance. In the context of 3GPP 5G/NR, an “application identifier” at least in some examples refers to an identifier that can be mapped to a specific application traffic detection rule.

The term “circuitry” at least in some examples refers to a circuit or system of multiple circuits configured to perform a particular function in an electronic device. The circuit or system of circuits may be part of, or include one or more hardware components, such as a logic circuit, a processor (shared, dedicated, or group) and/or memory (shared, dedicated, or group), an application-specific integrated circuit (ASIC), field-programmable gate array (FPGA), programmable logic controller (PLC), single-board computer (SBC), system on chip (SoC), system in package (SiP), multi-chip package (MCP), digital signal processor (DSP), and the like, that are configured to provide the described functionality. In addition, the term “circuitry” may also refer to a combination of one or more hardware elements with the program code used to carry out the functionality of that program code. Some types of circuitry may execute one or more software or firmware programs to provide at least some of the described functionality. Such a combination of hardware elements and program code may be referred to as a particular type of circuitry.

The term “processor circuitry” at least in some examples refers to, is part of, or includes circuitry capable of sequentially and automatically carrying out a sequence of arithmetic or logical operations, or recording, storing, and/or transferring digital data. The term “processor circuitry” at least in some examples refers to one or more application processors, one or more baseband processors, a physical CPU, a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry.”

The term “memory” and/or “memory circuitry” at least in some examples refers to one or more hardware devices for storing data, including random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, read-only memory (ROM), programmable ROM (PROM), erasable PROM (EPROM), electrically EPROM (EEPROM), flash memory, non-volatile RAM (NVRAM), magnetic disk storage mediums, optical storage mediums, flash memory devices or other machine readable mediums for storing data. The term “computer-readable medium” includes, but is not limited to, memory, portable or fixed storage devices, optical storage devices, and various other mediums capable of storing, containing or carrying instructions or data.

The term “interface circuitry” at least in some examples refers to, is part of, or includes circuitry that enables the exchange of information between two or more components or devices. The term “interface circuitry” at least in some examples refers to one or more hardware interfaces, for example, buses, I/O interfaces, peripheral component interfaces, network interface cards, and/or the like.

The term “infrastructure processing unit” or “IPU” at least in some examples refers to an advanced networking device with hardened accelerators and network connectivity (e.g., Ethernet or the like) that accelerates and manages infrastructure functions using tightly coupled, dedicated, programmable cores. In some implementations, an IPU offers full infrastructure offload and provides an extra layer of security by serving as a control point of a host for running infrastructure applications. An IPU is capable of offloading the entire infrastructure stack from the host and can control how the host attaches to this infrastructure. This gives service providers an extra layer of security and control, enforced in hardware by the IPU.

The term “device” at least in some examples refers to a physical entity embedded inside, or attached to, another physical entity in its vicinity, with capabilities to convey digital information from or to that physical entity. The term “controller” at least in some examples refers to an element or entity that has the capability to affect a physical entity, such as by changing its state or causing the physical entity to move. The term “scheduler” at least in some examples refers to an entity or element that assigns resources (e.g., processor time, network links, memory space, and/or the like) to perform tasks. The term “network scheduler” at least in some examples refers to a node, element, or entity that manages network packets in transmit and/or receive queues of one or more protocol stacks of network access circuitry (e.g., a network interface controller (NIC), baseband processor, and the like). The term “network scheduler” at least in some examples can be used interchangeably with the terms “packet scheduler”, “queueing discipline” or “qdisc”, and/or “queueing algorithm”.

The term “terminal” at least in some examples refers to point at which a conductor from a component, device, or network comes to an end. Additionally or alternatively, the term “terminal” at least in some examples refers to an electrical connector acting as an interface to a conductor and creating a point where external circuits can be connected. In some examples, terminals may include electrical leads, electrical connectors, electrical connectors, solder cups or buckets, and/or the like.

The term “compute node” or “compute device” at least in some examples refers to an identifiable entity implementing an aspect of computing operations, whether part of a larger system, distributed collection of systems, or a standalone apparatus. In some examples, a compute node may be referred to as a “computing device”, “computing system”, or the like, whether in operation as a client, server, or intermediate entity. Specific implementations of a compute node may be incorporated into a server, base station, gateway, road side unit, on-premise unit, user equipment, end consuming device, appliance, or the like. For purposes of the present disclosure, the term “node” at least in some examples refers to and/or is interchangeable with the terms “device”, “component”, “sub-system”, and/or the like.

The term “computer system” at least in some examples refers to any type interconnected electronic devices, computer devices, or components thereof. Additionally, the terms “computer system” and/or “system” at least in some examples refer to various components of a computer that are communicatively coupled with one another. Furthermore, the term “computer system” and/or “system” at least in some examples refer to multiple computer devices and/or multiple computing systems that are communicatively coupled with one another and configured to share computing and/or networking resources.

The term “server” at least in some examples refers to a computing device or system, including processing hardware and/or process space(s), an associated storage medium such as a memory device or database, and, in some instances, suitable application(s) as is known in the art. The terms “server system” and “server” may be used interchangeably herein, and these terms at least in some examples refers to one or more computing system(s) that provide access to a pool of physical and/or virtual resources. The various servers discussed herein include computer devices with rack computing architecture component(s), tower computing architecture component(s), blade computing architecture component(s), and/or the like. The servers may represent a cluster of servers, a server farm, a cloud computing service, or other grouping or pool of servers, which may be located in one or more datacenters. The servers may also be connected to, or otherwise associated with, one or more data storage devices (not shown). Moreover, the servers includes an operating system (OS) that provides executable program instructions for the general administration and operation of the individual server computer devices, and includes a computer-readable medium storing instructions that, when executed by a processor of the servers, may allow the servers to perform their intended functions. Suitable implementations for the OS and general functionality of servers are known or commercially available, and are readily implemented by persons having ordinary skill in the art.

The term “platform” at least in some examples refers to an environment in which instructions, program code, software elements, and the like can be executed or otherwise operate, and examples of such an environment include an architecture (e.g., a motherboard, a computing system, and/or the like), one or more hardware elements (e.g., embedded systems, and the like), a cluster of compute nodes, a set of distributed compute nodes or network, an operating system, a virtual machine (VM), a virtualization container, a software framework, a client application (e.g., web browser or the like) and associated application programming interfaces, a cloud computing service (e.g., platform as a service (PaaS)), or other underlying software executed with instructions, program code, software elements, and the like.

The term “architecture” at least in some examples refers to a computer architecture or a network architecture. The term “computer architecture” at least in some examples refers to a physical and logical design or arrangement of software and/or hardware elements in a computing system or platform including technology standards for interacts therebetween. The term “network architecture” at least in some examples refers to a physical and logical design or arrangement of software and/or hardware elements in a network including communication protocols, interfaces, and media transmission.

The term “appliance,” “computer appliance,” and the like, at least in some examples refers to a computer device or computer system with program code (e.g., software or firmware) that is specifically designed to provide a specific computing resource. The term “virtual appliance” at least in some examples refers to a virtual machine image to be implemented by a hypervisor-equipped device that virtualizes or emulates a computer appliance or otherwise is dedicated to provide a specific computing resource. The term “security appliance”, “firewall”, and the like at least in some examples refers to a computer appliance designed to protect computer networks from unwanted traffic and/or malicious attacks. The term “policy appliance” at least in some examples refers to technical control and logging mechanisms to enforce or reconcile policy rules (information use rules) and to ensure accountability in information systems. The term “gateway” at least in some examples refers to a network appliance that allows data to flow from one network to another network, or a computing system or application configured to perform such tasks. Examples of gateways include IP gateways, Internet-to-Orbit (I2O) gateways, IoT gateways, cloud storage gateways, and/or the like.

The term “user equipment” or “UE” at least in some examples refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, station, mobile station, mobile user, subscriber, user, remote station, access agent, user agent, receiver, radio equipment, reconfigurable radio equipment, reconfigurable mobile device, and the like. Furthermore, the term “user equipment” or “UE” includes any type of wireless/wired device or any computing device including a wireless communications interface. Examples of UEs, client devices, and the like, include desktop computers, workstations, laptop computers, mobile data terminals, smartphones, tablet computers, wearable devices, machine-to-machine (M2M) devices, machine-type communication (MTC) devices, Internet of Things (IoT) devices, embedded systems, sensors, autonomous vehicles, drones, robots, in-vehicle infotainment systems, instrument clusters, onboard diagnostic devices, dashtop mobile equipment, electronic engine management systems, electronic/engine control units/modules, microcontrollers, control module, server devices, network appliances, head-up display (HUD) devices, helmet-mounted display devices, augmented reality (AR) devices, virtual reality (VR) devices, mixed reality (MR) devices, and/or other like systems or devices. The term “station” or “STA” at least in some examples refers to a logical entity that is a singly addressable instance of a medium access control (MAC) and physical layer (PHY) interface to the wireless medium (WM). The term “wireless medium” or WM” at least in some examples refers to the medium used to implement the transfer of protocol data units (PDUs) between peer physical layer (PHY) entities of a wireless local area network (LAN).

The term “network element” at least in some examples refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, network access node (NAN), base station, access point (AP), RAN device, RAN node, gateway, server, network appliance, network function (NF), virtualized NF (VNF), and/or the like. The term “network controller” at least in some examples refers to a functional block that centralizes some or all of the control and management functionality of a network domain and may provide an abstract view of the network domain to other functional blocks via an interface. The term “network access node” or “NAN” at least in some examples refers to a network element in a radio access network (RAN) responsible for the transmission and reception of radio signals in one or more cells or coverage areas to or from a UE or station. A “network access node” or “NAN” can have an integrated antenna or may be connected to an antenna array by feeder cables. Additionally or alternatively, a “network access node” or “NAN” includes specialized digital signal processing, network function hardware, and/or compute hardware to operate as a compute node. In some examples, a “network access node” or “NAN” may be split into multiple functional blocks operating in software for flexibility, cost, and performance. In some examples, a “network access node” or “NAN” may be a base station (e.g., an evolved Node B (eNB) or a next generation Node B (gNB)), an access point and/or wireless network access point, router, switch, hub, radio unit or remote radio head, Transmission Reception Point (TRxP), a gateway device (e.g., Residential Gateway, Wireline 5G Access Network, Wireline 5G Cable Access Network, Wireline BBF Access Network, and the like), network appliance, and/or some other network access hardware. The term “access point” or “AP” at least in some examples refers to an entity that contains one station (STA) and provides access to the distribution services, via the wireless medium (WM) for associated STAs. An AP comprises a STA and a distribution system access function (DSAF).

The term “cell” at least in some examples refers to a radio network object that can be uniquely identified by a UE from an identifier (e.g., cell ID) that is broadcasted over a geographical area from a network access node (NAN). Additionally or alternatively, the term “cell” at least in some examples refers to a geographic area covered by a NAN. The term “serving cell” at least in some examples refers to a primary cell (PCell) for a UE in a connected mode or state (e.g., RRC_CONNECTED) and not configured with carrier aggregation (CA) and/or dual connectivity (DC). Additionally or alternatively, the term “serving cell” at least in some examples refers to a set of cells comprising zero or more special cells and one or more secondary cells for a UE in a connected mode or state (e.g., RRC_CONNECTED) and configured with CA. The term “primary cell” or “PCell” at least in some examples refers to a Master Cell Group (MCG) cell, operating on a primary frequency, in which a UE either performs an initial connection establishment procedure or initiates a connection re-establishment procedure. The term “Secondary Cell” or “SCell” at least in some examples refers to a cell providing additional radio resources on top of a special cell (SpCell) for a UE configured with CA. The term “special cell” or “SpCell” at least in some examples refers to a PCell for non-DC operation or refers to a PCell of an MCG or a PSCell of an SCG for DC operation. The term “Master Cell Group” or “MCG” at least in some examples refers to a group of serving cells associated with a “Master Node” comprising a SpCell (PCell) and optionally one or more SCells. The term “Secondary Cell Group” or “SCG” at least in some examples refers to a subset of serving cells comprising a Primary SCell (PSCell) and zero or more SCells for a UE configured with DC. The term “Primary SCG Cell” refers to the SCG cell in which a UE performs random access when performing a reconfiguration with sync procedure for DC operation. The term “handover” at least in some examples refers to the transfer of a user's connection from one radio channel to another (can be the same or different cell). Additionally or alternatively, the term “handover” at least in some examples refers to the process in which a radio access network changes the radio transmitters, radio access mode, and/or radio system used to provide the bearer services, while maintaining a defined bearer service QoS.

The term “Master Node” or “MN” at least in some examples refers to a NAN that provides control plane connection to a core network. The term “Secondary Node” or “SN” at least in some examples refers to a NAN providing resources to the UE in addition to the resources provided by an MN and/or a NAN with no control plane connection to a core network. The term “E-UTEAN NodeB”, “eNodeB”, or “eNB” at least in some examples refers to a RAN node providing E-UTRA user plane (e.g., PDCP, RLC, MAC, PHY) and control plane (e.g., RRC) protocol terminations towards a UE, and connected via an S1 interface to the Evolved Packet Core (EPC). Two or more eNBs are interconnected with each other (and/or with one or more en-gNBs) by means of an X2 interface. The term “next generation eNB” or “ng-eNB” at least in some examples refers to a RAN node providing E-UTRA user plane and control plane protocol terminations towards a UE, and connected via the NG interface to the 5GC. Two or more ng-eNBs are interconnected with each other (and/or with one or more gNBs) by means of an Xn interface. The term “Next Generation NodeB”, “gNodeB”, or “gNB” at least in some examples refers to a RAN node providing NR user plane and control plane protocol terminations towards a UE, and connected via the NG interface to the 5GC. Two or more gNBs are interconnected with each other (and/or with one or more ng-eNBs) by means of an Xn interface. The term “E-UTRA-NR gNB” or “en-gNB” at least in some examples refers to a RAN node providing NR user plane and control plane protocol terminations towards a UE, and acting as a Secondary Node in E-UTRA-NR Dual Connectivity (EN-DC) scenarios (see e.g., 3GPP TS 37.340 v17.0.0 (2022-04-15) (“[TS37340]”)). Two or more en-gNBs are interconnected with each other (and/or with one or more eNBs) by means of an X2 interface.

The term “Next Generation RAN node” or “NG-RAN node” at least in some examples refers to either a gNB or an ng-eNB. The term “IAB-node” at least in some examples refers to a RAN node that supports new radio (NR) access links to user equipment (UEs) and NR backhaul links to parent nodes and child nodes. The term “IAB-donor” at least in some examples refers to a RAN node (e.g., a gNB) that provides network access to UEs via a network of backhaul and access links. The term “Transmission Reception Point” or “TRxP” at least in some examples refers to an antenna array with one or more antenna elements available to a network located at a specific geographical location for a specific area. The term “Central Unit” or “CU” at least in some examples refers to a logical node hosting radio resource control (RRC), Service Data Adaptation Protocol (SDAP), and/or Packet Data Convergence Protocol (PDCP) protocols/layers of an NG-RAN node, or RRC and PDCP protocols of the en-gNB that controls the operation of one or more DUs; a CU terminates an F1 interface connected with a DU and may be connected with multiple DUs. The term “Distributed Unit” or “DU” at least in some examples refers to a logical node hosting Backhaul Adaptation Protocol (BAP), F1 application protocol (F1AP), radio link control (RLC), medium access control (MAC), and physical (PHY) layers of the NG-RAN node or en-gNB, and its operation is partly controlled by a CU; one DU supports one or multiple cells, and one cell is supported by only one DU; and a DU terminates the F1 interface connected with a CU. The term “Radio Unit” or “RU” at least in some examples refers to a logical node hosting PHY layer or Low-PHY layer and radiofrequency (RF) processing based on a lower layer functional split. The term “split architecture” at least in some examples refers to an architecture in which an CU, DU, and/or RU are physically separated from one another. Additionally or alternatively, the term “split architecture” at least in some examples refers to a RAN architecture such as those discussed in 3GPP TS 38.401 v17.4.0 (2023-04-03) (“[TS38401]”), 3GPP TS 38.410 v 17.1.0 (2022-06-23), and 3GPP TS 38.473 v17.4.1 (2023-04-05) (“[TS38473]”) the contents of each of which are hereby incorporated by reference in their entireties. The term “integrated architecture at least in some examples refers to an architecture in which an RU and DU are implemented on one platform, and/or an architecture in which a DU and a CU are implemented on one platform.

The term “Residential Gateway” or “RG” at least in some examples refers to a device providing, for example, voice, data, broadcast video, video on demand, to other devices in customer premises. The term “Wireline 5G Access Network” or “W-5GAN” at least in some examples refers to a wireline AN that connects to a 5GC via N2 and N3 reference points. The W-5GAN can be either a W-5GBAN or W-5GCAN. The term “Wireline 5G Cable Access Network” or “W-5GCAN” at least in some examples refers to an Access Network defined in/by CableLabs. The term “Wireline BBF Access Network” or “W-5GBAN” at least in some examples refers to an Access Network defined in/by the Broadband Forum (BBF). The term “Wireline Access Gateway Function” or “W-AGF” at least in some examples refers to a Network function in W-5GAN that provides connectivity to a 3GPP 5G Core network (5GC) to 5G-RG and/or FN-RG. The term “5G-RG” at least in some examples refers to an RG capable of connecting to a 5GC playing the role of a user equipment with regard to the 5GC; it supports secure element and exchanges N1 signaling with 5GC. The 5G-RG can be either a 5G-BRG or 5G-CRG.

The term “SMTC” refers to an SSB-based measurement timing configuration configured by SSB-MeasurementTimingConfiguration. The term “SSB” refers to an SS/PBCH block.

The term “Primary Cell” refers to the MCG cell, operating on the primary frequency, in which the UE either performs the initial connection establishment procedure or initiates the connection re-establishment procedure. The term “Primary SCG Cell” refers to the SCG cell in which the UE performs random access when performing the Reconfiguration with Sync procedure for DC operation. The term “Secondary Cell” refers to a cell providing additional radio resources on top of a Special Cell for a UE configured with CA. The term “Secondary Cell Group” refers to the subset of serving cells comprising the PSCell and zero or more secondary cells for a UE configured with DC. The term “Serving Cell” refers to the primary cell for a UE in RRC_CONNECTED not configured with CA/DC there is only one serving cell comprising of the primary cell. The term “serving cell” or “serving cells” refers to the set of cells comprising the Special Cell(s) and all secondary cells for a UE in RRC_CONNECTED configured with CA. The term “Special Cell” refers to the PCell of the MCG or the PSCell of the SCG for DC operation; otherwise, the term “Special Cell” refers to the Pcell.

The term “edge computing” at least in some examples refers to an implementation or arrangement of distributed computing elements that move processing activities and resources (e.g., compute, storage, acceleration, and/or network resources) towards the “edge” of the network in an effort to reduce latency and increase throughput for endpoint users (client devices, user equipment, and the like). Additionally or alternatively, term “edge computing” at least in some examples refers to a set of services hosted relatively close to a client/UE's access point of attachment to a network to achieve relatively efficient service delivery through reduced end-to-end latency and/or load on the transport network. In some examples, edge computing implementations involve the offering of services and/or resources in a cloud-like systems, functions, applications, and subsystems, from one or multiple locations accessible via wireless networks. Additionally or alternatively, term “edge computing” at least in some examples refers to the concept, as described in [TS23501], that enables operator and 3rd party services to be hosted close to a UE's access point of attachment, to achieve an efficient service delivery through the reduced end-to-end latency and load on the transport network. The term “edge compute node” or “edge compute device” at least in some examples refers to an identifiable entity implementing an aspect of edge computing operations, whether part of a larger system, distributed collection of systems, or a standalone apparatus. In some examples, a compute node may be referred to as a “edge node”, “edge device”, “edge system”, whether in operation as a client, server, or intermediate entity. Additionally or alternatively, the term “edge compute node” at least in some examples refers to a real-world, logical, or virtualized implementation of a compute-capable element in the form of a device, gateway, bridge, system or subsystem, component, whether operating in a server, client, endpoint, or peer mode, and whether located at an “edge” of an network or at a connected location further within the network. however, references to an “edge computing system” generally refer to a distributed architecture, organization, or collection of multiple nodes and devices, and which is organized to accomplish or offer some aspect of services or resources in an edge computing setting. The term “edge computing platform” or “edge platform” at least in some examples refers to a collection of functionality that is used to instantiate, execute, or run edge applications on a specific edge compute node (e.g., virtualization infrastructure and/or the like), enable such edge applications to provide and/or consume edge services, and/or otherwise provide one or more edge services. The term “edge application” or “edge app” at least in some examples refers to an application that can be instantiated on, or executed by, an edge compute node within an edge computing network, system, or framework, and can potentially provide and/or consume edge computing services. The term “edge service” at least in some examples refers to a service provided via an edge compute node and/or edge platform, either by the edge platform itself and/or by an edge application.

The term “cloud computing” or “cloud” at least in some examples refers to a paradigm for enabling network access to a scalable and elastic pool of shareable computing resources with self-service provisioning and administration on-demand and without active management by users. Cloud computing provides cloud computing services (or cloud services), which are one or more capabilities offered via cloud computing that are invoked using a defined interface (e.g., an API or the like).

The term “network function” or “NF” at least in some examples refers to a functional block within a network infrastructure that has one or more external interfaces and a defined functional behavior. The term “network service” or “NS” at least in some examples refers to a composition or collection of NF(s) and/or network service(s), defined by its functional and behavioral specification(s). The term “RAN function” or “RANF” at least in some examples refers to a functional block within a RAN architecture that has one or more external interfaces and a defined behavior related to the operation of a RAN or RAN node. Additionally or alternatively, the term “RAN function” or “RANF” at least in some examples refers to a set of functions and/or NFs that are part of a RAN. The term “Application Function” or “AF” at least in some examples refers to an element or entity that interacts with a 3GPP core network in order to provide services. Additionally or alternatively, the term “Application Function” or “AF” at least in some examples refers to an edge compute node or ECT framework from the perspective of a 5G core network. The term “management function” at least in some examples refers to a logical entity playing the roles of a service consumer and/or a service producer. The term “management service” at least in some examples refers to a set of offered management capabilities. The term “network function virtualization” or “NFV” at least in some examples refers to the principle of separating network functions from the hardware they run on by using virtualization techniques and/or virtualization technologies. The term “virtualized network function” or “VNF” at least in some examples refers to an implementation of an NF that can be deployed on a Network Function Virtualization Infrastructure (NFVI). The term “Network Functions Virtualization Infrastructure Manager” or “NFVI” at least in some examples refers to a totality of all hardware and software components that build up the environment in which VNFs are deployed. The term “Virtualized Infrastructure Manager” or “VIM” at least in some examples refers to a functional block that is responsible for controlling and managing the NFVI compute, storage and network resources, usually within one operator's infrastructure domain. The term “virtualization container”, “execution container”, or “container” at least in some examples refers to a partition of a compute node that provides an isolated virtualized computation environment. The term “OS container” at least in some examples refers to a virtualization container utilizing a shared Operating System (OS) kernel of its host, where the host providing the shared OS kernel can be a physical compute node or another virtualization container. Additionally or alternatively, the term “container” at least in some examples refers to a standard unit of software (or a package) including code and its relevant dependencies, and/or an abstraction at the application layer that packages code and dependencies together. Additionally or alternatively, the term “container” or “container image” at least in some examples refers to a lightweight, standalone, executable software package that includes everything needed to run an application such as, for example, code, runtime environment, system tools, system libraries, and settings. The term “virtual machine” or “VM” at least in some examples refers to a virtualized computation environment that behaves in a same or similar manner as a physical computer and/or a server. The term “hypervisor” at least in some examples refers to a software element that partitions the underlying physical resources of a compute node, creates VMs, manages resources for VMs, and isolates individual VMs from each other.

The term “Data Network” or “DN” at least in some examples refers to a network hosting data-centric services such as, for example, operator services, the internet, third-party services, or enterprise networks. Additionally or alternatively, a DN at least in some examples refers to service networks that belong to an operator or third party, which are offered as a service to a client or user equipment (UE). DNs are sometimes referred to as “Packet Data Networks” or “PDNs”. The term “Local Area Data Network” or “LADN” at least in some examples refers to a DN that is accessible by the UE only in specific locations, that provides connectivity to a specific DNN, and whose availability is provided to the UE.

The term “Internet of Things” or “IoT” at least in some examples refers to a system of interrelated computing devices, mechanical and digital machines capable of transferring data with little or no human interaction, and may involve technologies such as real-time analytics, machine learning and/or AI, embedded systems, wireless sensor networks, control systems, automation (e.g., smarthome, smart building and/or smart city technologies), and the like. IoT devices are usually low-power devices without heavy compute or storage capabilities.

The term “protocol” at least in some examples refers to a predefined procedure or method of performing one or more operations. Additionally or alternatively, the term “protocol” at least in some examples refers to a common means for unrelated objects to communicate with each other (sometimes also called interfaces). The term “communication protocol” at least in some examples refers to a set of standardized rules or instructions implemented by a communication device and/or system to communicate with other devices and/or systems, including instructions for packetizing/depacketizing data, modulating/demodulating signals, implementation of protocols stacks, and/or the like. In various implementations, a “protocol” and/or a “communication protocol” may be represented using a protocol stack, a finite state machine (FSM), and/or any other suitable data structure. The term “standard protocol” at least in some examples refers to a protocol whose specification is published and known to the public and is controlled by a standards body. The term “protocol stack” or “network stack” at least in some examples refers to an implementation of a protocol suite or protocol family. In various implementations, a protocol stack includes a set of protocol layers, where the lowest protocol deals with low-level interaction with hardware and/or communications interfaces and each higher layer adds additional capabilities. Additionally or alternatively, the term “protocol” at least in some examples refers to a formal set of procedures that are adopted to ensure communication between two or more functions within the within the same layer of a hierarchy of functions.

The term “application layer” at least in some examples refers to an abstraction layer that specifies shared communications protocols and interfaces used by hosts in a communications network. Additionally or alternatively, the term “application layer” at least in some examples refers to an abstraction layer that interacts with software applications that implement a communicating component, and includes identifying communication partners, determining resource availability, and synchronizing communication. Examples of application layer protocols include HTTP, HTTPs, File Transfer Protocol (FTP), Dynamic Host Configuration Protocol (DHCP), Internet Message Access Protocol (IMAP), Lightweight Directory Access Protocol (LDAP), MQTT (MQ Telemetry Transport), Remote Authentication Dial-In User Service (RADIUS), Diameter protocol, Extensible Authentication Protocol (EAP), RDMA over Converged Ethernet version 2 (RoCEv2), Real-time Transport Protocol (RTP), RTP Control Protocol (RTCP), Real Time Streaming Protocol (RTSP), SBMV Protocol, Skinny Client Control Protocol (SCCP), Session Initiation Protocol (SIP), Session Description Protocol (SDP), Simple Mail Transfer Protocol (SMTP), Simple Network Management Protocol (SNMP), Simple Service Discovery Protocol (SSDP), Small Computer System Interface (SCSI), Internet SCSI (iSCSI), iSCSI Extensions for RDMA (iSER), Transport Layer Security (TLS), voice over IP (VoIP), Virtual Private Network (VPN), Extensible Messaging and Presence Protocol (XMPP), and/or the like.

The term “session layer” at least in some examples refers to an abstraction layer that controls dialogues and/or connections between entities or elements, and may include establishing, managing and terminating the connections between the entities or elements.

The term “transport layer” at least in some examples refers to a protocol layer that provides end-to-end (e2e) communication services such as, for example, connection-oriented communication, reliability, flow control, and multiplexing. Examples of transport layer protocols include datagram congestion control protocol (DCCP), fibre channel protocol (FBC), Generic Routing Encapsulation (GRE), GPRS Tunneling (GTP), Micro Transport Protocol (μTP), Multipath TCP (MPTCP), MultiPath QUIC (MPQUIC), Multipath UDP (MPUDP), Quick UDP Internet Connections (QUIC), Remote Direct Memory Access (RDMA), Resource Reservation Protocol (RSVP), Stream Control Transmission Protocol (SCTP), transmission control protocol (TCP), user datagram protocol (UDP), and/or the like.

The term “network layer” at least in some examples refers to a protocol layer that includes means for transferring network packets from a source to a destination via one or more networks. Additionally or alternatively, the term “network layer” at least in some examples refers to a protocol layer that is responsible for packet forwarding and/or routing through intermediary nodes. Additionally or alternatively, the term “network layer” or “internet layer” at least in some examples refers to a protocol layer that includes interworking methods, protocols, and specifications that are used to transport network packets across a network. As examples, the network layer protocols include internet protocol (IP), IP security (IPsec), Internet Control Message Protocol (ICMP), Internet Group Management Protocol (IGMP), Open Shortest Path First protocol (OSPF), Routing Information Protocol (RIP), RDMA over Converged Ethernet version 2 (RoCEv2), Subnetwork Access Protocol (SNAP), and/or some other internet or network protocol layer.

The term “link layer” or “data link layer” at least in some examples refers to a protocol layer that transfers data between nodes on a network segment across a physical layer. Examples of link layer protocols include logical link control (LLC), medium access control (MAC), Ethernet, RDMA over Converged Ethernet version 1 (RoCEv1), and/or the like.

The term “radio resource control”, “RRC layer”, or “RRC” at least in some examples refers to a protocol layer or sublayer that performs system information handling; paging; establishment, maintenance, and release of RRC connections; security functions; establishment, configuration, maintenance and release of Signalling Radio Bearers (SRBs) and Data Radio Bearers (DRBs); mobility functions/services; QoS management; and some sidelink specific services and functions over the Uu interface (see e.g., 3GPP TS 36.331 v17.4.0 (2023-03-30) (“[TS36331]”) and/or 3GPP TS 38.331 v17.4.0 (2023-03-30) (“[TS38331]”)).

The term “Service Data Adaptation Protocol”, “SDAP layer”, or “SDAP” at least in some examples refers to a protocol layer or sublayer that performs mapping between QoS flows and a data radio bearers (DRBs) and marking QoS flow IDs (QFI) in both DL and UL packets (see e.g., 3GPP TS 37.324 v17.0.0 (2022-04-13) (“[TS37324]”).

The term “Packet Data Convergence Protocol”, “PDCP layer”, or “PDCP” at least in some examples refers to a protocol layer or sublayer that performs transfer user plane or control plane data; maintains PDCP sequence numbers (SNs); header compression and decompression using the Robust Header Compression (ROHC) and/or Ethernet Header Compression (EHC) protocols; ciphering and deciphering; integrity protection and integrity verification; provides timer based SDU discard; routing for split bearers; duplication and duplicate discarding; reordering and in-order delivery; and/or out-of-order delivery (see e.g., 3GPP TS 36.323 v17.2.0 (2023-01-13) and/or 3GPP TS 38.323 v17.4.0 (2023-03-28) (“[TS38323]”)).

The term “radio link control layer”, “RLC layer”, or “RLC” at least in some examples refers to a protocol layer or sublayer that performs transfer of upper layer PDUs; sequence numbering independent of the one in PDCP; error Correction through ARQ; segmentation and/or re-segmentation of RLC SDUs; reassembly of SDUs; duplicate detection; RLC SDU discarding; RLC re-establishment; and/or protocol error detection (see e.g., 3GPP TS 36.322 v17.0.0 (2022-04-15) and 3GPP TS 38.322 v17.2.0 (2023-01-13) (“[TS38322]”)).

The term “medium access control protocol”, “MAC protocol”, or “MAC” at least in some examples refers to a protocol that governs access to the transmission medium in a network, to enable the exchange of data between stations in a network. Additionally or alternatively, the term “medium access control layer”, “MAC layer”, or “MAC” at least in some examples refers to a protocol layer or sublayer that performs functions to provide frame-based, connectionless-mode (e.g., datagram style) data transfer between stations or devices. Additionally or alternatively, the term “medium access control layer”, “MAC layer”, or “MAC” at least in some examples refers to a protocol layer or sublayer that performs mapping between logical channels and transport channels; multiplexing/demultiplexing of MAC SDUs belonging to one or different logical channels into/from transport blocks (TB) delivered to/from the physical layer on transport channels; scheduling information reporting; error correction through HARQ (one HARQ entity per cell in case of CA); priority handling between UEs by means of dynamic scheduling; priority handling between logical channels of one UE by means of logical channel prioritization; priority handling between overlapping resources of one UE; and/or padding (see e.g., 3GPP TS 36.321 v17.3.0 (2023-01-13), and 3GPP TS 38.321 v17.4.0 (2023-03-29) (“[TS38321]”).

The term “physical layer”, “PHY layer”, or “PHY” at least in some examples refers to a protocol layer or sublayer that includes capabilities to transmit and receive modulated signals for communicating in a communications network (see e.g., 3GPP TS 36.201 v17.0.0 (2022-03-31), and 3GPP TS 38.201 v17.0.0 (2022-01-05) (“[TS38201]”)

The term “access technology” at least in some examples refers to the technology used for the underlying physical connection to a communication network. The term “radio access technology” or “RAT” at least in some examples refers to the technology used for the underlying physical connection to a radio based communication network. The term “radio technology” at least in some examples refers to technology for wireless transmission and/or reception of electromagnetic radiation for information transfer. The term “RAT type” at least in some examples may identify a transmission technology and/or communication protocol used in an access network. Examples of access technologies include wireless access technologies/RATs, wireline, wireline-cable, wireline broadband forum (wireline-BBF), Ethernet (see e.g., IEEE Standard for Ethernet, IEEE Std 802.3-2018 (31 Aug. 2018) (“[IEEE8023]”)) and variants thereof, fiber optics networks (e.g., ITU-T G.651, ITU-T G.652, Optical Transport Network (OTN), Synchronous optical networking (SONET) and synchronous digital hierarchy (SDH), and the like), digital subscriber line (DSL) and variants thereof, Data Over Cable Service Interface Specification (DOCSIS) technologies, hybrid fiber-coaxial (HFC) technologies, and/or the like. Examples of RATs (or RAT types) and/or communications protocols include Advanced Mobile Phone System (AMPS) technologies (e.g., Digital AMPS (D-AMPS), Total Access Communication System (TACS) and variants thereof, such as Extended TACS (ETACS), and the like); Global System for Mobile Communications (GSM) technologies (e.g., Circuit Switched Data (CSD), High-Speed CSD (HSCSD), General Packet Radio Service (GPRS), and Enhanced Data Rates for GSM Evolution (EDGE)); Third Generation Partnership Project (3GPP) technologies (e.g., Universal Mobile Telecommunications System (UNITS) and variants thereof (e.g., UNITS Terrestrial Radio Access (UTRA), Wideband Code Division Multiple Access (W-CDMA), Freedom of Multimedia Access (FOMA), Time Division-Code Division Multiple Access (TD-CDMA), Time Division-Synchronous Code Division Multiple Access (TD-SCDMA), and the like), Generic Access Network (GAN)/Unlicensed Mobile Access (UMA), High Speed Packet Access (HSPA) and variants thereof (e.g., HSPA Plus (HSPA+)), Long Term Evolution (LTE) and variants thereof (e.g., LTE-Advanced (LTE-A), Evolved UTRA (E-UTRA), LTE Extra, LTE-A Pro, LTE LAA, MuLTEfire, and the like), Fifth Generation (5G) or New Radio (NR), narrowband IoT (NB-IOT), 3GPP Proximity Services (ProSe), and/or the like); ETSI RATs (e.g., High Performance Radio Metropolitan Area Network (HiperMAN), Intelligent Transport Systems (ITS) (e.g., ITS-G5, ITS-G5B, ITS-G5C, and the like), and the like); Institute of Electrical and Electronics Engineers (IEEE) technologies and/or WiFi (e.g., IEEE Standard for Local and Metropolitan Area Networks: Overview and Architecture, IEEE Std 802-2014, pp. 1-74 (30 Jun. 2014) (“[IEEE802]”), IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications, IEEE Std 802.11-2020, pp. 1-4379 (26 Feb. 2021) (“[IEEE80211]”), IEEE 802.15 technologies (e.g., IEEE Standard for Low-Rate Wireless Networks, IEEE Std 802.15.4-2020, pp. 1-800 (23 Jul. 2020) (“[IEEE802154]”) and variants thereof (e.g., ZigBee, WirelessHART, MiWi, ISA100.11a, Thread, IPv6 over Low power WPAN (6LoWPAN), and the like), IEEE Standard for Local and metropolitan area networks—Part 15.6: Wireless Body Area Networks, IEEE Std 802.15.6-2012, pp. 1-271 (29 Feb. 2012), and the like), WLAN V2X RATs (e.g., IEEE Standard for Information technology—Local and metropolitan area networks—Specific requirements—Part 11: Wireless LAN Medium Access Control (MAC) and Physical Layer (PHY) Specifications Amendment 6: Wireless Access in Vehicular Environments, IEEE Std 802.11p-2010, pp. 1-51 (15 Jul. 2010) (“[IEEE80211p]”) (which is now part of [IEEE80211]), IEEE Guide for Wireless Access in Vehicular Environments (WAVE) Architecture, IEEE STANDARDS ASSOCIATION, IEEE 1609.0-2019 (10 Apr. 2019) (“[IEEE16090]”), IEEE 802.11bd, Dedicated Short Range Communications (DSRC), and/or the like), Worldwide Interoperability for Microwave Access (WiMAX) (e.g., IEEE Standard for Air Interface for Broadband Wireless Access Systems, IEEE Std 802.16-2017, pp. 1-2726 (2 Mar. 2018) (“[WiMAX]”)), Mobile Broadband Wireless Access (MBWA)/iBurst (e.g., IEEE 802.20 and variants thereof), Wireless Gigabit Alliance (WiGig) standards (e.g., IEEE 802.11ad, IEEE 802.11ay, and the like), and so forth); Integrated Digital Enhanced Network (iDEN) and variants thereof (e.g., Wideband Integrated Digital Enhanced Network (WiDEN)); millimeter wave (mmWave) technologies/standards (e.g., wireless systems operating at 10-300 GHz and above 3GPP 5G); short-range and/or wireless personal area network (WPAN) technologies/standards (e.g., IEEE 802.15 technologies (e.g., as mentioned previously); Bluetooth and variants thereof (e.g., Bluetooth 5.3, Bluetooth Low Energy (BLE), and the like), WiFi-direct, Miracast, ANT/ANT+, Z-Wave, Universal Plug and Play (UPnP), low power Wide Area Networks (LPWANs), Long Range Wide Area Network (LoRA or LoRaWAN™), and the like); optical and/or visible light communication (VLC) technologies/standards (e.g., IEEE Standard for Local and metropolitan area networks—Part 15.7: Short-Range Optical Wireless Communications, IEEE Std 802.15.7-2018, pp. 1-407 (23 Apr. 2019), and the like); Sigfox; Mobitex; 3GPP2 technologies (e.g., cdmaOne (2G), Code Division Multiple Access 2000 (CDMA 2000), and Evolution-Data Optimized or Evolution-Data Only (EV-DO); Push-to-talk (PTT), Mobile Telephone System (MTS) and variants thereof (e.g., Improved MTS (IMTS), Advanced MTS (AMTS), and the like); Personal Digital Cellular (PDC); Personal Handy-phone System (PHS), Cellular Digital Packet Data (CDPD); Cellular Digital Packet Data (CDPD); DataTAC; Digital Enhanced Cordless Telecommunications (DECT) and variants thereof (e.g., DECT Ultra Low Energy (DECT ULE), DECT-2020, DECT-5G, and the like); Ultra High Frequency (UHF) communication; Very High Frequency (VHF) communication; and/or any other suitable RAT or protocol. In addition to the aforementioned RATs/standards, any number of satellite uplink technologies may be used for purposes of the present disclosure including, for example, radios compliant with standards issued by the International Telecommunication Union (ITU), or the ETSI, among others. The examples provided herein are thus understood as being applicable to various other communication technologies, both existing and not yet formulated.

The term “channel” at least in some examples refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” at least in some examples refers to a connection between two devices through a RAT for the purpose of transmitting and receiving information.

The term “carrier” at least in some examples refers to a modulated waveform conveying one or more physical channels (e.g., 5G/NR, E-UTRA, UTRA, and/or GSM/EDGE physical channels). The term “carrier frequency” at least in some examples refers to the center frequency of a cell.

The term “bearer” at least in some examples refers to an information transmission path of defined capacity, delay, bit error rate, and/or the like. The term “radio bearer” at least in some examples refers to the service provided by Layer 2 (L2) for transfer of user data between user equipment (UE) and a radio access network (RAN). The term “radio access bearer” at least in some examples refers to the service that the access stratum provides to the non-access stratum for transfer of user data between a UE and a CN.

The terms “beamforming” and “beam steering” at least in some examples refer to a spatial filtering mechanism used at a transmitter (Tx) to improve the received signal power, signal-to-noise ratio (SNR), or some other signalling metric at an intended receiver (Rx). The term “beamformer” at least in some examples refers to a STA that transmits a physical layer PDU (PPDU) using a beamforming steering matrix. The term “beamforming steering matrix” at least in some examples refers to a matrix determined using knowledge of the channel between a Tx and an intended Rx that maps from space-time streams to transmit antennas with the goal of improving the signal power, SNR, and/or some other signalling metric at the intended Rx.

The term “subframe” at least in some examples at least in some examples refers to a time interval during which a signal is signaled. In some implementations, a subframe is equal to 1 millisecond (ms). The term “time slot” at least in some examples at least in some examples refers to an integer multiple of consecutive subframes. The term “superframe” at least in some examples at least in some examples refers to a time interval comprising two time slots.

The term “channel coding” at least in some examples refers to processes and/or techniques to add redundancy to messages or packets in order to make those messages or packets more robust against noise, channel interference, limited channel bandwidth, and/or other errors. For purposes of the present disclosure, the term “channel coding” can be used interchangeably with the terms “forward error correction” or “FEC”; “error correction coding”, “error correction code”, or “ECC”; and/or “network coding” or “NC”. The term “network coding” at least in some examples refers to processes and/or techniques in which transmitted data is encoded and decoded to improve network performance. The term “code rate” at least in some examples refers to the proportion of a data stream or flow that is useful or non-redundant (e.g., for a code rate of k/n, for every k bits of useful information, the (en)coder generates a total of n bits of data, of which n−k are redundant). The term “systematic code” at least in some examples refers to any error correction code in which the input data is embedded in the encoded output. The term “non-systematic code” at least in some examples refers to any error correction code in which the input data is not embedded in the encoded output. The term “interleaving” at least in some examples refers to a process to rearrange code symbols so as to spread bursts of errors over multiple codewords that can be corrected by ECCs. The term “code word” or “codeword” at least in some examples refers to an element of a code or protocol, which is assembled in accordance with specific rules of the code or protocol.

The term “network address” at least in some examples refers to an identifier for a node or host in a computer network, and may be a unique identifier across a network and/or may be unique to a locally administered portion of the network. Examples of identifiers and/or network addresses can include am application identifier, Bluetooth hardware device address (BD ADDR), a cellular network address (e.g., Access Point Name (APN), AMF name and/or AMF identifier (ID), AF-Service-Identifier, Closed Access Group Identifier (CAG-ID), Edge Application Server (EAS) ID, Data Network Access Identifier (DNAI), Data Network Name (DNN), EPS Bearer Identity (EBI), Equipment Identity Register (EIR) and/or 5G-EIR, Extended Unique Identifier (EUI), Group ID for Network Selection (GIN), Generic Public Subscription Identifier (GPSI), Globally Unique AMF Identifier (GUAMI), Globally Unique Temporary Identifier (GUTI) and/or 5G-GUTI, gNB Identifier (gNB ID), Global gNB ID, International Mobile Equipment Identity (IMEI), IMEI Type Allocation Code (IMEA/TAC), International Mobile Subscriber Identity (IMSI), IMSI software version (IMSISV), permanent equipment identifier (PEI), Local Area Data Network (LADN) DNN, Local NG-RAN Node Identifier, Mobile Subscriber Identification Number (MSIN), Mobile Subscriber/Station ISDN Number (MSISDN), Network identifier (NID), NR Cell Global Identifier (NCGI), Network Slice Instance (NSI) ID, Network Slice AS Group (NSAG), Permanent Equipment Identifier (PEI), Public Land Mobile Network (PLMN) ID, Physical Cell Identifier (PCI), QoS Flow ID (QFI) and/or 5G QoS Identifier (5QI), RAN ID, Routing Indicator, Radio Network Temporary Identifier (RNTI) and variants thereof (e.g., any of those discussed in clause 8 of 3GPP TS 38.300 v17.4.0 (2023-03-28) (“[TS38300]”) and/or NCR-RNTI discussed previously), SMS Function (SMSF) ID, Stand-alone Non-Public Network (SNPN) ID, Single Network Slice Selection Assistance information (S-NSSAI), sidelink identities (e.g., Source Layer-2 ID, Destination Layer-2 ID, PC5 Link Identifier, and the like), Subscription Concealed Identifier (SUCI), Subscription Permanent Identifier (SUPI), Temporary Mobile Subscriber Identity (TMSI) and variants thereof, Tracking Area identity (TAI), UE Access Category and Identity, and/or other cellular network related identifiers), CAG-ID, drivers license number, Global Trade Item Number (GTIN) (e.g., Australian Product Number (APN), EPC, European Article Number (EAN), Universal Product Code (UPC), and the like), email address, Enterprise Application Server (EAS) ID, an endpoint address, an Electronic Product Code (EPC) as defined by the EPCglobal Tag Data Standard, Fully Qualified Domain Name (FQDN), flow ID and/or flow hash, hash value, index, internet protocol (IP) address in an IP network (e.g., IP version 4 (IPv4), IP version 6 (IPv6), and the like), an internet packet exchange (IPX) address, LAN ID, a MAC address, personal area network (PAN) ID, port number (e.g., TCP port number, UDP port number, and the like), price lookup code (PLC), product key, QUIC connection ID, RFID tag, sequence number, service set identifier (SSID) and variants thereof, screen name, serial number, stock keeping unit (SKU), socket address, social security number (SSN), telephone number (e.g., in a public switched telephone network (PTSN)), unique identifier (UID) (e.g., including globally UID, universally unique identifier (UUID) (e.g., as specified in ISO/IEC 11578:1996), and the like), a Universal Resource Locator (URL) and/or Universal Resource Identifier (URI), user name (e.g., ID for logging into a service provider platform, such as a social network and/or some other service), vehicle identification number (VIN), Virtual LAN (VLAN) ID, X.21 address, an X.25 address, Zigbee® ID, Zigbee® Device Network ID, and/or any other suitable network address and components thereof.

The term “port” in the context of computer networks, at least in some examples refers to a communication endpoint, a virtual data connection between two or more entities, and/or a virtual point where network connections start and end. Additionally or alternatively, a “port” at least in some examples is associated with a specific process or service. Additionally or alternatively, the term “port” at least in some examples refers to a particular interface of the specified equipment (apparatus) with an electromagnetic environment (e.g., any connection point on an equipment intended for connection of cables to or from that equipment is considered as a port).

The term “delay” at least in some examples refers to a time interval between two events. Additionally or alternatively, the term “delay” at least in some examples refers to a time interval between the propagation of a signal and its reception. The term “delay bound” at least in some examples refers to a predetermined or configured amount of acceptable delay. The term “per-packet delay bound” at least in some examples refers to a predetermined or configured amount of acceptable packet delay where packets that are not processed and/or transmitted within the delay bound are considered to be delivery failures and are discarded or dropped. The term “goodput” at least in some examples refers to a number of useful information bits delivered by the network to a certain destination per unit of time. The term “jitter” at least in some examples refers to a deviation from a predefined (“true”) periodicity of a presumably periodic signal in relation to a reference clock signal. The term “latency” at least in some examples refers to the amount of time it takes to transfer a first/initial data unit in a data burst from one point to another. Additionally or alternatively, the term “latency” at least in some examples refers to the delay experienced by a data unit (e.g., frame) in the course of its propagation between two points in a network, measured from the time that a known reference point in the frame passes the first point to the time that the reference point in the data unit passes the second point. The term “network delay” at least in some examples refers to the delay of an a data unit within a network (e.g., an IP packet within an IP network). The term “packet delay” at least in some examples refers to the time it takes to transfer any packet from one point to another. Additionally or alternatively, the term “packet delay” or “per packet delay” at least in some examples refers to the difference between a packet reception time and packet transmission time. Additionally or alternatively, the “packet delay” or “per packet delay” can be measured by subtracting the packet sending time from the packet receiving time where the transmitter and receiver are at least somewhat synchronized. The term “packet drop rate” at least in some examples refers to a share of packets that were not sent to the target due to high traffic load or traffic management and should be seen as a part of the packet loss rate. The term “packet loss rate” at least in some examples refers to a share of packets that could not be received by the target, including packets dropped, packets lost in transmission and packets received in wrong format. The term “performance indicator” at least in some examples refers to performance data aggregated over a group of network functions (NFs), which is derived from performance measurements collected at the NFs that belong to the group, according to the aggregation method identified in a Performance Indicator definition. The term “physical rate” or “PHY rate” at least in some examples refers to a speed at which one or more bits are actually sent over a transmission medium. Additionally or alternatively, the term “physical rate” or “PHY rate” at least in some examples refers to a speed at which data can move across a wireless link between a transmitter and a receiver. The term “processing delay” at least in some examples refers to an amount of time taken to process a packet in a network node. The term “propagation delay” at least in some examples refers to amount of time it takes a signal's header to travel from a sender to a receiver. The term “queuing delay” at least in some examples refers to an amount of time a job waits in a queue until that job can be executed. Additionally or alternatively, the term “queuing delay” at least in some examples refers to an amount of time a packet waits in a queue until it can be processed and/or transmitted. The term “throughput” or “network throughput” at least in some examples refers to a rate of production or the rate at which something is processed. Additionally or alternatively, the term “throughput” or “network throughput” at least in some examples refers to a rate of successful message (date) delivery over a communication channel. The term “transmission delay” at least in some examples refers to an amount of time needed (or necessary) to push a packet (or all bits of a packet) into a transmission medium.

The term “application” or “app” at least in some examples refers to a computer program designed to carry out a specific task other than one relating to the operation of the computer itself. Additionally or alternatively, term “application” or “app” at least in some examples refers to a complete and deployable package, environment to achieve a certain function in an operational environment. The term “process” at least in some examples refers to an instance of a computer program that is being executed by one or more threads. In some implementations, a process may be made up of multiple threads of execution that execute instructions concurrently. The term “algorithm” at least in some examples refers to an unambiguous specification of how to solve a problem or a class of problems by performing calculations, input/output operations, data processing, automated reasoning tasks, and/or the like.

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. In some examples, an API may be defined or otherwise used for a web-based system, operating system, database system, computer hardware, software library, and/or the like.

The terms “instantiate,” “instantiation,” and the like at least in some examples refers to the creation of an instance. An “instance” also at least in some examples refers to a concrete occurrence of an object, which may occur, for example, during execution of program code.

The term “reference point” at least in some examples refers to a conceptual point at the conjunction of two non-overlapping functional groups, elements, or entities.

The term “use case” at least in some examples refers to a description of a system from a user's perspective. Use cases sometimes treat a system as a black box, and the interactions with the system, including system responses, are perceived as from outside the system. Use cases typically avoid technical jargon, preferring instead the language of the end user or domain expert.

The term “user” at least in some examples refers to an abstract representation of any entity issuing commands, requests, and/or data to a compute node or system, and/or otherwise consumes or uses services. Additionally or alternatively, the term “user” at least in some examples refers to an entity, not part of the 3GPP System, which uses 3GPP System services (e.g., a person using a 3GPP system mobile station as a portable telephone). The term “user profile” at least in some examples refers to a set of information to provide a user with a consistent, personalized service environment, irrespective of the user's location or the terminal used (within the limitations of the terminal and the serving network).

The terms “configuration”, “policy”, “ruleset”, and/or “operational parameters”, at least in some examples refer to a machine-readable information object that contains instructions, conditions, parameters, and/or criteria that are relevant to a device, system, or other element/entity.

The term “datagram” at least in some examples at least in some examples refers to a basic transfer unit associated with a packet-switched network; a datagram may be structured to have header and payload sections. The term “datagram” at least in some examples may be synonymous with any of the following terms, even though they may refer to different aspects: “data unit”, a “protocol data unit” or “PDU”, a “service data unit” or “SDU”, “frame”, “packet”, a “network packet”, “segment”, “block”, “cell”, “chunk”, “Type Length Value” or “TLV”, and/or the like. Examples of datagrams, network packets, and the like, include internet protocol (IP) packet, Internet Control Message Protocol (ICMP) packet, UDP packet, TCP packet, SCTP packet, ICMP packet, Ethernet frame, RRC messages/packets, SDAP PDU, SDAP SDU, PDCP PDU, PDCP SDU, MAC PDU, MAC SDU, BAP PDU. BAP SDU, RLC PDU, RLC SDU, WiFi frames as discussed in a IEEE 802 protocol/standard (e.g., [IEEE80211] or the like), Type Length Value (TLV), and/or other like data structures. The term “packet” at least in some examples refers to an information unit identified by a label at layer 3 of the OSI reference model. In some examples, a “packet” may also be referred to as a “network protocol data unit” or “NPDU”. The term “protocol data unit” at least in some examples refers to a unit of data specified in an (N)-protocol layer and includes (N)-protocol control information and possibly (N)-user data.

The term “information element” or “IE” at least in some examples refers to a structural element containing one or more fields. Additionally or alternatively, the term “information element” or “IE” at least in some examples refers to a field or set of fields defined in a standard or specification that is used to convey data and/or protocol information. The term “field” at least in some examples refers to individual contents of an information element, or a data element that contains content. The term “data frame”, “data field”, or “DF” at least in some examples refers to a data type that contains more than one data element in a predefined order. The term “data element” or “DE” at least in some examples refers to a data type that contains one single data. Additionally or alternatively, the term “data element” at least in some examples refers to an atomic state of a particular object with at least one specific property at a certain point in time, and may include one or more of a data element name or identifier, a data element definition, one or more representation terms, enumerated values or codes (e.g., metadata), and/or a list of synonyms to data elements in other metadata registries. Additionally or alternatively, a “data element” at least in some examples refers to a data type that contains one single data. Data elements may store data, which may be referred to as the data element's content (or “content items”). Content items may include text content, attributes, properties, and/or other elements referred to as “child elements.” Additionally or alternatively, data elements may include zero or more properties and/or zero or more attributes, each of which may be defined as database objects (e.g., fields, records, and the like), object instances, and/or other data elements. An “attribute” at least in some examples refers to a markup construct including a name—value pair that exists within a start tag or empty element tag. Attributes contain data related to its element and/or control the element's behavior. The term “type length value”, “tag length value”, or “TLV” at least in some examples refers to an encoding scheme used for informational elements in a protocol; TLVs are sometimes used to encode additional or optional information elements in a protocol. In some examples, a TLV-encoded data stream contains code related to the type of value, the length of the value, and the value itself. In some examples, the type in a TLV includes a binary and/or alphanumeric code, which indicates the kind of field that this part of the message represents; the length in a TLV includes a size of the value field (e.g., in bytes); and the value in a TLV includes a variable-sized series of bytes which contains data for this part of the message.

The term “reference” at least in some examples refers to data useable to locate other data and may be implemented a variety of ways (e.g., a pointer, an index, a handle, a key, an identifier, a hyperlink, and/or the like).

The term “data set” or “dataset” at least in some examples refers to a collection of data; a “data set” or “dataset” may be formed or arranged in any type of data structure. In some examples, one or more characteristics can define or influence the structure and/or properties of a dataset such as the number and types of attributes and/or variables, and various statistical measures (e.g., standard deviation, kurtosis, and/or the like). The term “data structure” at least in some examples refers to a data organization, management, and/or storage format. Additionally or alternatively, the term “data structure” at least in some examples refers to a collection of data values, the relationships among those data values, and/or the functions, operations, tasks, and the like, that can be applied to the data. Examples of data structures include primitives (e.g., Boolean, character, floating-point numbers, fixed-point numbers, integers, reference or pointers, enumerated type, and/or the like), composites (e.g., arrays, records, strings, union, tagged union, and/or the like), abstract data types (e.g., data container, list, tuple, associative array, map, dictionary, set (or dataset), multiset or bag, stack, queue, graph (e.g., tree, heap, and the like), and/or the like), routing table, symbol table, quad-edge, blockchain, purely-functional data structures (e.g., stack, queue, (multi)set, random access list, hash consing, zipper data structure, and/or the like).

The term “Timing Advance Group” or “TAG” at least in some examples refers to a group of serving cells that is configured by RRC and that, for the cells with a UL configured, using the same timing reference cell and the same Timing Advance (TA) value. In some examples, a TAG containing the SpCell of a MAC entity is referred to as a Primary TAG (PTAG), and the term Secondary TAG (STAG) refers to other TAGs.

Although many of the previous examples are provided with use of specific cellular/mobile network terminology, including with the use of 4G/5G 3GPP network components (or expected terahertz-based 6G/6G+ technologies), it will be understood these examples may be applied to many other deployments of wide area and local wireless networks, as well as the integration of wired networks (including optical networks and associated fibers, transceivers, and/or the like). Furthermore, various standards (e.g., 3GPP, ETSI, and/or the like) may define various message formats, PDUs, containers, frames, and/or the like, as comprising a sequence of optional or mandatory data elements (DEs), data frames (DFs), information elements (IEs), and/or the like. However, it should be understood that the requirements of any particular standard should not limit the examples discussed herein, and as such, any combination of containers, frames, DFs, DEs, IEs, values, actions, and/or features are possible in various examples, including any combination of containers, DFs, DEs, values, actions, and/or features that are strictly required to be followed in order to conform to such standards or any combination of containers, frames, DFs, DEs, IEs, values, actions, and/or features strongly recommended and/or used with or in the presence/absence of optional elements.

Aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1. A network controlled repeater (NCR), comprising:
radiofrequency (RF) circuitry to receive a configuration from an operations, administration, and maintenance (OAM) element, wherein the configuration includes an NCR identity (NCR-id) and a list of radio access network (RAN) nodes; and
processor circuitry connected to the RF circuitry, wherein the processor circuitry is to establish a network connection with a RAN node in the list of RAN nodes via the RF circuitry and using the NCR-id.

2. The NCR of claim 1, wherein, to establish the network connection with the RAN node, the processor circuitry is to:
when the NCR enters an radio resource control (RRC) connected state, generate a power-on indication to include the NCR-id; and
cause the RF circuitry to send the power-on indication to the RAN node, wherein the RRC setup complete message is to cause the RAN node to establish a user equipment (UE) context for the NCR.

3. The NCR of claim 2, wherein the RF circuitry is to receive an access response from the RAN node based on the power-on indication, wherein the access response includes an acknowledge (ACK) field, and the ACK field is set when the NCR has been authorized to connect to the RAN node.

4. The NCR of claim 2, wherein:
the processor circuitry is to generate a turn on/off indicator, wherein the turn on/off indicator includes an NCR-id field to carry the NCR-id, an on/off field to include a first value, and a component field to include a second value, and wherein the first value indicates to turn on or off a component indicated by the second value in the component field, and the second value indicates an NCR component to be turned on or off based on the first value in the on/off field; and
the RF circuitry is to send the turn on/off indicator to the RAN node.

5. The NCR of claim 2, wherein the processor circuitry is to select the RAN node from the list of RAN nodes.

6. The NCR of claim 1, wherein, to establish the network connection with the RAN node, the processor circuitry is to:
generate an RRC setup request message to include the NCR-id; and
cause the RF circuitry to send the RRC setup request message to the RAN node.

7. The NCR of claim 6, wherein the RF circuitry is to receive an RRC setup message from the RAN node based on the RRC setup request message, wherein the RRC setup message includes additional identification information for the NCR.

8. The NCR of claim 1, wherein the processor circuitry is operate only a medium access control layer entity (MAC) and a physical layer entity (PHY) of a cellular communication protocol stack.

9. The NCR of claim 8, wherein:
the RF circuitry is to receive side control information from the RAN node; and
the processor circuitry is to control a radio unit layer (RU) of the NCR of the cellular communication protocol stack based on the side control information.

10. One or more non-transitory computer-readable media (NTCRM) comprising instructions, wherein execution of the instructions by a network controlled repeater (NCR) is to cause the NCR to:
receive an NCR support indication from a radio access network (RAN) node;
generate a radio resource control (RRC) setup complete message to include an NCR indication; and
cause the RRC setup complete message to be sent to the RAN node, wherein the RRC setup complete message is to cause the RAN node to establish a user equipment (UE) context.

11. The one or more NTCRM of claim 10, wherein the RRC setup complete message is to cause the RAN node to send an initial UE message to a network function (NF) in a cellular core network.

12. The one or more NTCRM of claim 11, wherein the initial UE message includes the NCR indication or a different NCR indication, and the RAN node is to establish the UE context based on an NCR authentication indication provided by the NF.

13. The one or more NTCRM of claim 11, wherein the initial UE message does not include an NCR indication, and the RAN node is to establish the UE context based on a UE authentication indication provided by the NF.

14. The one or more NTCRM of claim 10, wherein the NCR support indication is included in a system information block (SIB) or a master information block (MIB) broadcasted by the RAN node.

15. The one or more NTCRM of claim 10, wherein the NCR support indication is included in a PLMN-IdentityInfoList information element included in system information block 1 (SIB1) broadcasted by the RAN node.

16. One or more non-transitory computer-readable media (NTCRM) comprising instructions, wherein execution of the instructions by a network controlled repeater (NCR) is to cause the NCR to:
during a random access channel (RACH) procedure,
cause a message 3 (MSG3) medium access control (MAC) control element (CE) to be sent to a radio access network (RAN) node,
receive a user equipment (UE) contention resolution identity MAC CE from the RAN node based on the MSG3 MAC CE, and
complete the RACH procedure using a UE contention resolution identity included in the UE contention resolution identity MAC CE; and
begin amplify-and-forwarding services after the RACH procedure is completed.

17. The one or more NTCRM of claim 16, wherein execution of the instructions is to cause the NCR to:
generate the MSG3 MAC CE to only include a configured NCR identity (NCR-id).

18. The one or more NTCRM of claim 16, wherein execution of the instructions is to cause the NCR to:
select a random contention resolution identity; and
generate the MSG3 MAC CE to only include the selected random contention resolution identity.

19. The one or more NTCRM of claim 18, wherein execution of the instructions is to cause the NCR to:
generate a MAC CE-as-RRCSetupComplete based on receipt of the UE contention resolution identity MAC CE, wherein the MAC CE-as-RRCSetupComplete is to include an NCR indicator; and
cause the MAC CE-as-RRCSetupComplete to be sent to the RAN node.

20. The one or more NTCRM of claim 19, wherein the NCR indicator included in the MAC CE-as-RRCSetupComplete includes an NCR indicator field to indicate that the MAC CE-as-RRCSetupComplete is sent by a network controlled repeater, and a selected public land mobile network (PLMN) identity field to carry a selected PLMN identity associated with the NCR.
